(19) United States
(12) Patent Application Publication
(10) Pub. No.: US 2026/0192511 A1
(43) Pub. Date: Jul. 9, 2026

(54) STEREOLITHOGRAPHY THREE-DIMENSIONAL PRINTING SYSTEMS AND METHODS

(71) Applicant: SOUTHWEST GREENE INTERNATIONAL, INC., Oceanside, CA (US)

(72) Inventors: Pierre Lin, San Francisco, CA (US); Daniel Christiansen, San Francisco, CA (US); Peter Schmehl, Berkeley, CA (US); Tara Pratap Ebsworth, Oakland, CA (US); Aldo Suseno, Hayward, CA (US)

(73) Assignee: SOUTHWEST GREENE INTERNATIONAL, INC., Oceanside, CA (US)

(21) Appl. No.: 19/552,808

(22) Filed: Feb. 27, 2026

Related U.S. Application Data
(63) Continuation of application No. 17/525,239, filed on Nov. 12, 2021, now abandoned.
Application No. 17/525,239 is a continuation of application No. PCT/US20/33279, filed on May 15, 2020.
(60) Provisional application No. 62/849,596, filed on May 17, 2019.

(51) Int. Cl. B29C 64/124; B29C 64/20; B29C 64/386; B33Y 10/00; B33Y 30/00; B33Y 50/00

(52) U.S. Cl. CPC B29C 64/124; B29C 64/20; B29C 64/386; B33Y 10/00; B33Y 30/00; B33Y 50/00

(57) ABSTRACT

The present disclosure provides systems and methods for printing three-dimensional (3D) objects. A system for printing a 3D object may comprise a platform comprising an area configured to hold a mixture including a photoactive resin. The platform may comprise a first coupling unit. The system may comprise an optical source configured to provide light to the mixture for curing the photoactive resin in at least a portion of the mixture to print at least a portion of the 3D object. The system may comprise a build head configured to support the at least the portion of the 3D object during printing. The build head may comprise a second coupling unit that is configured to couple to the first coupling unit to provide an alignment of the area of the platform relative to a surface of the build head while printing the at least the portion of the 3D object.

### CROSS-REFERENCE

This application is a continuation of International Patent Application No. PCT/US20/33279, filed May 15, 2020, which claims the benefit of U.S. Patent Application No. 62/849,596, filed May 17, 2019, each of which is entirely incorporated herein by reference.

### BACKGROUND

Additive manufacturing techniques, such as three-dimensional (3D) printing, are rapidly being adopted as useful techniques for a number of different applications, including rapid prototyping and fabrication of specialty components. Examples of 3D printing include powder-based printing, fused deposition modeling (FDM), and stereolithography (SLA).

Photopolymer-based 3D printing technology (e.g., SLA) may produce a 3D structure in a layer-by-layer fashion by using light to selectively cure polymeric precursors into a polymeric material within a photoactive resin. Photopolymer-based 3D printers that use bottom up illumination may project light upwards through an optically transparent window of a vat containing photoactive resin to cure at least a portion of the resin. Such printers may build a 3D structure by forming one layer at a time, where a subsequent layer adheres to the previous layer.

### SUMMARY

The present disclosure describes technologies relating to 3D printing. The present disclosure describes using one or more coupling units to control an alignment between a platform holding a mixture for 3D printing and a build head configured to support at least a portion of a 3D object. The present disclosure describes additional hardware configurations for performing the 3D printing.

In an aspect, the present disclosure provides a system for printing a three-dimensional (3D) object, comprising: a platform comprising an area configured to hold a mixture including a photoactive resin, wherein the platform comprises a first coupling unit; an optical source configured to provide light to the mixture for curing the photoactive resin in at least a portion of the mixture to print at least a portion of the 3D object; and a build head configured to support the at least the portion of the 3D object during printing, wherein the build head comprises a second coupling unit that is configured to couple to the first coupling unit to provide an alignment of the area of the platform relative to a surface of the build head while printing the at least the portion of the 3D object.

In some embodiments, the first coupling unit or the second coupling unit comprises at least one releasable fastener configured to promote the coupling of the first coupling unit and the second coupling unit. In some embodiments, the first coupling unit and the second coupling unit comprises at least one releasable fastener configured to promote the coupling of the first coupling unit and the second coupling unit. In some embodiments, the at least one fastener comprises at least one magnet.

In some embodiments, the system further comprises a controller configured to direct the optical source to provide the light to the mixture to cure the photoactive resin in the at least the portion of the mixture.

In some embodiments, the build head and the platform are configured to undergo relative motion towards or away from one another along an axis. In some embodiments, the build head is configured to move along the axis while the platform is stationary along the axis. In some embodiments, the platform is configured to move along the axis while the build head is stationary along the axis. In some embodiments, both the build head and the platform are configured to move along the axis toward or away from one another.

In some embodiments, the system further comprises a controller configured to direct the build head or the platform to undergo motion towards or away from one another along the axis. In some embodiments, the system further comprises a controller configured to direct the build head and the platform to undergo motion towards or away from one another along the axis. In some embodiments, the controller is further configured to (i) direct the build head and/or the platform to undergo motion towards one another along the axis, and (ii) couple the first coupling unit to the second coupling unit. In some embodiments, the controller is further configured to direct the build head or the platform to undergo motion towards one another along the axis until the coupling of the first coupling unit and the second coupling unit. In some embodiments, the controller is further configured to direct the build head and the platform to undergo motion towards one another along the axis until the coupling of the first coupling unit and the second coupling unit. In some embodiments, the controller is further configured to (i) disconnect the coupling of the first coupling unit and the second coupling unit, and (ii) direct the build head or the platform to undergo motion away from one another along the axis. In some embodiments, the controller is further configured to (i) disconnect the coupling of the first coupling unit and the second coupling unit, and (ii) direct the build head and the platform to undergo motion away from one another along the axis.

In some embodiments, the area is configured to move relative to the platform along an additional axis. In some embodiments, the area is configured to move across the platform along the additional axis. In some embodiments, the axis and the additional axis are the same. In some embodiments, the axis and the additional axis are different. In some embodiments, the axis and the additional axis are perpendicular to one another. In some embodiments, the system further comprises a controller configured to direct the area to move relative to the platform along the additional axis.

In some embodiments, the first coupling unit is part of the area. In some embodiments, the first coupling unit and the area are different. In some embodiments, the first coupling unit protrudes from a surface of the platform. In some embodiments, the area and the surface of the platform are parallel to one another. In some embodiments, the area and the surface of the platform are on the same plane. In some embodiments, the first coupling unit protrudes from the surface of the platform by an adjustable height. In some embodiments, the first coupling unit comprises an actuator to control the adjustable height. In some embodiments, the system further comprises a controller configured to direct the actuator to control the adjustable height of the first coupling unit.

In some embodiments, the second coupling unit protrudes from the surface of the build head. In some embodiments, the second coupling unit protrudes from the surface of the build head by an adjustable height. In some embodiments, the second coupling unit comprises an actuator to control the adjustable height. In some embodiments, the system further comprises a controller configured to direct the actuator to control the adjustable height of the second coupling unit.

In some embodiments, the alignment forms a film of the mixture between the area of the platform and the surface of the build head, wherein the film has a thickness.

In some embodiments, the coupling of the first coupling unit and the second coupling unit comprises a kinematic coupling.

In some embodiments, the system further comprises a sensor configured to detect the coupling of the first coupling unit and second coupling unit. In some embodiments, the system further comprises a controller configured to direct the sensor to detect the coupling of the first coupling unit and second coupling unit. In some embodiments, the controller is further configured to direct the build head or the platform to undergo motion towards one another along an axis until the sensor detects the coupling of the first coupling unit and second coupling unit. In some embodiments, the controller is further configured to direct the build head and the platform to undergo motion towards one another along an axis until the sensor detects the coupling of the first coupling unit and second coupling unit. In some embodiments, the sensor is part of the first coupling unit and/or the second coupling unit.

In some embodiments, the sensor comprises a contact sensor and/or a non-contact sensor. In some embodiments, the contact sensor or the non-contact sensor comprises a pressure sensor configured to detect a pressure between the first coupling unit and the second coupling unit. In some embodiments, the contact sensor and the non-contact sensor comprises a pressure sensor configured to detect a pressure between the first coupling unit and the second coupling unit. In some embodiments, the non-contact sensor comprises an electrical current sensor configured to detect an electrical current between the first coupling unit and the second coupling unit. In some embodiments, the non-contact sensor comprises a magnetic field sensor configured to detect a magnetic field between the first coupling unit and the second coupling unit. In some embodiments, the non-contact sensor comprises a camera. In some embodiments, the contact sensor comprises a piezoelectric sensor. In some embodiments, the contact sensor comprises a force sensor. In some embodiments, the contact sensor comprises a contact switch.

In some embodiments, the system further comprises a deposition head configured to move across the area and deposit the mixture over the area.

In some embodiments, the area is part of a vat configured to hold the mixture. In some embodiments, the vat comprises a print window, and wherein the optical source is configured to provide the light through the print window and to the mixture.

In some embodiments, the area is an open substrate configured to hold a film of the mixture, and wherein the open substrate does not have any sidewall that contacts the film of the mixture during the printing. In some embodiments, the open substrate comprises a print window, and wherein the optical source is configured to provide the light through the print window and to the mixture.

In some embodiments, the mixture further comprises one or more particles. In some embodiments, the one or more particles comprise at least one metal particle, at least one ceramic particle, or a combination thereof.

Another aspect of the present disclosure provides a method for printing a three-dimensional (3D) object, comprising: (a) providing (i) a platform comprising an area comprising a mixture including a photoactive resin, wherein the platform comprises a first coupling unit, (ii) an optical source in optical communication with the mixture, wherein the optical source provides light for curing the photoactive resin in at least a portion of the mixture to print at least a portion of the 3D object, and (iii) a build head that supports the at least the portion of the 3D object during printing, wherein the build head comprises a second coupling unit; and (b) coupling the first coupling unit to the second coupling unit to provide an alignment of the area of the platform relative to a surface of the build head while printing the at least the portion of the 3D object.

In some embodiments, the first coupling unit or the second coupling unit comprises at least one releasable fastener configured to promote the coupling of the first coupling unit and the second coupling unit. In some embodiments, the first coupling unit and the second coupling unit comprises at least one releasable fastener configured to promote the coupling of the first coupling unit and the second coupling unit. In some embodiments, the at least one fastener comprises at least one magnet.

In some embodiments, the method further comprises, subsequent to (b), directing the optical source to provide the light to the mixture to cure the photoactive resin in the at least the portion of the mixture.

In some embodiments, the method further comprises directing the build head or the platform to undergo motion towards or away from one another along an axis. In some embodiments, the method further comprises directing the build head and the platform to undergo motion towards or away from one another along an axis. In some embodiments, the method further comprises directing the build head to move along the axis while the platform is stationary along the axis. In some embodiments, the method further comprises directing the platform to move along the axis while the build head is stationary along the axis. In some embodiments, the method further comprises directing both the build head and the platform to move along the axis toward or away from one another. In some embodiments, the method further comprises, in (b), (i) directing the build head and/or the platform to undergo motion towards one another along the axis and (ii) coupling the first coupling unit to the second coupling unit. In some embodiments, the method further comprise, in (b), directing the build head and/or the platform to undergo motion towards one another along the axis until the coupling of the first coupling unit and the second coupling unit. In some embodiments, the method further comprises, subsequent to (b), (i) disconnecting the coupling of the first coupling unit and the second coupling unit, and (ii) directing the build head and/or the platform to undergo motion away from one another along the axis.

In some embodiments, the method further comprises directing the area to move relative to the platform along an additional axis. In some embodiments, the method further comprises directing the area to move across the platform along the additional axis. In some embodiments, the axis and the additional axis are the same. In some embodiments, the axis and the additional axis are different. In some embodiments, the axis and the additional axis are perpendicular to one another.

In some embodiments, the first coupling unit is part of the area. In some embodiments, the first coupling unit and the area are different. In some embodiments, the first coupling unit protrudes from a surface of the platform. In some embodiments, the area and the surface of the platform are parallel to one another. In some embodiments, the area and the surface of the platform are on the same plane. In some embodiments, the first coupling unit protrudes from the surface of the platform by an adjustable height. In some embodiments, the first coupling unit comprises an actuator to control the adjustable height. In some embodiments, the method further comprises directing the actuator to control the adjustable height of the first coupling unit.

In some embodiments, the second coupling unit protrudes from the surface of the build head. In some embodiments, the second coupling unit protrudes from the surface of the build head by an adjustable height. In some embodiments, the second coupling unit comprises an actuator to control the adjustable height. In some embodiments, the method further comprises directing the actuator to control the adjustable height of the second coupling unit.

In some embodiments, the alignment forms a film of the mixture between the area of the platform and the surface of the build head, wherein the film has a thickness.

In some embodiments, the coupling of the first coupling unit and the second coupling unit comprises a kinematic coupling.

In some embodiments, the method further comprises, in (b), directing a sensor to detect the coupling of the first coupling unit and second coupling unit. In some embodiments, the method further comprises, in (b), directing the build head and/or the platform to undergo motion towards one another along an axis until the sensor detects the coupling of the first coupling unit and second coupling unit. In some embodiments, the sensor is part of the first coupling unit and/or the second coupling unit.

In some embodiments, the sensor comprises a contact sensor and/or a non-contact sensor. In some embodiments, the contact sensor and/or the non-contact sensor comprises a pressure sensor configured to detect a pressure between the first coupling unit and the second coupling unit. In some embodiments, the non-contact sensor comprises an electrical current sensor configured to detect an electrical current between the first coupling unit and the second coupling unit. In some embodiments, the non-contact sensor comprises a magnetic field sensor configured to detect a magnetic field between the first coupling unit and the second coupling unit. In some embodiments, the non-contact sensor comprises a camera. In some embodiments, the contact sensor comprises a piezoelectric sensor. In some embodiments, the contact sensor comprises a force sensor. In some embodiments, the contact sensor comprises a contact switch.

In some embodiments, the method further comprises, in (a), directing a deposition head to move across the area and deposit the mixture over the area.

In some embodiments, the area is a part of a vat configured to hold the mixture. In some embodiments, the vat comprises a print window, further comprising, subsequent to (b), directing the optical source to provide the light through the print window to the mixture.

In some embodiments, the area is an open substrate configured to hold a film of the mixture, and wherein the open substrate does not have any sidewall that contacts the film of the mixture during the printing. In some embodiments, the open substrate comprises a print window, further comprising, subsequent to (b), directing the optical source to provide the light through the print window and to the mixture.

In some embodiments, the mixture further comprises one or more particles. In some embodiments, the one or more particles comprise at least one metal particle, at least one ceramic particle, or a combination thereof.

In another aspect, the present disclosure provides A method for three-dimensional (3D) printing, comprising: (a) providing a printing unit comprising: (1) a substrate comprising (i) a surface capable of holding a mixture for printing a 3D object and (ii) a back surface opposite from the surface; (2) a base disposed adjacent to the substrate, wherein the base comprises one or more channels in fluid communication with the back surface, wherein the one or more channels are disposed opposite from at least a portion of the surface; and (3) a vacuum unit operatively coupled to the one or more channels; and (b) using the vacuum unit to provide a vacuum between the base and the back surface.

In some embodiments, the method further comprises, subsequent to (b), depositing the mixture adjacent to the surface such that the one or more channels are disposed opposite from at least a portion of the mixture. In some embodiments, the printing unit further comprises an optical source, the method further comprising using the optical source to provide light through at least the one or more channels and towards the at least the portion of the mixture.

In some embodiments, the method further comprises using the optical source to provide light through the at least the one or more channels, through the back surface, through the surface, and towards the at least the portion of the mixture. In some embodiments, the light is provided at a wavelength or wavelength range that is not sufficient to cure the mixture. In some embodiments, the light is infrared light.

In some embodiments, the printing unit further comprises a housing that (i) is operatively coupled to the vacuum unit and (ii) seals at least the back surface from an ambient environment. In some embodiments, the housing comprises a vacuum port, wherein the vacuum unit is in fluid communication with the one or more channels via the vacuum port. In some embodiments, the housing further seals the optical source from the ambient environment.

In some embodiments, the optical source is coupled to at least a portion of the base.

In some embodiments, the base comprises a ceramic material. In some embodiments, the base has a stiffness of at least about 5 gigapascal (GPa). In some embodiments, the base has a porosity ranging between about 1% to about 30% by volume of the base. In some embodiments, the one or more channels comprise a plurality of pores, wherein a pore of the plurality of pores has a diameter ranging between about 5 micrometers (μm) to about 500 μm.

In some embodiments, the substrate is transparent or semi-transparent. In some embodiments, the substrate is flexible.

Another aspect of the present disclosure provides a system for three-dimensional (3D) printing, comprising: a substrate comprising (i) a surface configured to hold a mixture for printing a 3D object and (ii) a back surface opposite from the surface; a base disposed adjacent to the substrate, wherein the base comprises one or more channels in fluid communication with the back surface, wherein the one or more channels are disposed opposite from at least a portion of the surface; a vacuum unit operatively coupled to the one or more channels, wherein the vacuum unit is configured to provide a vacuum between the base and the back surface; and a controller operatively coupled to the vacuum unit, wherein the controller is configured to direct the vacuum unit to provide the vacuum between the base and the back surface.

In some embodiments, the system further comprises an optical source configured to provide light through at least the one or more channels and towards the surface.

In some embodiments, the optical source is configured to provide the light through the at least the one or more channels, through the back surface, and towards the surface. In some embodiments, the optical source is configured to provide the light at a wavelength or wavelength range that is not sufficient to cure the mixture. In some embodiments, the light is infrared light.

In some embodiments, the system further comprises a housing (i) operatively coupled to the vacuum unit and (ii) configured to seal at least the back surface from an ambient environment. In some embodiments, the housing comprises a vacuum port, wherein the vacuum unit is in fluid communication with the aid one or more channels via the vacuum port. In some embodiments, the housing is further configured to seal the optical source from the ambient environment.

In some embodiments, the optical source is coupled to at least a portion of the base.

In some embodiments, the base comprises a ceramic material. In some embodiments, the base has a stiffness of at least about 5 gigapascal (GPa). In some embodiments, the base has a porosity ranging between about 1% to about 30% by volume of the base. In some embodiments, the one or more channels comprise a plurality of pores, wherein a pore of the plurality of pores has a diameter ranging between about 5 micrometers (μm) to about 500 μm.

In some embodiments, the substrate is transparent or semi-transparent. In some embodiments, the substrate is flexible.

Another aspect of the present disclosure provides a method for three-dimensional (3D) printing, comprising: (a) providing a printing unit comprising: (1) a substrate comprising (i) a surface holding a mixture for printing a 3D object and (ii) a back surface opposite from the surface; (2) a build head disposed adjacent to the surface; and (3) a base unit comprising a window; and (b) moving the base unit across the back surface to provide at least a portion of the window adjacent to the back surface.

In some embodiments, in (b), the base unit generates a contact between at least a portion of the mixture to (i) the build head or (ii) a previous layer of the 3D object disposed adjacent to the build head. In some embodiments, in (b), the moving the base unit reduces a vertical distance between at least a portion of the surface and the build head.

In some embodiments, the method further comprises, in (b), arranging the substrate to remain horizontally stationary during the movement of the base unit. In some embodiments, the method further comprises, in (b), arranging the build head to remain horizontally or vertically stationary during the movement of the base unit. In some embodiments, the method further comprises arranging the build head to remain horizontally and vertically stationary during the movement of the base unit.

In some embodiments, the printing unit further comprises an optical source, and wherein the method further comprises, subsequent to (b), using the optical source to provide light through the window and towards the mixture. In some embodiments, the method further comprises using the optical source to provide the light through the window, through the back surface, through the surface, and towards the mixture. In some embodiments, the method further comprises providing the light at a wavelength or wavelength range that is sufficient to cure at least a portion of the mixture.

In some embodiments, the base unit further comprises one or more actuators, and wherein the method further comprises, in (b), using the one or more actuators for the moving the base unit.

In some embodiments, the base unit further comprises a curved edge or corner that generates an initial contact with at least a portion of the back surface. In some embodiments, the base unit further comprises a wiper that generates an initial contact with at least a portion of the back surface. In some embodiments, (i) an apex edge of the wiper and (ii) a surface of the at least the portion of the window are on a same plane. In some embodiments, the wiper is a blade, a roller, or a rod. In some embodiments, the method further comprises subjecting the wiper and the base unit to motion relative to one another.

In some embodiments, the method further comprises subjecting the surface and the build head to motion relative to one another.

Another aspect of the present disclosure provides a system for three-dimensional (3D) printing, comprising: a substrate comprising (i) a surface configured to hold a mixture for printing a 3D object and (ii) a back surface opposite from the surface; a build head disposed adjacent to the surface; a base unit comprising a window, wherein the base unit is configured to move across the back surface to provide at least a portion of the window adjacent to the back surface; and a controller operatively coupled to the base unit, wherein the controller is configured to direct the base unit to move across the back surface.

In some embodiments, the movement of the base unit is configured to reduce a vertical distance between at least a portion of the surface and the build head.

In some embodiments, the substrate is arranged to remain horizontally stationary during the movement of the base unit. In some embodiments, the build head is arranged to remain horizontally or vertically stationary during the movement of the base unit. In some embodiments, the build head is arranged to remain horizontally and vertically stationary during the movement of the base unit.

In some embodiments, the system further comprises an optical source configured to provide light through the window and towards the surface, wherein the controller is operatively coupled to the optical source and configured to direct the optical source to provide the light through the window and towards the surface. In some embodiments, the controller is operatively coupled to the optical source, and wherein the controller is configured to direct the optical source to provide the light through the window, through the back surface, and towards the surface. In some embodiments, the optical source is configured to provide the light at a wavelength or wavelength range that is sufficient to cure at least a portion of the mixture.

In some embodiments, the base unit further comprises one or more actuators configured to direct the movement of the base unit.

In some embodiments, the base unit further comprises a curved edge or corner configured to generate an initial contact with at least a portion of the back surface. In some embodiments, the base unit further comprises a wiper configured to generate an initial contact with at least a portion of the back surface. In some embodiments, (i) an apex edge of the wiper and (ii) a surface of the at least the portion of the window are on a same plane. In some embodiments, the wiper is a blade, a roller, or a rod. In some embodiments, the system further comprises one or more actuators configured to direct the wiper and the base unit to motion relative to one another.

In some embodiments, the system further comprises one or more actuators configured to direct the surface and the build head to motion relative to one another.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIGS. 1A-1C show an example of a 3D printing system;

FIG. 1D shows an example of a 3D printing system using multi-wavelengths;

FIGS. 2A-2C show another example of a 3D printing system;

FIGS. 3A-3D show a different example of a 3D printing system;

FIGS. 4A-4C show an example of a 3D printing system comprising a deposition zone and a printing zone;

FIGS. 5A and 5B illustrate example flowcharts of methods of using a 3D printing system;

FIG. 6 illustrates an example flowchart of another method of using a 3D printing system;

FIG. 7 illustrates an example flowchart of a different method of using a 3D printing system;

FIGS. 8A-8D illustrate example flowcharts of methods of using different 3D printing systems;

FIGS. 9A and 9B illustrate an example of a vacuum unit for 3D printing;

FIG. 10 illustrates an example flowchart of a method for 3D printing using a vacuum unit;

FIGS. 11A and 11B illustrate an example of a laminator unit for 3D printing;

FIGS. 12A and 12B illustrate examples of a 3D printing system comprising a laminator unit;

FIG. 13 illustrates a perspective view of a laminator unit for 3D printing;

FIGS. 14A-14H schematically illustrate a lamination process for 3D printing;

FIG. 15 illustrates an example flowchart of a method for 3D printing using a laminator unit (i.e., a base unit);

FIG. 16A shows comparative data between 3D structures generated with or without a laminator unit;

FIGS. 16B-16C show images of 3D structures generated with or without a laminator unit; and

FIG. 17 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “three-dimensional object” (also “3D object”), as used herein, generally refers to an object or a part that is printed by three-dimensional (“3D”) printing. The 3D object may be at least a portion of a larger 3D object or an entirety of the 3D object. The 3D object may be fabricated (e.g., printed) in accordance with a computer model of the 3D object.

The term “platform,” as used herein, generally refers to a structure that supports a mixture (e.g., a liquid) or a film of the mixture during 3D printing. The mixture may have a viscosity that is sufficient to permit the mixture to remain on or adjacent to the platform during 3D printing. The platform may be flat. The platform may include an optically transparent or semi-transparent print window (e.g., glass or a polymer) to direct light (e.g., one or more lights) through the window and to the mixture or the film of the mixture. Alternatively or in addition to, the light may be directed from above and/or one or more sides of the platform. The platform may have various shapes. The platform may be a rectangle or a ring, for example.

The platform may comprise one or more walls adjacent to the platform, such as at least 1, 2, 3, or 4 walls. The walls may enclose the platform. During printing, a property (e.g., viscosity) of a mixture used for printing may be sufficient to keep the mixture adjacent to the platform without sufficient flow of the mixture towards the one or more walls. In some examples, the walls prevent flow of the mixture out of the open platform. In some examples, the platform may be part (e.g., a bottom portion) of a container or a vat.

The platform may be an “open platform” that is not bounded by any wall. The he open platform may not be vat or a container. The open platform may not be part of a vat or a container. The open platform may be a substrate or slab that does not have a depression (e.g., vat or container) for retaining a liquid. In such situations, the mixture may be sufficiently viscous such that the mixture remains on the open platform. The open platform may include one or more sides that are not bounded.

The platform may comprise an area configured to hold the mixture. The area may be at least a portion of the platform (e.g., at least a portion of a surface of the platform). The area may be an additional object (e.g., a sheet, plaster, film, glass, window, etc.) disposed on or adjacent to the platform. The area may be stationary relative to the platform. Alternatively or in addition to, the area may be movable relative to the platform.

The term “print surface,” as used herein, generally refers to at least a portion of the platform (e.g., a print area or print window) or at least a portion of an object disposed on or adjacent to the platform (e.g., a film) that is configured to hold a film of the mixture or any excess thereof during the 3D printing.

The term “build head,” as used herein, generally refers to a structure that supports at least a portion of a printed 3D object (or another object onto which a 3D object may be printed). During the 3D printing, the build head or the at least the portion of the printed 3D object that is disposed on the build head may be in contact with a mixture (e.g., a film of a mixture), and at least a portion of the mixture may be formed into a new portion (e.g., layer) of the 3D object.

A relative distance between the platform (e.g., a print window of the platform, a film disposed on or adjacent to the platform) and the build head may be adjustable (e.g., by one or more actuators coupled to the platform and/or the build head). A relative position of the build head with respect to the platform may be adjustable. The build head may be movable relative to the platform. Hence, the moving piece may be the build head, the platform, or both. A distance between a surface of the build head and a surface of the platform may be adjustable by the one or more actuators. A relative movement between the build head and at least a portion of the platform (e.g., a print window of the platform, a film disposed on or adjacent to the platform) may comprise one or more motions, such as, for example, sliding, rotating, and/or twisting motions. Such relative movement may take place in one or more coordinate directions (e.g., x-, y-, and/or z-axis).

The term “coupling unit,” as used herein, generally refers to a device configured to connect or complex to an object (and/or to one another). The coupling unit may comprise one or more connection mechanisms configured to connect to the object (and/or to one another). A first coupling unit and a second coupling unit may be configured to pair with one another (e.g., male-to-female pairing) to create a connection (e.g., directly or indirectly) between the first and second coupling units. In such cases, the connection mechanism(s) may be part of the first coupling unit, the second coupling unit, or both. Examples of the connection mechanism(s) can include, but are not limited to, various male-to-female fasteners (e.g., mating or interlocking fasteners, hooks and holes, hooks and loops such as Velcro™, a female nut threaded onto a male bolt, a male protrusion inserted into a female indentation in LEGO blocks, a male threaded pipe fitted into a female threaded elbow in plumbing, a male universal serial bus (USB) plug inserted into a female USB socket, etc.), tethers (e.g., string tethers), adhesives (e.g., solids, semi-solids, gels, viscous liquids, etc.), magnets (e.g., electromagnet or permanent magnet), and other grasping mechanisms (e.g., one or more robotic arms). Coupling may be performed using an electric field between two plates. The coupling mechanism may be reversible or irreversible.

At least a portion of a surface of the coupling unit may be flat or textured. The at least the portion of the surface of the coupling unit may be partially or entirely smooth, knurled, or serrated to adjust contact surface area and/or frictional force between the at least the portion of the surface of the coupling unit and its target surface of a target object.

The one or more coupling units may or may not have an adjustable height. At least a portion of a coupling unit may be height adjustable. A coupling unit may comprise a top surface and a bottom surface, and a height of the top surface may be adjustable (e.g., via one or more actuators) relative to the bottom surface. A coupling unit may be operatively coupled to an object (e.g., the platform or the build head), and the height of the top surface of the coupling unit may be adjustable relative to a surface of the object. Adjusting a height of one or more coupling units during the 3D printing may be configured to adjust a relative distance between the platform and the build head during the 3D printing.

The platform comprising the coupling unit(s) may be an open platform (or open substrate) configured to hold the mixture. In some examples, the open substrate may not have any sidewall that contacts the film of the mixture (or layer of mixture disposed on or adjacent to the open substrate) during the printing. In some examples, the open substrate may comprise a print window, and one or more optical sources may be configured to provide the light through the print window and to the mixture.

As an alternative, the platform comprising the coupling unit(s) may be part of a vat or a container. In such cases, the coupling unit(s) of the platform may be inside and/or outside of the vat. In some examples, the area may be part of a vat configured to hold the mixture. In an example, the vat may comprise a print window, and one or more optical sources may be configured to provide the light through the print window and to the mixture.

The build head and/or the platform may comprise at least one coupling unit, and the coupling unit may be in digital communication with a controller (e.g., computer software) to determine when and whether the coupling unit has generated a connection (e.g., a physical connection) between the build head and the platform.

The coupling unit may comprise a sensor or be operatively coupled to a sensor. The sensor may be configured to determine a degree of time and/or characteristic (e.g., force, pressure, electricity, magnetic field, etc.) of the connection mechanism of the coupling unit. The sensor may be operatively coupled to a surface of the coupling unit that is configured to generate the connection between the platform and the build head. A coupling unit may comprise or be operatively coupled to at least 1, 2, 3, 4, 5, or more sensors. A coupling unit may comprise or be operatively coupled to at most 5, 4, 3, 2, or 1 sensor(s). The sensor may comprise a contact sensor and/or a non-contact sensor.

The term “sensor,” as used herein, generally refers to a device, system, or a subsystem that provides a feedback (e.g., electromagnetic radiation absorbance and/or reflectance, image, video, distance, pressure, force, electrical current, electrical potential, magnetic field, position, angle, displacement, distance, speed, acceleration, etc.). Such feedback may correspond to or be correlated with one or more components of the 3D printing system (e.g., one or more coupling units, a mixture of a film of a mixture, the build head, the platform, etc.) or the 3D printing process (e.g., coupling of a coupling unit to an object or to another coupling unit, deposition of a film of a mixture over an area of the platform, etc.). Examples of the sensor can include, but are not limited to, light sensor, speed sensor, pressure sensor, tactile sensor, chemical sensor, current sensor, electroscope, galvanometer, hall effect sensor, hall probe, magnetic anomaly detector, magnetometer, magnetoresistance, magnetic field sensor (e.g., microelectromechanical systems (MEMS) magnetic field sensor), metal detector, planar hall sensor, voltage detector, etc. Additional examples of the sensor can include, but are not limited to, capacitive displacement sensor, flex sensor, free fall sensor, gyroscopic sensor, impact sensor, inclinometer, piezoelectric sensor, linear encoder, liquid capacitive inclinometers, odometer, photoelectric sensor, piezoelectric sensor, position sensor, angular rate sensor, rotary encoder, shock detector (i.e., impact monitor), tilt sensor, ultrasonic thickness gauge, variable reluctance sensor, velocity receiver, a colorimeter, infrared sensor, photodetector, phototransistor, force sensor, tactile sensor, strain gauge, temperature sensor, Doppler radar, motion detector, proximity sensor, speed sensor, etc. In some cases, the sensor may be a switch, comprising, for example, a contact switch (e.g., a high precision contact switch), a limit switch, a reed switch. In some cases, the sensor may be a level.

The term “kinematic coupling,” as used herein, generally refers to one or more fixtures (e.g., at least 1, 2, 3, 4, 5, or more fixtures) configured to control or constrain distance, force, and/or location of coupling of two or more structural interfaces (e.g., at least 2, 3, 4, 5, or more structural interfaces). Reproducibility and precision of the kinematic coupling between the two or more structural interfaces may be at least in part due an exact constraint design, wherein a number of points of constraint may equal to a number of degrees of freedom to be constrained. In some examples, in a mechanical system, such as the 3D printing system of the present disclosure, there may be three potential degrees of freedom (e.g., three linear degrees of freedom including x-, y-, and z-axes) to be controlled. There may be six potential degrees of freedom, comprising three linear degrees of freedom (e.g., the x, y, and z axes) and three rotational degrees of freedom (e.g., around each of the three axes, i.e., pitch, roll, and yaw).

The term “mixture,” as used herein, generally refers to a material that is usable to print a 3D object. The mixture may be referred to as a resin. The mixture may be dispensed from a nozzle and over an area. Such area can be an area of a platform (e.g., a print window) or a film (e.g., an opaque, transparent, and/or a semi-transparent film). The mixture may be a liquid, semi-liquid, or solid. The mixture may have a viscosity sufficient to be self-supporting on the print window without flowing or sufficient flowing. The viscosity of the mixture may range, for example, from about 4,000 centipoise (cP) to about 2,000,000 cP. The mixture may be pressed (e.g., by a wiper or a build head) into a film of the mixture on or over such area (e.g., the print window, the film, etc.). A thickness of the film of the mixture may be adjustable. The mixture may include a photoactive resin. The photoactive resin may include a polymerizable and/or cross-linkable component (e.g., a precursor) and a photoinitiator that activates curing of the polymerizable and/or cross-linkable component, to thereby subject the polymerizable and/or cross-linkable component to polymerization and/or cross-linking. The photoactive resin may include a photoinhibitor that inhibits curing of the polymerizable and/or cross-linkable component. In some examples, the mixture may include a plurality of particles (e.g., polymer particles, metal particles, ceramic particles, combinations thereof, etc.). In such a case, the mixture may be a slurry or a photopolymer slurry. The mixture may be a paste. The plurality of particles may be added to the mixture. The plurality of particles may be solids or semi-solids (e.g., gels). Examples of non-metal material include metallic, intermetallic, ceramic, polymeric, or composite materials. The plurality of particles may be suspended throughout the mixture. The plurality of particles in the mixture may have a distribution that is monodisperse or polydisperse. In some examples, the mixture may contain additional optical absorbers and/or non-photoreactive components (e.g., fillers, binders, plasticizers, stabilizers such as radical inhibitors, etc.). The 3D printing may be performed with at least 1, 2, 3, 4, 5, 6, 7, 8, 9, 10 or more mixtures. A plurality of mixtures comprising different materials (e.g., different photoactive resin and/or different plurality of particles) may be used for printing a multi-material 3D object.

The terms “mixture” and “viscous liquid” may be used interchangeably in the present disclosure.

The term “particles,” as used here, generally refers to any particulate material that may be incorporated into the mixture. The particles may be incorporated to alter (e.g., increase, decrease, stabilize, etc.) a material property (e.g., viscosity) of the mixture. The particles may be configured to be melted or sintered (e.g., not completely melted). The particulate material may be in powder form. The particles may be inorganic materials. The inorganic materials may be metallic (e.g., aluminum or titanium), intermetallic (e.g., steel alloys), ceramic (e.g., metal oxides) materials, or any combination thereof. The powders may be coated by one or more polymers. The term “metal” or “metallic” generally refers to both metallic and intermetallic materials. The metallic materials may include ferromagnetic metals (e.g., iron and/or nickel). The particles may have various shapes and sizes. For example, a particle may be in the shape of a sphere, cuboid, or disc, or any partial shape or combination of shapes thereof. The particle may have a cross-section that is circular, triangular, square, rectangular, pentagonal, hexagonal, or any partial shape or combination of shapes thereof. Upon heating, the particles may sinter (or coalesce) into a solid or porous object that may be at least a portion of a larger 3D object or an entirety of the 3D object. The 3D printing may be performed with at least 1, 2, 3, 4, 5, 6, 7, 8, 9, 10 or more types of particles.

The term “a film of a mixture” or “a layer of mixture,” as used interchangeably herein, generally refers to a layer of the mixture that is usable to print a 3D object. The film of the mixture may have a uniform or non-uniform thickness across the film of the mixture. The film of the mixture may have an average thickness or a variation of the thickness that is below, within, or above a defined threshold (e.g., a value or a range). The average thickness or the variation of the thickness of the film of the mixture may be detectable and/or adjustable during the 3D printing. An average (mean) thickness of the film of the mixture may be an average of thicknesses from at least about 2, 3, 4, 5, 6, 7, 8, 9, 10, 15, 20, 30, 40, 50, 100, 200, 300, 400, 500, 1000, 2000, 3000, 4000, 5000, or more positions within the film of the mixture. An average (mean) thickness of the film of the mixture may be an average of thicknesses from at most about 5000, 4000, 3000, 2000, 1000, 500, 400, 300, 200, 100, 50, 40, 30, 20, 15, 10, 9, 8, 7, 6, 5, 4, 3, or 2 positions within the film of the mixture. A variation of the thickness of the film of the mixture may be a variance (i.e., sigma squared or “62”) or standard deviation (i.e., sigma or “G”) within a set of thicknesses from the at least about 2, 3, 4, 5, 6, 7, 8, 9, 10, 15, 20, 30, 40, 50, 100, 200, 300, 400, 500, 1000, 2000, 3000, 4000, 5000, or more positions within the film of the mixture. A variation of the thickness of the film of the mixture may be a variance or standard deviation within a set of thicknesses from the at most about 5000, 4000, 3000, 2000, 1000, 500, 400, 300, 200, 100, 50, 40, 30, 20, 15, 10, 9, 8, 7, 6, 5, 4, 3, or 2 positions within the film of the mixture.

During 3D printing, one or more parameters (e.g., (1) a speed of deposition of a film of a mixture adjacent to a surface of an area of a platform (e.g., a print window, a film, etc.), (2) a speed of extrusion of the mixture from a nozzle onto the area of the platform, (3) an amount of the mixture extruded onto the area of the platform, (4) intensity and/or exposure time of one or more lights from one or more light sources, (5) speed of a relative movement between the platform and the build head, (6) a force (e.g., a contact force, approach force, etc.) between a portion of the platform (e.g., one or more coupling units of the platform) and a portion of the build head (e.g., one or more coupling units of the build head) during the relative movement in (5), (7) a force exerted by the build head onto the mixture on or adjacent to the platform, etc.) may be maintained or adjusted to maintain or improve print quality (e.g., a quality of the film of the mixture prior to printing at least a portion of the 3D object, or the printed portion of the 3D object, etc.).

The film of the mixture that is usable to print the 3D object may or may not be re-deposited (e.g., adjacent to the area of the platform) prior to printing at least a portion of the 3D object. For re-deposition, the film of the mixture that is usable to print the 3D object may be removed and a new film of the mixture may be re-deposited prior to printing at least a portion of the 3D object. Access mixture from the removed film may or may not be recycled to deposit the new film of the mixture. In some examples, the film of the mixture may be re-deposited until a desired (e.g., pre-determined) thickness, average thickness, a variation of the thickness, area, average area, and/or a variation of the area is obtained.

The term “deposition head,” as used herein, generally refers to a part that may move across an area of a platform configured to hold a mixture (e.g., a print window a platform, a film on or adjacent to the platform, etc.). The deposition head may move across the area and deposit a mixture (e.g., a pool or film of a mixture) over the area. The film of the mixture may have a uniform thickness across the print window. The film of the mixture may not have a uniform thickness across the print window. The thickness of the film may be adjustable. The deposition head may be coupled to a motion stage adjacent to at least the area of the platform. The deposition head may have at least one nozzle to dispense at least one mixture (e.g., a mixture) over the area of the platform. The deposition head may have at least one wiper to form the layer (or film) of the mixture or remove any excess mixture from the area. The deposition head may have at least one actuator to adjust a distance between the at least one wiper and the area of the platform (thereby to adjust a desired thickness of the film of the mixture). In some examples, the deposition head may have a slot die. The deposition head may retrieve any excess mixture from the area of the platform, contain the excess mixture within the deposition head, and/or recycle the retrieved mixture when printing subsequent portions of the 3D object. The deposition head may clean the area of the platform.

The 3D printing may be performed with at least 1, 2, 3, 4, 5, 6, 7, 8, 9, 10 or more deposition heads. Each of a plurality of deposition heads may be in fluid communication with a separate source of mixture. The plurality of deposition heads may be used to deposit and cure alternating films of different mixtures (e.g., different photoactive resins and/or different inorganic particles). Compartmentalizing different mixtures in separate sources and separate deposition heads may improve printing speed and prevent cross-contamination of the different mixtures.

The term “nozzle,” as used herein, generally refers to a component of the deposition head that directs the mixture towards the area of the platform. The nozzle may include an opening for the mixture to enter and an additional opening for the mixture to exit. The nozzle may not comprise any contraction or control mechanism to adjust flow of the mixture towards the open platform. As an alternative, the nozzle may comprise a contraction or control mechanism to adjust the flow of the mixture towards the open platform.

The term “wiper,” as used herein, generally refers to a part that may be in contact with a the area of the platform configured to hold a mixture, the mixture, or another wiper. In some examples, the wiper may be a component of a deposition head. The wiper may be in contact with a mixture to press the mixture into a film. The wiper may be in contact with the area of the platform to remove any excess mixture. A distance between the wiper and the area of the platform may be adjustable. In some examples, the wiper may be a component in a cleaning zone. The wiper may be in contact with another wiper to remove any excess mixture. The wiper may have various shapes, sizes, and surface textures. The wiper may be a blade (e.g., a squeegee blade, a doctor blade), roller, or rod (e.g., wire wound rod), for example. The 3D printing may be performed with at least 1, 2, 3, 4, 5, 6, 7, 8, 9, 10 or more wipers. In some examples, the blade is part of the nozzle or attached to the nozzle.

The deposition head may be a container with an exit orifice opened towards the area of the platform configured to hold the mixture. The mixture may be poured out from the deposition head, through the exit orifice, and towards the area of the platform. The deposition head may be mobile or stationary when the mixture is poured out towards the area of the platform.

One or more lights (e.g., from one or more light sources) may be used to initiate (activate) curing of a portion of the mixture, thereby to print at least a portion of the 3D object. The one or more lights (e.g., from one or more light sources) may be used to inhibit (prevent) curing of a portion of the mixture adjacent to an area of the platform (e.g., a print window, a film on or adjacent to the platform, etc.). The one or more lights (e.g., from one or more light sources) may be used by one or more sensors to determine a profile and/or quality of the mixture (e.g., the film of the mixture) prior to, during, and subsequent to printing the at least the portion of the 3D object.

The 3D printing may be performed with one wavelength. The 3D printing may be performed with at least about 2, 3, 4, 5, 6, 7, 8, 9, 10 or more wavelengths that are different. The 3D printing may be performed with at least about 1, 2, 3, 4, 5, 6, 7, 8, 9, 10 or more lights. The 3D printing may be performed with at least about 1, 2, 3, 4, 5, 6, 7, 8, 9, 10 or more light sources, and it may be desirable to prevent curing of a portion of the mixture (e.g., a film of the mixture) adjacent to the area of the platform (e.g., a print window, a film on or adjacent to the platform, etc.).

The one or more lights may comprise electromagnetic radiation. The term “electromagnetic radiation,” as used herein, generally refers to one or more wavelengths from the electromagnetic spectrum including, but not limited to x-rays (about 0.1 nanometers (nm) to about 10.0 nm; or about 10¹⁸ Hertz (Hz) to about 10¹⁶ Hz), ultraviolet (UV) rays (about 10.0 nm to about 380 nm; or about 8×10¹⁶ Hz to about 915 Hz), visible light (about 380 nm to about 750 nm; or about 8×10¹⁴ Hz to about 4×10¹⁴ Hz), infrared (IR) light (about 750 nm to about 0.1 centimeters (cm); or about 4×10¹⁴ Hz to about 5×10¹¹ Hz), and microwaves (about 0.1 cm to about 100 cm; or about 108 Hz to about 5×10¹¹ Hz).

The one or more light sources may comprise an electromagnetic radiation source. The term “electromagnetic radiation source,” as used herein, generally refers to a source that emits electromagnetic radiation. The electromagnetic radiation source may emit one or more wavelengths from the electromagnetic spectrum.

The term “photoinitiation,” as used herein, generally refers to a process of subjecting a portion of a mixture (e.g., a film of the mixture) to a light to cure a photoactive resin in the portion of the mixture. The light (i.e., “photoinitiation light”) may have a wavelength that activates a photoinitiator that initiates curing of a polymerizable and/or cross-linkable component (e.g., monomers, oligomers, etc.) in the photoactive resin.

The term “photoinhibition,” as used herein, generally refers to a process of subjecting a portion of a mixture (e.g., a film of a mixture) to a light to inhibit curing of a photoactive resin in the portion of the mixture. The light (i.e., “photoinhibition light”) may have a wavelength that activates a photoinhibitor that inhibit curing of a polymerizable and/or cross-linkable component in the photoactive resin. The wavelength of the photoinhibition light and another wavelength of a photoinitiation light may be different. In some examples, the photoinhibition light and the photoinitiation light may be projected from the same optical source. In some examples, the photoinhibition light and the photoinitiation light may be projected from different optical sources.

The term “diffuser,” as used herein, generally refers to a sheet (e.g., a plate) or a film (e.g., a laminate or coating on an optical lens or a window) that diffuses energy (e.g., light). The diffuser may scatter or filter the energy. The diffuser may receive one or more electromagnetic radiations (e.g., IR lights) on a first side of the diffuser, then transmit scattered (e.g., distributed, evenly distributed, etc) electromagnetic radiations from a second side of the diffuser opposite the first side. The transmitted scattered electromagnetic radiations may form a flood electromagnetic radiation. The diffuser may eliminate bright spots corresponding to location(s) of one or more electromagnetic radiation sources. Flux of the scattered electromagnetic radiations from the diffuser may be independent of angle with respect to the diffuser and/or of position within a surface of the diffuser. The diffuser may cause light to spread evenly across a surface (e.g., a surface of the diffuser), thereby minimizing or removing high intensity bright spots as the light travels through the diffuser.

The term “profile,” as used herein, generally refers to a view (e.g., image or video) and/or electromagnetic spectrum with respect to such components. The view may be a side view, bottom-up view, or top-down view. The view may comprise an outline, silhouette, contour, shape, form, figure, structure of the components. The electromagnetic spectrum may be absorption, emission, and/or fluorescence spectrum of at least a portion of the electromagnetic radiation (e.g., IR radiation). The profiles may be indicative of one or more features of the components. In an example, the sensor may be capable of sensing or detecting and/or analyzing zero-dimensional (e.g., a single point), one-dimensional (1D), two-dimensional (2D), and/or 3D profiles (e.g., features) of the components.

The 3D printing system may be surrounded by an enclosure (e.g., a case or fabric). The enclosure may prevent external energy (e.g., ambient light) from interfering with one or more lights used during the 3D printing.

The term “green body,” as used herein, generally refers to a 3D object that has a polymeric material and a plurality of particles (e.g., metal, ceramic, or both) that are encapsulated by the polymeric material. The plurality of particles may be in a polymer (or polymeric) matrix. The plurality of particles may be capable of sintering or melting. The green body may be self-supporting. The green body may be heated in a heater (e.g., in a furnace) to burn off at least a portion of the polymeric material and coalesce the plurality of particles into at least a portion of a larger 3D object or an entirety of the 3D object.

The term “brown body,” as used herein, generally refers to a green body that has been treated (e.g., solvent treatment, heat treatment, pressure treatment, etc.) to remove at least a portion (e.g., at least 20 percent (%), 30%, 40%, 50%, 60%, 70%, 80%, 90%, 95%, or more; at most 100%, 95%, 90%, 80%, 70%, 60%, 50%, 4%, 30%, 20%, or less) of the polymeric material within the green body. The brown body may comprise the plurality of particles of the green body. The plurality of particles may be capable of sintering or melting. The brown body may be self-supporting. The brown body may be heated in a heater (e.g., in a furnace) to burn off at least a portion of any remaining polymeric material and coalesce the plurality of particles into at least a portion of a larger 3D object or an entirety of the 3D object.

The present disclosure provides methods and systems for forming a 3D object. Such methods may employ application of a film of a mixture adjacent to an area of a platform and exposing the film to light to subject at least a portion of the film to polymerization and/or cross-linking. The 3D object may be based on a computer model of the 3D object, such as a computer-aided design (CAD) stored in a non-transitory computer storage medium (e.g., medium).

### Overview

A build head configured to hold at least a portion of a 3D object and a platform configured to hold a mixture usable to form the at least the portion of the 3D object can be configured to move towards each other and press onto the mixture disposed on or adjacent to an area of the platform (e.g., a print window or a film that is configured to hold a mixture). The relative movement towards one another can create a layer of the mixture (e.g., a film or layer of the mixture) having a thickness that is approximately the same as the distance of the gap between an area (or surface) of the build head (or an object disposed on or adjacent to the area of the build head) and the area of the platform. Conventionally, a misalignment between the area of the platform and the area of the build head can occur, which may lead to an uneven thickness across the layer of the mixture disposed between the platform and the build head. The uneven thickness of the layer of the mixture can lead to a newly printed layer of the 3D object having an undesirable, uneven thickness.

In some examples, the build head or the platform may tilt and/or rotate relative to one another during the relative movement towards one another, thereby resulting in their misalignment and the uneven thickness of the layer of the mixture. In an example, the viscosity of the mixture may be such that (e.g., high viscosity due to a plurality of particles dispersed inside the mixture) when the build head moves towards the platform and presses onto a surface of the mixture, the viscosity of the mixture (and/or movement of one or more particles within the mixture) causes the build head to tilt and/or rotate, thereby resulting in the misalignment and uneven thickness of the layer of the mixture.

When the mixture comprises a plurality of particles, a misalignment between the area of the platform and the area of the build head can result in and/or be a result of an uneven distribution of the plurality of particles within such layer of mixture that is disposed between (and pressed by) the platform and the build head.

In view of the foregoing, there exists a considerable need for alternative systems and methods to aid or provide an alignment between the build head and the platform during 3D printing.

### Systems for 3D Printing

In an aspect, the present disclosure provides a system for printing a 3D object, comprising a platform comprising an area configured to hold a mixture including a photoactive resin. The system may comprise an optical source configured to provide light to the mixture for curing the photoactive resin in at least a portion of the mixture to print at least a portion of the 3D object. The system may comprise a build head configured to support the at least the portion of the 3D object during printing. The platform may comprise a coupling unit configured to couple to at least a portion of the build head to provide an alignment of the area of the platform relative to a surface of the build head while printing the at least the portion of the 3D object.

Upon coupling of the coupling unit of the platform to the at least the portion of the build head, the coupling may be released prior to, during, or subsequent to printing the at least the portion of the 3D object (e.g., a layer of the 3D object) by directing the optical source to provide the light to at least a portion of the mixture. At least a portion of the coupling unit may be movable (e.g., retractable) relative to the platform, in order to be capable of releasing the coupling without changing relative positions of the platform and the build head.

The platform may comprise at least 1, 2, 3, 4, 5, 6, 7, 8, 9, 10, or more coupling units. The platform may comprise at most 10, 9, 8, 7, 6, 5, 4, 3, 2, or 1 coupling unit(s). The coupling unit of the platform may generate at least one connection (e.g., a physical connection whereby two objects are in contact with each other) with the at least the portion of the build head. The coupling unit of the platform may be configured to generate at least 1, 2, 3, 4, 5, 6, 7, 8, 9, 10, or more connections with the at least the portion of the build head. The coupling unit of the platform may be configured to generate at most 10, 9, 8, 7, 6, 5, 4, 3, 2, or 1 connection(s) with the at least the portion of the build head.

In another aspect, the present disclosure provides a system for printing a 3D object, comprising a platform comprising an area configured to hold a mixture including a photoactive resin. The system may comprise an optical source configured to provide light to the mixture for curing the photoactive resin in at least a portion of the mixture to print at least a portion of the 3D object. The system may comprise a build head configured to support the at least the portion of the 3D object during printing. The build head may comprise a coupling unit configured to couple to at least a portion of the platform to provide an alignment of the area of the platform relative to a surface of the build head while printing the at least the portion of the 3D object.

Upon coupling of the coupling unit of the build head to the at least the portion of the platform, such coupling may be released prior to, during, or subsequent to printing the at least the portion of the 3D object (e.g., a layer of the 3D object) by directing the optical source to provide the light to at least a portion of the mixture. At least a portion of the coupling unit may be movable (e.g., retractable) relative to the platform, in order to be capable of releasing the coupling without changing relative positions of the platform and the build head.

The build head may comprise at least 1, 2, 3, 4, 5, 6, 7, 8, 9, 10, or more coupling units. The build head may comprise at most 10, 9, 8, 7, 6, 5, 4, 3, 2, or 1 coupling unit(s). The coupling unit of the build head may generate at least one connection (e.g., a physical connection whereby two objects are in contact with each other) with the at least the portion of the platform. The coupling unit of the build head may be configured to generate at least 1, 2, 3, 4, 5, 6, 7, 8, 9, 10, or more connections with the at least the portion of the platform. The coupling unit of the build head may be configured to generate at most 10, 9, 8, 7, 6, 5, 4, 3, 2, or 1 connection(s) with the at least the portion of the platform.

In a different aspect, the present disclosure provides a system for printing a 3D object, comprising a platform that comprises an area configured to hold a mixture including a photoactive resin. The platform may comprise a first coupling unit. The system may comprise an optical source configured to provide light to the mixture for curing the photoactive resin in at least a portion of the mixture to print at least a portion of the 3D object. The system may comprise a build head configured to support the at least the portion of the 3D object during printing. The build head may comprise a second coupling unit that is configured to couple to the first coupling unit to provide an alignment of the area of the platform relative to a surface of the build head while printing the at least the portion of the 3D object.

The alignment or positioning of the area of the platform relative to the surface of the build head may prevent or minimize an incorrect rotation or tiling of (i) the build head relative to the area of the platform, (ii) a previously printed layer of the 3D object disposed on the surface of the build head relative to the area of the platform, and/or (iii) a surface of another object disposed on the surface of the build head relative to the area of the platform.

Upon coupling of the first coupling unit and the second coupling unit, such coupling may be released prior to, during, or subsequent to printing the at least the portion of the 3D object (e.g., a layer of the 3D object) by directing the optical source to provide the light to at least a portion of the mixture. At least a portion of the first coupling unit may be movable (e.g., retractable) relative to the platform, in order to be capable of releasing the coupling without changing relative positions of the platform and the build head. Alternatively or in addition to, at least a portion of the second coupling unit may be movable (e.g., retractable) relative to the build head, in order to be capable of releasing the coupling without changing relative positions of the platform and the build head.

The area may be the open platform or part of the platform. For example, at least about 10%, 15%, 20%, 25%, 30%, 35%, 40%, 45%, 50%, 55%, 60%, 65%, 70%, 75%, 80%, 85%, 90%, 95%, or more of the platform may comprise the area. As another example, at most about 95%, 90%, 85%, 80%, 75%, 70%, 65%, 60%, 55%, 50%, 45%, 40%, 35%, 30%, 25%, 20%, 15%, 10%, or less of the platform may comprise the area. A surface of the area may be flat. A surface of the area may be textured.

The build head may comprise one or more coupling units configured to couple to at least a portion of the platform. The build head may comprise at least 1, 2, 3, 4, 5, 6, 7, 8, 9, 10, or more coupling units. The build head may comprise at most 10, 9, 8, 7, 6, 5, 4, 3, 2, or 1 coupling unit(s). The platform may comprise one or more coupling units configured to couple to at least a portion of the build head. The platform may comprise at least 1, 2, 3, 4, 5, 6, 7, 8, 9, 10, or more coupling units. The platform may comprise at most 10, 9, 8, 7, 6, 5, 4, 3, 2, or 1 coupling unit(s). The build head and the platform may each comprise a coupling unit configured to couple to one another. The build head and the platform may comprise at least 1, 2, 3, 4, 5, 6, 7, 8, 9, 10, or more pairs of the coupling units configured to couple to one another. The build head and the platform may comprise at most 10, 9, 8, 7, 6, 5, 4, 3, 2, or 1 pair(s) of the coupling units configured to couple to one another. In an example, the build head and the platform may comprise three pairs of the coupling units configured to couple to one another.

The coupling between the first and second coupling units may comprise at least one connection (e.g., a physical connection whereby two objects are in contact with each other) between the first and second coupling units. The coupling between the first and second coupling units may comprise at least 1, 2, 3, 4, 5, 6, 7, 8, 9, 10, or more connections between the first and second coupling units. The coupling between the first and second coupling units may comprise at most 10, 9, 8, 7, 6, 5, 4, 3, 2, or 1 connection(s) between the first and second coupling units.

The first coupling unit of the platform may not contact the mixture (or a film of the mixture) disposed on or adjacent to the platform during the 3D printing. Alternatively or in addition to, the first coupling unit of the platform may contact the mixture (or a film of the mixture) disposed on or adjacent to the platform during the 3D printing.

A portion of the platform comprising the first coupling unit may be part of an area of the platform configured to hold the mixture or a film of the mixture. Such area may be referred to as a print surface of the platform. In some examples, the print surface of the platform may comprise print window of the platform, which print window may be configured to hold a mixture or a film of the mixture. The print window (e.g., plastic or ceramic, such as glass) may be opaque, transparent, or semi-transparent. In some examples, the print surface of the platform may comprise a film disposed on or adjacent to the platform, which film may be (i) configured to hold a mixture or a film of the mixture, and/or (ii) opaque, transparent, or semi-transparent. The film may cover at least a portion of the print surface of the platform. The film may be stationary during at least a portion (e.g., the entirety) of the 3D printing process. Alternatively or in addition to, the film may be movable (e.g., over the print surface) during at least a portion of the 3D printing process.

Examples of such film that is configured to hold the mixture or the film of the mixture may comprise one or more thin glasses, or polymers, such as fluoropolymers. Examples of one or more fluoropolymers include fluorinated ethylene propylene (FEP), polyvinylidene fluoride (PVDF), ethylenchlorotrifluoroethylene (ECTFE), ethylenetetrafluoroethylene (ETFE), polytetrafluoroethylene (PTFE), perfluoroalkoxy (PFA), and modified fluoroalkoxy (a copolymer of tetrafluoroethylene and perfluoromethylvinylether, also known as MFA). Another non-limiting example of the film for holding the mixture may be polyethylene terephthalate (PET).

The portion of the platform comprising the first coupling unit may not be part of the print surface of the platform. The first coupling unit and the area (i.e., the print surface) may be different. In such cases, for example, the first coupling unit of the platform may not be in contact with the mixture that is deposited on the platform (e.g., the print surface of the platform).

The first coupling unit and/or the second coupling unit may comprise at least one fastener (e.g., at least one releasable fastener) configured to promote the coupling of the first coupling unit and the second coupling unit. The fastener may automatically be triggered to connect the first and second coupling units and upon a contact (e.g., a physical contact) between the first and second coupling units. Alternatively or in addition to, the fastener may be triggered to connect the first and second coupling units upon an external trigger (e.g., via a controller). The fastener may be releasable to release the coupling between the first and second coupling units. The fastener may be releasable (e.g., automatically releasable) upon a relative pulling motion (e.g., a motion away from one another) between the first coupling unit (or the platform) and the second coupling unit (or the build head). Alternatively or in addition to, the fastener may be triggered to be released upon an external trigger (e.g., via the controller).

Examples of such fastener of the first coupling unit and/or the second coupling unit may include one or more magnets, such as electromagnets (e.g., at least 1, 2, 3, 4, 5, or more magnets per coupling unit, at most 5, 4, 3, 2, or 1 magnet(s) per coupling unit, etc.), male-to-female fasteners, or one or more mechanical clamp mechanisms (e.g., vacuum clamp, electroactive polymer, etc.).

The coupling of the first coupling unit and the second coupling unit may comprise a kinematic coupling (e.g., Kelvin kinematic coupling, Maxwell kinematic coupling, canoe coupling, etc.). In some examples, the kinematic coupling may comprise two structural interfaces comprising the build head and the platform. In some examples, the system may comprise three first coupling units and three second coupling units, wherein each of the first coupling units and each of the second coupling units are configured to couple to one another to generate a kinematic coupling. The use of the kinematic coupling may ensure that there is no degree of freedom left for the build head and/or the platform after the coupling, such that the alignment provided between the build head and the platform remains during printing at least a layer of the 3D object.

The coupling of the first and second coupling units may be driven by a relative movement (e.g., by an actuator coupled to the build head and/or the platform) between the build head and the platform. Alternatively or in addition to, the coupling of the first and second coupling units may be driven by (i) a relative movement of a first portion of the first coupling unit to the platform (e.g., by an actuator coupled to the portion of the first coupling unit) and/or (ii) a relative movement of a second portion of the second coupling unit to the build head (e.g., by an actuator coupled to the portion of the second coupling unit). In an example, the build head and the platform may move relatively in a direction towards one another until the first and second coupling units are brought to a predetermined distance away from one another. Following, (i) the actuator coupled to the first portion of the first coupling unit may direct the first portion to move towards the second coupling unit, and/or (ii) the actuator coupled to the second portion of the second coupling unit may direct the second portion to move towards the first coupling unit, until the first and second coupling units are coupled. Such movement of the portions of the first and second coupling unit relative to the platform or the build head may allow high precision and control of the relative movement between the first and second coupling units.

The actuator coupled to the first coupling unit and/or the second coupling unit may adjust the relative alignment between the build head and the platform prior to, during, and/or subsequent to the printing of at least a portion of the 3D object. Alternatively or in addition to, the actuator coupled to the first coupling unit and/or the second coupling unit may lock and hold the coupling of the first and second coupling units together.

Examples of the actuator provided herein may comprise a servomotor, brushed electric motor, brushless electric motor (e.g., stepper motor), torque motor, and shaft actuator (e.g. hollow shaft actuator).

The system may further comprise a controller configured to direct the optical source to provide the light to the mixture to cure the photoactive resin in the at least the portion of the mixture. The system may comprise at least 1, 2, 3, 4, 5, or more optical sources. The system may comprise at most 5, 4, 3, 2, or 1 optical source(s). Each optical source may direct a single light or a plurality of lights that are different.

The build head and the platform may be configured to undergo relative motion towards or away from one another along an axis (e.g., along at least 1, 2, 3, or more axes, along at most 3, 2, or 1 axis (or axes)). In some examples, the build head may be configured to move along the axis while the platform is stationary along the axis. In some examples, the platform may be configured to move along the axis while the build head is stationary along the axis. In some examples, both the build head and the platform may be configured to move along the axis toward or away from one another.

The system may further comprise a controller configured to direct the build head and/or the platform to undergo motion towards or away from one another along the axis. The controller may be further configured to (i) direct the build head and/or the platform to undergo motion towards one another along the axis, and (ii) couple the first coupling unit of the platform to the second coupling unit of the build head. Alternatively or in addition to, the controller may be further configured to direct the build head and/or the platform to undergo motion towards one another along the axis until the coupling of the first coupling unit and the second coupling unit. In such a case, the controller may be further configured to stop the relative movement of the build head and/or the platform upon the coupling of the first coupling unit and the second coupling unit. Additionally, the controller may be further configured to (i) disconnect the coupling of the first coupling unit and the second coupling unit, and (ii) direct the build head and/or the platform to undergo motion away from one another along the axis.

The area of the platform (e.g., the print surface) may be configured to move relative to (e.g., towards or away from, across, etc.) the platform along an additional axis (e.g., along at least 1, 2, 3, or more additional axes, along at most 3, 2, or 1 additional axis (or axes)). In an example, the area of the platform may be configured to move across the platform. The print surface may be configured to move relative to a region of the platform disposed between the build head and the optical source. The relative movement between the print surface and the region of the platform may be linear (e.g., horizontal and/or vertical with respect to a surface of the platform) and/or rotational. In some examples, the print surface may be a print window configured to hold the mixture, and the print window of the platform may be configured to move relative to the platform along the additional axis. Alternatively or in addition to, the print surface may be a film (e.g., configured to hold the mixture, and the film of the mixture), and the film may be configured to move relative to the platform along the additional axis. In such relative movement, the moving component may be the area of the platform, the platform, or both.

The axis and the additional axis may be the same. The axis and the additional axis may be parallel to one another. Alternatively or in addition to, the axis and the additional axis may be different. The axis and the additional axis may be off by at least 1 degree, 2 degrees, 3 degrees, 4 degrees, 5 degrees, 10 degrees, 20 degrees, 30 degrees, 60 degrees, 90 degrees, 120 degrees, 150 degrees, or more. The axis and the additional axis may be off by 150 degrees, 120 degrees, 90 degrees, 60 degrees, 30 degrees, 20 degrees, 10 degrees, 5 degrees, 4 degrees, 3 degrees, 2 degrees, 1 degree, or less. In some examples, the axis and the additional axis may be perpendicular to one another. In an example, while the build head and the platform may be configured to undergo relative motion towards or away from one another along y-axis, the print surface of the platform may be configured to undergo relative motion across the platform along x-axis that is perpendicular to the y-axis and parallel to a surface of the platform. Additionally, the system may further comprise a controller configured to direct the area (i.e., the print surface) to move relative to (e.g., towards or away from, across, etc.) the platform along the additional axis.

The first coupling unit may not be protruded from a surface of the platform. In such cases, the first coupling unit and the surface of the platform may be part of the same plane. As an alternative, the first coupling unit may be configured to protrude from a surface of the platform. The first coupling unit may be configured to protrude from the surface of the platform by a height (e.g., a stationary height or an adjustable height). The first coupling unit may comprise an actuator to control the adjustable height. The system may further comprise a controller configured to direct the actuator to control the adjustable height of the first coupling unit.

The first coupling unit may be operatively coupled to at least 1, 2, 3, 4, 5, or more actuators to control the adjustable height of the first coupling unit. The first coupling unit may be operatively coupled to at most 5, 4, 3, 2, or 1 actuator(s) to control the adjustable height of the first coupling unit.

The second coupling unit may not be protruded from a surface of the build head. In such cases, the second coupling unit and the surface of the build head may be part of the same plane. As an alternative, the second coupling unit may be configured to protrude from a surface of the build head. The second coupling unit may be configured to protrude from the surface of the build head by a height (e.g., a stationary height or an adjustable height). The second coupling unit may comprise an actuator to control the adjustable height. The system may further comprise a controller configured to direct the actuator to control the adjustable height of the second coupling unit.

The second coupling unit may be operatively coupled to at least 1, 2, 3, 4, 5, or more actuators to control the adjustable height of the second coupling unit. The second coupling unit may be operatively coupled to at most 5, 4, 3, 2, or 1 actuator(s) to control the adjustable height of the second coupling unit.

Examples of the one or more actuators of the first coupling unit and/or the second coupling unit may comprise a stepper actuator, linear actuator, hydraulic actuator, pneumatic actuator, electric actuator, magnetic actuator, mechanical actuator (e.g., rack and pinion, chains, etc.), etc.

The alignment of the area of the platform relative to the surface of the build head (e.g., provided by coupling of the first coupling unit to the second coupling unit) may form a film (or layer) of the mixture between the area of the platform and the surface of the build head. The film of the mixture may have a thickness. The film of the mixture may have a thickness ranging between about 100 nm to about 1000 micrometer (μm). The film of the mixture may have a thickness of at least about 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 100 μm, 200 μm, 300 μm, 400 μm, 500 μm, 600 μm, 700 μm, 800 μm, 900 μm, 1000 μm, or more. The film of the mixture may have a thickness of at most about 1000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, 100 nm, or less.

The system may comprise one or more sensors configured to detect quality (e.g., thickness, defects, volume, etc.) of the film (or layer) of the mixture. The one or more sensors may confirm that such quality of the film of the mixture is within a predetermined threshold (e.g., a tolerance range). In some examples, the thickness of the film of the mixture may have a tolerance ranging between about 10 nm to about 10 μm. The thickness of the film of the mixture may have a tolerance of at least about 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm, 10 μm, or more. The thickness of the film of the mixture may have a tolerance of at most about 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, or less.

The adjustable height of the first coupling unit and/or the second coupling unit may correlate to a designed thickness of the mixture (or a film of the mixture) to be disposed between the print surface of the platform and the surface of the build head (or a surface of an object disposed on the build head). The adjustable height may correlate to at least a thickness of a layer (e.g., a subsequent) of the 3D object to be printed. The adjustable height may correlate to at least a thickness of at least 1, 2, 3, 4, 5, 6, 7, 8, 9, 10, or more layers of the 3D object to be printed. The adjustable height may correlate to at least a thickness of at most 10, 9, 8, 7, 6, 5, 4, 3, 2, or 1 layer(s) of the 3D object to be printed. In some examples, the adjustable height may correlate to a thickness of at least one photoinitiation layer and at least one photoinhibition layer of the 3D printing process.

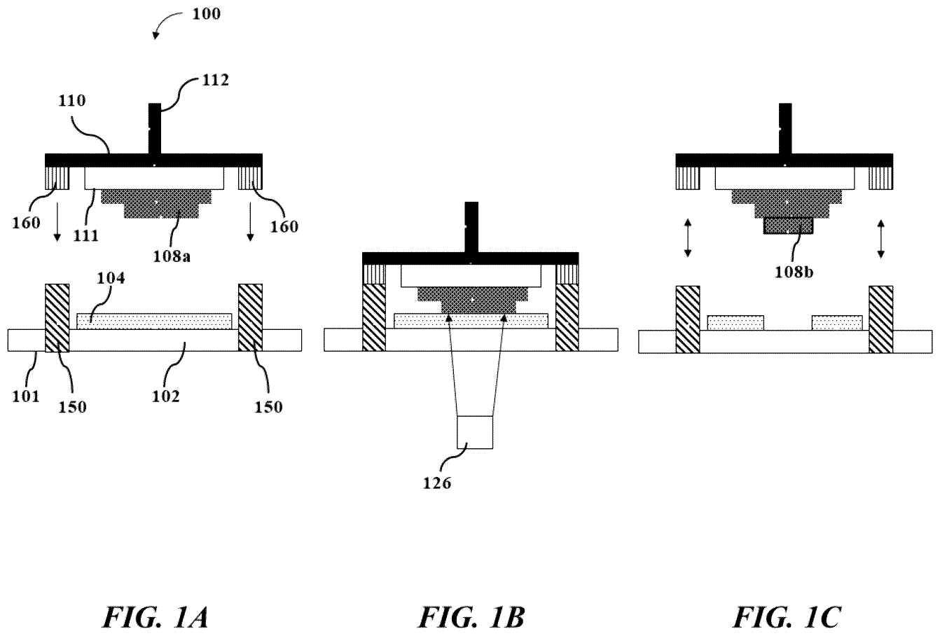

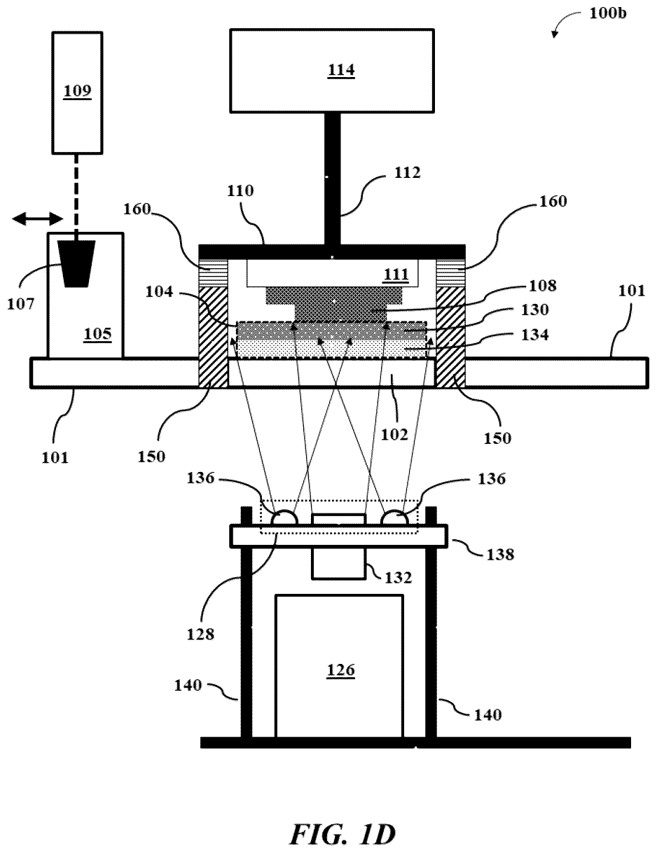

FIG. 1 shows an example of a 3D printing system 100. Referring to FIG. 1A, the system 100 includes a platform 101 comprising an area 102 (i.e., a print surface) configured to hold the mixture 104 or a film of the mixture 104, which includes a photoactive resin. The mixture 104 may include a plurality of particles (e.g., metal, intermetallic, and/or ceramic particles). The platform 101 comprises a plurality of first coupling units 150. The platform 101 is an open platform, wherein the mixture 104 is self-supporting on or adjacent to the print surface 102 of the platform 101 without requiring support or being supported by any wall of the platform 101. The plurality of first coupling units 150 are not in contact with the mixture 104 during 3D printing. The system 100 includes a build head 110 configured to move relative to the platform 101. The build head 110 is movable by an actuator 112 (e.g., a linear actuator) operatively coupled to the build head 110. Alternatively or in addition to, the platform 101 may comprise one or more actuators to move the platform 101 relative to the build head 110. The build head 110 comprises a surface 111 configured to hold at least a portion of a 3D object 108a (e.g., a previously printed portion of the 3D object) or a different object onto which the at least the portion of the 3D object is to be printed. The build head 110 comprises a plurality of second coupling units 160. One of the plurality of second coupling units 160 of the build head 110 is configured to couple to one of the plurality of the first coupling units 150 of the platform 101 to provide an alignment of the print surface 102 of the platform 101 relative to the surface 111 of the build head 110 during 3D printing.

Referring to FIG. 1B, the build head 110 is directed to move in a relative direction towards the platform 101. When the plurality of second coupling units 160 of the build head 110 couple to the plurality of the first coupling units 150 of the platform 101 (e.g., one-to-one coupling), the relative movement between the build head 110 and the platform 101 may pause or stop. The coupling of the first coupling units 150 and second coupling units 160 may yield a film of the mixture 104 disposed between the print surface 102 and the surface of the surface of the object 108a with an approximately contact thickness (or an approximately constant particle density across the film of the mixture 104). Subsequently, one or more optical sources 126 directs one or more lights to the mixture 104 to cure the photoactive resin in the at least the portion of the mixture, thereby to print at least a portion of the 3D object on the surface of the build head 110 or a surface of the object 108a disposed on the surface of the build head 110. The optical source(s) 126 may direct the light(s) through the print surface 102 of the platform 101 and to the at least the portion of the mixture for 3D printing.

Referring to FIG. 1C, after generating a newly printed portion 108b (layer) of the 3D object, the plurality of second coupling units 160 of the build head 110 are de-coupled (or detached) from the plurality of the first coupling units 150 of the platform 101, and the build head 110 is relatively moved in a direction away from the platform 101.

FIG. 1D shows an example of a 3D printing system 100b using multi-wavelengths. The system 100b comprises one or more components of the 3D printing system 100, as provided in FIGS. 1A-1C. The system 100b includes the open platform 101 comprising the print window 102 to hold a layer of the mixture 104, which includes a photoactive resin. The mixture 104 may also include a plurality of particles (e.g., metal, intermetallic, and/or ceramic particles). The system 100b includes a deposition head 105 that comprises a nozzle 107 that is in fluid communication with a source of the mixture 109. The source of the vmixture 109 may be a syringe. The syringe may be operatively coupled to a syringe pump. The syringe pump can direct the syringe in a positive direction (from the source of the mixture 109 towards the nozzle 107) to dispense the mixture onto the platform and within the deposition head. The syringe pump can direct the syringe in a negative direction (away from the nozzle 107 towards the source of the mixzture 109) to retract any excess mixture in the nozzle and/or on the print window back into the syringe. The deposition head 105 is configured to move across the open platform 101 comprising the print window 102 to deposit the film of the mixture 104. The plurality of first coupling units 150 of the platform may not be in the way of the movement of the deposition head 105 during the deposition of the mixture 104. The plurality of first coupling units 150 may be movable (e.g., retractable) such that they can be moved out of the way of the movement of the deposition head 105 during the deposition of the mixture 104. In an example, the system 100 may comprise an additional source of an additional mixture that is in fluid communication with the nozzle 107 or an additional nozzle of the deposition head 105. In another example, the system 100 may comprise an additional deposition head comprising an additional nozzle that is in fluid communication with an additional source of an additional mixture. In a different example, the system 100 may comprise three or more deposition heads and three or more sources of the same or different mixtures.

Once the layer of the mixture 104 is deposited on or adjacent to the print window 102, the build head 110 moves down until the plurality of second coupling units 160 of the build head 110 are coupled to the plurality of first coupling units 150 of the platform 101. The coupling of the first and second coupling units 150 and 160 provides an alignment between the surface 111 of the build head 110 and the surface of the print window 102 (or a surface of a film disposed on or adjacent to the print window 102). Such alignment may produce a new layer of the mixture 104 disposed between the surface 111 and the print window 102, having an average thickness that is defined by the height of the plurality of first coupling units 150 and/or the plurality of the second coupling units 160. Following, illumination is transmitted through the print window 102 to cure at least a portion of the film of the mixture 104 to print at least a portion of a 3D structure 108. The at least the portion of the 3D structure 108 is shown as a block of two layers, however, in practice a wide variety of complicated shapes may be printed. The at least the portion of the 3D structure 108 includes entirely solid structures, hollow core prints, lattice core prints, and generative design geometries.

The at least the portion of the 3D structure 108 is printed on a build head 110, which is connected by a rod 112 to one or more 3D printing mechanisms 114. The 3D printing mechanisms 114 may include various mechanical structures for moving the build head 110 in a direction towards and/or away from the open platform 101. This movement is a relative movement, and thus moving pieces can be the build head 110, the open platform 101, or both, in various embodiments. In some examples, the 3D printing mechanisms 114 include Cartesian (xyz) type 3D printer motion systems or delta type 3D printer motion systems. The 3D printing mechanisms 114 include one or more controllers to direct movement of the build head 110, the open platform 101, or both.

Multiple devices emitting various wavelengths and/or intensities of light, including a light projection device 126 and light sources 128, may be positioned below the print window 102 and in communication with the one or more controllers. The light sources 128 can include at least 2, 3, 4, 5, 6, or more light sources. As an alternative to the light sources 128, a single light source may be used. The light projection device 126 directs a first light having a first wavelength through the print window 102 and into the film of the mixture 104 adjacent to the print window 102. The first wavelength emitted by the light projection device 126 is selected to produce photoinitiation and is used to create at least a portion of the 3D structure on the at least the portion of the 3D structure 108 that is adjacent to the build head 110 by curing the photoactive resin in the film of the mixture 104 within a photoinitiation layer 130. The light projection device 126 is utilized in combination with one or more projection optics 132 (e.g. a projection lens for a digital light processing (DLP) device), such that the light output from the light projection device 126 passes through the one or more projection optics 132 prior to illuminating the film of the mixture 104 adjacent to the print window 102.

The light projection device 126 is a DLP device including a digital micro-mirror device (DMD) for producing patterned light that can selectively illuminate and cure the photoactive resin in the photoinitiation layer 130. The light projection device 126, in communication with the one or more controllers, may receive instructions defining a pattern of illumination to be projected from the light projection device 126 into the photoinitiation layer 130 to cure a layer of the photoactive resin onto the at least the portion of the 3D structure 108.

The light sources 128 direct a second light having a second wavelength into the film of the mixture 104 adjacent to the open platform 101 comprising the print window 102. The second light may be provided as multiple beams from the light sources 128 through the print window 102 simultaneously. As an alternative, the second light may be generated from the light sources 128 and provided as a single beam through the print window 102. The second wavelength emitted by the light sources 128 is selected to produce photoinhibition in the photoactive resin in the film of the mixture 104 and is used to create a photoinhibition layer 134 within the film of the mixture 104 directly adjacent to the print window 102. The light sources 128 can produce a flood light to create the photoinhibition layer 134, the flood light being a non-patterned, high-intensity light. In some examples, the light sources 128 are light emitting diodes (LEDs) 136. The light sources 128 can be arranged on a light platform 138. The light platform 138 is mounted on adjustable axis rails 140. The adjustable axis rails 140 allow for movement of the light platform 138 along an axis towards or away from the print window 102. The light platform 138 and the one or more projection optics 132 may be moved independently. A relative position of the light platform comprising the light sources may be adjusted to project the second light into the photoinhibition layer 134 at the respective peak intensity and/or in a uniform projection manner. In some examples, the light platform 138 functions as a heat-sink for at least the light sources 128 arranged on the light platform 138.

The respective thicknesses of the photoinitiation layer 130 and the photoinhibition layer 134 may be adjusted by the one or more controllers. Such change in layer thickness(es) is performed for each new 3D printed layer, depending on the desired thickness of the 3D printed layer, and/or the type of mixture in the film of the mixture 104. The thickness(es) of the photoinitiation layer 130 and the photoinhibition layer 134 may be changed, for example, by changing the intensity of the respective light emitting devices (126 and/or 128), exposure times for the respective light emitting devices, or both. Alternatively or in addition to, by controlling relative rates of reactions between the photoactive species (e.g., at least one photoinitiator and at least one photoinhibitor), the overall rate of curing of the photoactive resin in the photoinitiation layer 130 and/or the photoinhibition layer 134 may be controlled. This process can thus be used to prevent curing from occurring at the film of the mixture-print window interface and control the rate at which curing of the photoactive resin takes place in the direction normal to the film of the photoactive resin-print window interface.

Once the at least the portion of the 3D object is printed from the photoinitiation layer 130 of the layer of mixture 104, the coupling between the plurality of first coupling units 150 and the plurality of second coupling units 160 may be de-coupled, and the build head may be moved in a direction away from the print surface to allow the deposition head 105 to remove any excess mixture 104 from the print window 102 and deposit another layer of the mixture on or adjacent to the print window 102.

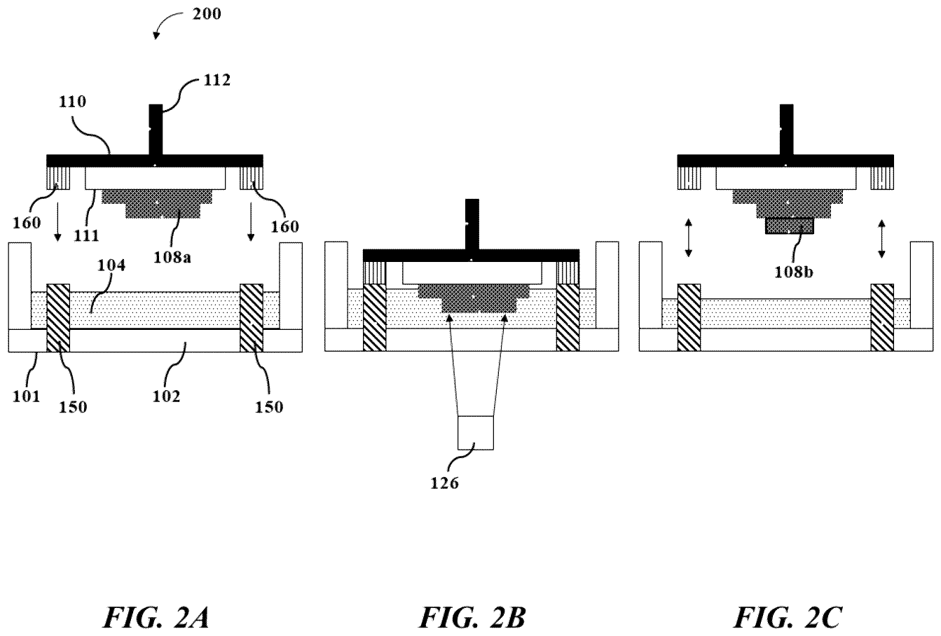

FIG. 2 shows an example of a 3D printing system 200. Referring to FIG. 2A, the system 100 includes a platform 101 comprising an area 102 (i.e., a print surface) configured to hold the mixture 104 or a film of the mixture 104, which includes a photoactive resin. The mixture 104 may include a plurality of particles (e.g., metal, intermetallic, and/or ceramic particles). The platform 101 comprises a plurality of first coupling units 150. The platform 101 is part of a vat configured to hold the mixture 104. The plurality of first coupling units 150 of the platform 101 may not be part of the vat. Alternatively or in addition to, the plurality of first coupling units 150 of the platform 101 may be part of the vat. In some examples, as illustrated in FIG. 2A, at least a portion of the plurality of first coupling units 150 of the platform 101 is in contact with the mixture 104 during 3D printing. The system 100 includes a build head 110 configured to move relative to the platform 101. The build head 110 is movable by an actuator 112 (e.g., a linear actuator) operatively coupled to the build head 110. Alternatively or in addition to, the platform 101 may comprise one or more actuators to move the platform 101 relative to the build head 110. The build head 110 comprises a surface 111 configured to hold at least a portion of a 3D object 108a (e.g., a previously printed portion of the 3D object) or a different object onto which the at least the portion of the 3D object is to be printed. The build head comprises a plurality of second coupling units 160. One of the plurality of second coupling units 160 of the build head 110 is configured to couple to one of the plurality of the first coupling units 150 of the platform 101 to provide an alignment of the print surface 102 of the platform 101 relative to the surface 111 of the build head 110 during 3D printing.

Referring to FIG. 2B, the build head 110 is directed to move in a relative direction towards the platform 101. When the plurality of second coupling units 160 of the build head 110 couple to the plurality of the first coupling units 150 of the platform 101 (e.g., one-to-one coupling), the relative movement between the build head 110 and the platform 101 may pause or stop. The coupling of the first coupling units 150 and second coupling units 160 may yield a film of the mixture 104 disposed between the print surface 102 and the surface of the surface of the object 108a with an approximately contact thickness (or an approximately constant particle density across the film of the mixture 104). Subsequently, one or more optical sources 126 directs one or more lights to the mixture 104 to cure the photoactive resin in the at least the portion of the mixture, thereby to print at least a portion of the 3D object on the surface of the build head 110 or a surface of the object 108a disposed on the surface of the build head 110. In some examples, the optical source(s) 126 may direct the light(s) through the print surface 102 of the platform 101 and to the at least the portion of the mixture for 3D printing.

Referring to FIG. 2C, after generating a newly printed portion 108b (layer) of the 3D object, the plurality of second coupling units 160 of the build head 110 are de-coupled (or detached) from the plurality of the first coupling units 150 of the platform 101 of the vat, and the build head 110 is relatively moved in a direction away from the platform 101 of the vat.

The system may further comprise at least one sensor configured to detect the coupling of the first coupling unit and second coupling unit. The system may comprise at least 1, 2, 3, 4, 5, 6, 7, 8, 9, 10, or more sensors configured to detect the coupling of the first and second coupling units. The system may comprise at most 10, 9, 8, 7, 6, 5, 4, 3, 2, or 1 sensor(s) configured to detect the coupling of the first and second coupling units.

The system may further comprise a controller configured to direct the at least one sensor to detect the coupling of the first coupling unit and second coupling unit. The controller may be further configured to direct the build head and/or the platform to undergo motion (relative motion) towards one another along an axis until the at least one sensor detects the coupling of the first coupling unit and second coupling unit. In such cases, the controller may be further configured to stop movement of the build head and/or the platform. Alternatively or in addition to, the controller may be further configured to release the coupling of the first and second coupling units.

The at least one sensor may be part of the first coupling unit and/or the second coupling unit. The at least one sensor may be part of the first coupling unit, and not part of the second coupling unit. The at least one sensor may be part of the second coupling unit, and not part of the first coupling unit. The at least one sensor may be part of the first and second coupling units. In some examples, a first portion of the at least one sensor (e.g., an energy source, such as a light source) may be part of the first coupling unit, and a second portion of the at least one sensor (e.g., an energy sensor, such as a light sensor) may be part of the second coupling unit. Alternatively or in addition to, the at least one sensor may be disposed adjacent to the first coupling unit and/or the second coupling unit. The at least one sensor may be disposed at a distance away from the first coupling unit and/or the second coupling unit to detect (e.g., visualize) the coupling between the first and second coupling units.

The at least one sensor configured to detect the coupling of the first and second coupling units may comprise at least one camera (e.g., at least 1, 2, 3, 4, 5, or more cameras). The at least one sensor may comprise at least one pressure sensor (e.g., at least 1, 2, 3, 4, 5, or more pressure sensors) configured to detect a pressure between the first coupling unit and the second coupling unit. The at least one sensor may comprise an electrical current sensor configured to detect an electrical current between the first coupling unit and the second coupling unit. The at least one sensor may comprise at least one magnetic field sensor (e.g., at least 1, 2, 3, 4, 5, or more magnetic field sensors) configured to detect a magnetic field between the first coupling unit and the second coupling unit. The at least one sensor may comprise a piezoelectric sensor configured to (i) measure one or more changes in pressure, acceleration, temperature, strain, or force on the first and/or second coupling units during their coupling and (ii) convert the measured one or more changes to an electrical charge.

Each of a plurality of first coupling units of the platform and each of a plurality of second coupling units of the build head may be configured to couple to one another to form a coupling a pair. Each pair of one of the first coupling units and one of the second coupling units may comprise at least one sensor (e.g., time sensor, pressure sensor, electrical current sensor, speed sensor, etc.) configured to detect at least one property of the coupling between the pair. Examples of the at least one property may include a duration of coupling, a pressure between the first and second coupling units upon generating the coupling, an initial force of contact between the first and second coupling units, a relative speed of the first and second coupling units during their initial contact, an electrical current between the first and second coupling units, etc. A controller may be in communication with a plurality of the sensors from a plurality of pairs (e.g., all of the pairs) of the first and second coupling units. The controller may direct the plurality of sensors to measure the at least one property of coupling from the plurality of pairs of first and second coupling units. The controller may be configured to calculate an average of the measurements of the at least one property of coupling. When such average value is within a predetermined range of values (e.g., within a predetermined contact force, pressure, electrical current, duration of coupling, etc.), the controller may direct the 3D printing system to proceed to a subsequent process of 3D printing, e.g., directing one or more lights to print at least a portion of the 3D object. When such average value is outside of the predetermined range of values, the controller may decouple the plurality of pairs of the first and second coupling units, e.g., by directing the build head to move in a relative direction away from the platform. Following, build head may move towards the platform again to re-initiate the coupling between the plurality of first coupling units and the plurality of second coupling units. In some examples, a new layer of the mixture may be deposited prior to directing the build head to move towards the platform again.

The area of the platform (e.g., the print surface of the platform) may comprise a slab. The slab may be part of the platform or disposed on or adjacent to the platform. The slab may be opaque, transparent, or semi-transparent. The slab may comprise a print window that is transparent or semi-transparent to permit at least a portion of a light to pass through. Alternatively or in addition to, the film configured to hold the mixture may be disposed on or adjacent to the print window. The print window may be disposed between the platform and the film. The film may be disposed on or adjacent to the print window. In some examples, the film may cover the print window.

The system may comprise one or more actuators or vacuum systems (e.g., at least 1, 2, 3, 4, 5, or more actuators or vacuum systems; at most 5, 4, 3, 2, or 1 actuator(s) or vacuum system(s)) to move the film and the print window relatively towards or away from one another, to provide an alignment of the film relative to the print window. Such alignment may help the film to be flat. Such alignment may help reduce or prevent one or more defects between (or at a contact surface between) the film and the print window. Examples of the one or more defects of the alignment may include uneven tension across the film, uneven thickness of the mixture disposed on or adjacent to the film, a plurality of phases of the mixture disposed on or adjacent to the film, voids (e.g., air bubbles) between the film and the print window, folding/creasing/wrinkling of the film, etc. The film may be operatively coupled to a mounting device configured to hold the film.

The mounting device may be two or more anchor devices to hold on to two or more edges (e.g., at least 2, 3, 4, 5, or more edges; at most 5, 4, 3, or 2 edges) or corners (e.g., at least 2, 3, 4, 5, or more corners; at most 5, 4, 3, or 2 corners) of the film. In an example, the film may be a rectangular film, and the mounting device may be a frame that is coupled to at least the four corners of the film to keep the film flat. The mounting device may keep the film non-flat. The mounting device may be a film transfer unit that is configured to move the film relative to (e.g., across) the platform. In some examples, the film transfer unit may move the film towards and away from the print window of the platform. The one or more actuators or vacuum systems may be part of the film transfer unit. Alternatively or in addition to, the one or more actuators or vacuum systems may not be part of the film transfer unit. In such a case, the one or more actuators or vacuum systems may be operatively coupled to at least one film transfer unit (e.g., at least 1, 2, 3, 4, 5, film transfer units; at most 5, 4, 3, 2, or 1 film transfer unit(s)). Each of the one or more actuators or vacuum systems may be operatively coupled to one film transfer unit at a time. Alternatively or in addition to, each of the one or more actuators or vacuum systems may be operatively coupled to a plurality of film transfer units at a time.

Each film transfer unit may be configured to hold a film and direct movement of the film relative to the platform. The relative movement between the film transfer unit and the platform may be linear (e.g., horizontal and/or vertical with respect to a print window of the platform) and/or rotational. The system may comprise at least 1, 2, 3, 4, 5, 6, 7, 8, 9, 10, or more film transfer units, thus comprising at least 1, 2, 3, 4, 5, 6, 7, 8, 9, 10, or more films configured to hold the mixture. The system may comprise at most 10, 9, 8, 7, 6, 5, 4, 3, 2, or 1 film transfer unit(s), thus comprising at most 10, 9, 8, 7, 6, 5, 4, 3, 2, or 1 film(s) configured to hold the mixture.

The film transfer unit may be operatively coupled to a motion stage (e.g., at least one motion stage). The motion stage may be adjacent to the platform. The motion stage may be coupled to the film transfer unit and configured to direct movement of the film transfer unit (and the film coupled to the film transfer unit) in one or more directions along one or more axes (e.g., at least 1, 2, 3, or more axes; at most 3, 2, or 1 axis). The motion stage may be configured to direct a horizontal movement (e.g., along x-axis) of the film transfer unit and the film across the platform or the print window of the platform. Alternatively or in addition to, the motion stage may be configured to direct a vertical movement (e.g., along y-axis) of the film transfer unit and the film towards or away from the platform (or the print window or the platform). The motion stage may be connected to one or more actuators configured to direct movement of the motion stage. The one or more actuators may be mechanical, hydraulic, pneumatic, electro-mechanical, or magnetic actuators. The system may further comprise a controller operatively coupled to the one or more actuators and configured to control movement of the motion stage.

The system may comprise at least one mixture deposition zone and at least one printing zone. The at least one mixture deposition zone may comprise at least one deposition head, and be configured to at least deposit the mixture on the area of the platform (e.g., on the film configured to hold the mixture). In some examples, the at least one mixture deposition zone may comprise one or more sensors configured to detect (i) one or more qualities of the mixture (or a layer of mixture) deposited on the area of the platform prior to the 3D printing, and/or (ii) one or more qualities of the mixture (or layer of mixture) subsequent to the 3D printing (i.e., “silhouette” imaging of the 3D printed part.”) The at least one printing zone may comprise at least one build head and at least one optical source, and be configured to at least print at least a portion of a 3D object on the build head using the at least one optical source. The at least one mixture deposition zone and the at least one printing zone may be part of part of a same platform. Alternatively or in addition to, the at least one mixture deposition zone and the at least one printing zone may not be part of part of the same platform (e.g., different platforms, but on the same plate; different platforms, and on different planes).

The at least one printing zone may not comprise any deposition head. As an alternative, the at least one printing zone may comprise at least one deposition head. The at least one deposition head of the at least one printing zone and the at least one deposition head of the at least one mixture deposition zone may be the same or different.

The system may comprise at least 1, 2, 3, 4, 5, or more mixture deposition zones. The system may comprise at most 5, 4, 3, 2, or 1 mixture deposition zone(s). The system may comprise at least 1, 2, 3, 4, 5, or more printing zones. The system may comprise at most 5, 4, 3, 2, or 1 printing zone(s). The at least one mixture deposition zone and the at least one printing zone may be connected by at least one film transfer unit. The at least one mixture deposition zone and the at least one printing zone may be connected by at least 1, 2, 3, 4, 5, or more film transfer units. The at least one mixture deposition zone and the at least one printing zone may be connected by at most 5, 4, 3, 2, or 1 film transfer unit(s). The at least one mixture deposition zone and the at least one printing zone may be modular, such that they can be (i) connected to one another in multiple configurations (e.g., side by side, top to bottom, front to back, etc.), and (ii) disconnected into separate components. Separating the at least two zones into individual and separate modular components can allow modifying or fixing one component without disrupting the other.

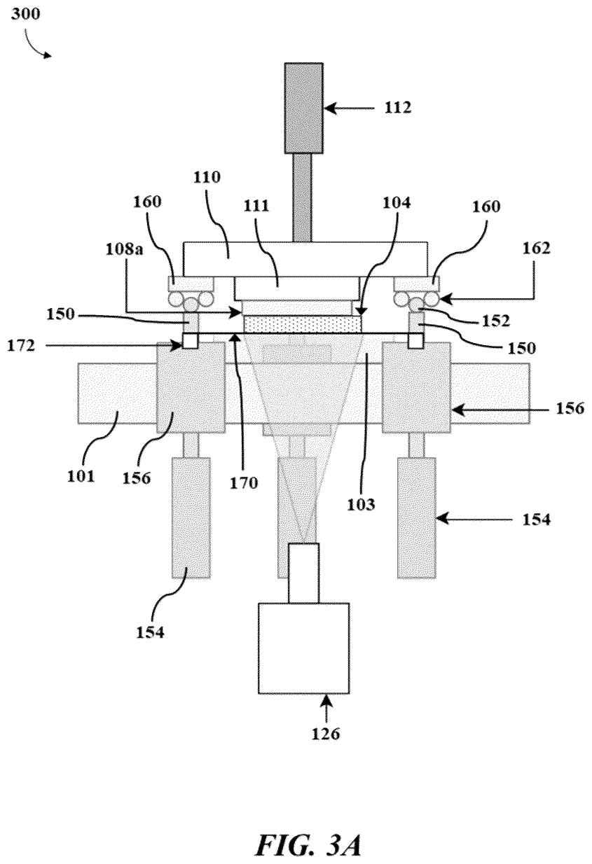

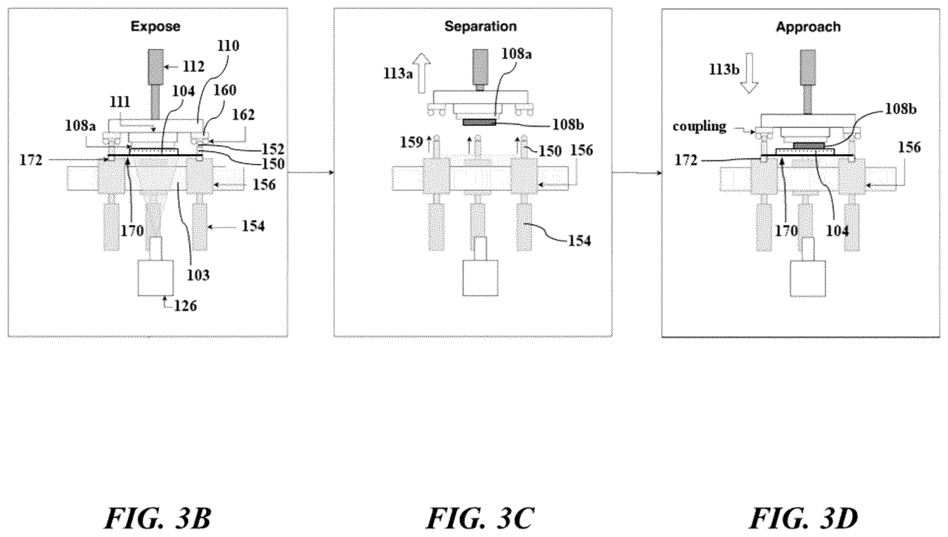

FIG. 3 shows examples of a 3D printing system 300. Referring to FIG. 3A, the system 300 includes a platform 101 comprising an area 102 (i.e., a print surface, such as a film 170) configured to hold the mixture 104 or a film of the mixture 104, which includes a photoactive resin. The mixture 104 may include a plurality of particles (e.g., metal, intermetallic, and/or ceramic particles). The platform 101 comprises a print window 103. The system 300 further comprises a film transfer unit 172 that is configured to hold the film 170. The film transfer unit is operatively coupled to one or more actuators to dispose the film 170 onto the print window 103.

Referring to FIG. 3A, the platform 101 comprises a plurality of first coupling units 150. The platform 101 is an open platform, wherein the mixture 104 is self-supporting on or adjacent to the film 170 without requiring support or being supported by any wall. The plurality of first coupling units 150 are not in contact with the mixture 104 during 3D printing. The system 300 includes a build head 110 configured to move relative to the platform 101. The build head 110 is movable by an actuator 112 (e.g., a linear actuator) operatively coupled to the build head 110. Alternatively or in addition to, the platform 101 may comprise one or more actuators to move the platform 101 relative to the build head 110. The build head 110 comprises a surface 111 configured to hold at least a portion of a 3D object 108a (e.g., a previously printed portion of the 3D object) or a different object onto which the at least the portion of the 3D object is to be printed. The surface 111 of the build head 110 may be a portion of a surface of the build head 110. Alternatively or in addition to, the surface 111 may be a surface of an object (e.g., a film or a slab) that is disposed on or adjacent to a surface of the build head 110. The build head 110 comprises a plurality of second coupling units 160. One of the plurality of second coupling units 160 of the build head 110 is configured to couple to one of the plurality of the first coupling units 150 of the platform 101 to provide an alignment of film 170 relative to the surface 111 of the build head 110 during 3D printing. In some examples, the plurality of first coupling units 150 (e.g., three first coupling units) and the plurality of second coupling units 160 (e.g., three second coupling units) may couple to generate a kinematic coupling between the build head 110 and the film 170, to provide an alignment between the build head 110 and the film 170. The relative movement between the build head and the platform may continue until each of the plurality of first coupling units 150 is coupled to its respective second coupling unit from the plurality of second coupling units 160 (or vice versa).

Referring to FIG. 3A, one or more of the plurality of first coupling units 150 of the platform 101 may comprise one or more sensors 152. Alternatively or in addition to, one or more of the plurality of second coupling units 160 of the build head 110 may comprise one or more sensors 162. The one or more sensors 152 and/or the one or more sensors 162 may be configured to at least detect coupling of the first coupling unit(s) 150 and the second coupling unit(s) 160.

Referring to FIG. 3A, the plurality of first coupling units 150 of the platform 101 may be operatively coupled to one or more actuators 154 (e.g., one or more z-axis telescopic actuators) configured to adjust a height (or protrusion) of the plurality of first coupling units 150 relative to the platform 101 (or relative to a surface of the film 170 disposed adjacent to the platform 101). The one or more actuators 154 may comprise one or more fasteners 156 (e.g., one or more shaft clamps) configured to fasten, hold on to, or stabilize a movement of the plurality of first coupling units 150 relative to the actuators 154.

Referring to FIG. 3A, the plurality of second coupling units 160 of the build head 110 may be operatively coupled to one or more actuators (e.g., one or more z-axis telescopic actuators) configured to adjust a height (or protrusion) of the plurality of second coupling units 160 relative to a surface 111 of the build head 110 (or relative to a surface of the object 108a disposed on the build head 110). The one or more actuators may comprise one or more fasteners (e.g., one or more shaft clamps) configured to fasten, hold on to, or stabilize a movement of the plurality of second coupling units 160 relative to the actuators.

Referring to FIG. 3B, the plurality of first coupling units 150 of the platform 101 may protrude relative to a surface of the film 170, e.g., protruded by at least a thickness of a desired thickness of a layer of the 3D object. Upon disposing the film 170 on or adjacent to the print window 103 of the platform 101 (e.g., by the one or more actuators or vacuum systems as provided in FIG. 3A), the build head 110 may be moved relatively towards the film 170, until the plurality of first coupling units 150 and the plurality of second coupling units 160 couple to one another. The relative movement of the build head 110 towards the film 170 may be stopped when the sensors 152 of the first coupling units 150 and/or the sensors 162 of the second coupling units detect such coupling. Thus, a surface (e.g., an outer most surface) of a portion of the 3D object 108a may contact at least a portion of the film of the mixture 104 deposited on the film 170. Subsequently, one or more of the optical source 126 (e.g., a single optical source or a plurality of optical sources) may provide one or more lights through the print window 103 (or through the platform 101 and through the print window 103), through the film 170, and to at least a portion of the film of the mixture 104 to print at least a portion of the 3D object 108b.

Referring to FIG. 3C, upon printing of the at least the portion of the 3D object 108b on the other portion of the 3D object 108a, the build head 110 may be moved 113a away from the platform 101. During or subsequent to the relative movement of the build head 110 away from the platform, the one or more fasteners 156 may release the plurality of first coupling units 150 from the one or more actuators 154, and the one or more actuators 154 may move 159 the plurality of first coupling units 150 relatively away from the platform 101, e.g., by at least a thickness of a subsequent layer of the 3D object to be printed. Additionally, the film transfer unit 172 may move the film 170 across the platform 101 and away from the print window 103. Subsequently, any excess mixture may be removed from the film 170 and a new layer of the mixture 104 may be deposited on or adjacent to the film 170.

Referring to FIG. 3D, the film transfer unit 172 may move the film 170 across he platform 101 and towards the print window 103. The film 170 may comprise a new layer of the mixture 104. Subsequently, the film 170 may be disposed on the print window 103, such that the film covers at least a portion of the print window 103. Alternatively, there may be a gap between the film 170 and the print window 103. Subsequently, the build head 110 may be moved 113b towards the film 170 until the plurality of first coupling units 150 and the plurality of second coupling units 160 couple to one another. As such, an outermost surface of the previously printed portion of the 3D object 108b may be in contact with at least a portion of the new layer of the mixture 104 on the film 170.

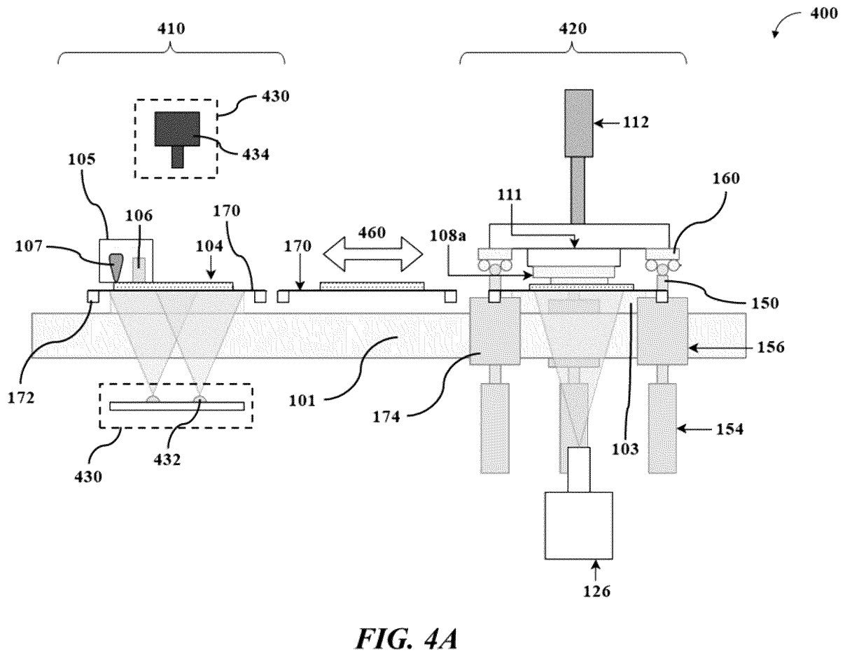

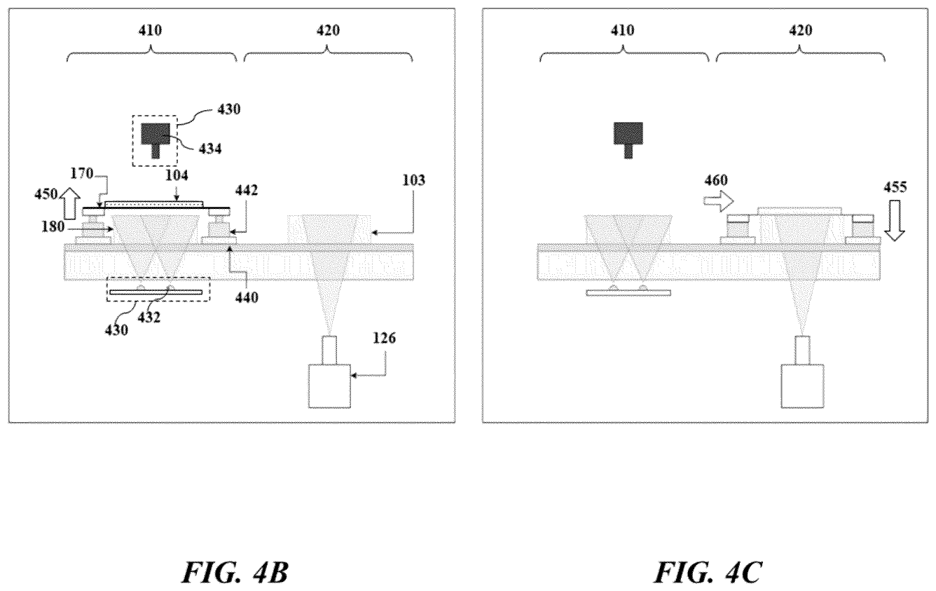

FIG. 4 shows examples of a 3D printing system 400. Referring to FIG. 4A, the 3D printing system 400 comprises a mixture deposition zone 410 and a printing zone 420 that are (i) connected to a same platform 101 or (ii) coupled to the same platform 101. The system 400 further comprises a deposition head 105 configured to deposit a mixture 104 to the platform 101, print window 103, and/or film 170 configured to hold a mixture. In this example, the deposition head is configured to deposit the mixture 104 onto the film 170. The deposition head 105 comprises a nozzle 107 that is in fluid communication with a source of the mixture 104 and at least one wiper 106 configured to (i) reduce or inhibit flow the mixture 104 out of the deposition head 105, (ii) flatten the mixture 104 into a film or layer of the mixture 104, and/or (iii) remove any excess of the 104 from the film 170. The system 400 further comprises a mixture sensor 430 (e.g., a camera, a densitometer, etc.) configured to detect one or more qualities of the mixture 104 that is deposited onto the film 170. The mixture sensor comprises a mixture sensor light source 432 and a mixture sensor detector 434. The mixture sensor light source 432 is disposed beneath the film 170, and the mixture sensor detector 434 is disposed above the film 170. Alternatively or in addition to, the mixture sensor light source 432 and the mixture sensor detector 434 may be disposed inversely or on the same side of the film 170. Subsequent to depositing a layer of the mixture 104 on the film 170, the mixture sensor light source 432 may emit a sensor light (e.g., infrared light) through at least the film 170 and towards the layer of mixture 104 on or adjacent to the film 170, and the mixture sensor detector 434 may capture or detect any of the infrared light that is transmitted through the layer of the mixture 104. Measurements by the mixture sensor 430 can help determine whether a quality of the layer of the mixture 104 is sufficient to proceed with printing at least a portion of the 3D object. The printing zone 420 can comprise one or more components of the 3D printing system 300 provided in FIG. 3A.

The infrared light (e.g., for detecting qualities of a layer of the mixture) may comprise near-infrared (NIR) light (about 750 nm to about 1.4 μm), short-wavelength infrared (SWIR) light (about 1.4 μm to about 3 μm), mid-wavelength infrared (MWIR) light (about 3 μm to about 8 μm), long-wavelength infrared (LWIR) light (8 μm to about 15 μm), and/or far infrared light (about 15 μm to about 1 mm). An optical source of the infrared light (e.g., for the mixture sensor light source 432) may comprise a LED device, a halogen lamp, a fluorescent light device, and a gas discharge lamp (e.g., a xenon arc lamp).

Referring to FIG. 4A, the film 170 is coupled to a film transfer unit 172. The film transfer unit 172 is configured to move 460 at least between and/or over the mixture deposition zone 410 and the printing zone 420.

Referring to FIG. 4B, the film transfer unit 172 comprises one or more actuators. The one or more actuators can comprise a horizontal actuator 440 that directs a horizontal movement (e.g., linear and/or rotational movement) of the film 170 relative to the platform 101. The horizontal actuator 440 may comprise or be operatively coupled to one or more axis rails to allow for movement of the film transfer unit 172 between the mixture deposition zone 410 and the printing zone 420. For example, the horizontal actuator 440 can be configured to direct a relative movement of the film 170 and the film transfer unit 172 between the deposition area 180 of the mixture deposition zone 410 to the print window 103 of the printing zone 420. The deposition area 180 of the mixture deposition zone 410 may be part of the platform 101 or an additional layer or slab (e.g., a transparent or semi-transparent material) disposed on or adjacent to the platform 101. Alternatively or in addition to, the one or more actuators of the film transfer unit 172 can comprise a vertical actuator 442 (e.g., pneumatic actuators) that directs a vertical movement 450 (e.g., upwards or downwards) of the film 170 relative to the deposition area 180 of the mixture deposition zone 410. A direction of movement of the horizontal actuator 440 and a direction of movement of the vertical actuator 442 may or may not be perpendicular.

A portion of the platform 101 disposed beneath at least a portion of the deposition area 180 may be transparent or semi-transparent, such that a light (e.g., a sensor light) may be directed through the portion of the platform 101, through the deposition area 180, through the film 170, and towards the mixture 104. As an alternative, a portion of the platform 101 disposed beneath at least a portion of the deposition area 180 may be hollow, such that a light (e.g., a sensor light) may be directed through the hollow portion of the platform 101, through the deposition area 180, through the film 170, and towards the mixture 104.

Referring to FIG. 4B, once the mixture 104 (e.g., the film or layer of the mixture 104) is deposited on the film 170, and one or more qualities of the deposited mixture 104 is confirmed by the sensor 530, the vertical actuator 442 of the film transfer unit 172 can direct a movement of the film 170 holding the deposited mixture 104 in a direction 450 (e.g., upwards) away from the deposition area 180. Following, as shown in FIG. 4C, the horizontal actuator 440 of the film transfer unit 172 can direct a movement of the film 170 in a direction 460 from the deposition area 180 of the mixture deposition zone 410 towards the print window 103 of the printing zone 420. Following, the vertical actuator 442 of the film transfer unit 172 directs a movement of the film 170 holding the deposited mixture 104 in a direction 455 (e.g., downwards) towards the print window 103. Such movement of the film 170 relative to the print window 103 can help ensure that the film 170 is contacting the print window 103 in a manner that keeps the film 170 flat (e.g., without or with minimal wrinkles, without or with minimal disruption, such as aggregation of the deposited mixture 104 or aggregation of one or more particles within the deposited mixture 104, etc.). Subsequently, the optical source 126 directs one or more lights towards the mixture 104 (e.g., through the platform 101, through the print window 103, through the film 170, and towards the mixture 104) for printing at least a portion of the 3D object. As an alternative, the optical source 126 may direct the one or more lights at least through the print window 103, through the film 170, and towards the mixture 104 for printing the at least the portion of the 3D object.

A portion of the platform 101 disposed beneath at least a portion of the print window 103 may be transparent or semi-transparent, such that a light (e.g., photoinitiation and/or photoinhibition light) may be directed through the portion of the platform 101, through the print window 103, through the film 170, and towards the mixture 104. As an alternative, the portion of the platform 101 disposed beneath at least a portion of the print window 103 may be hollow, such that a light (e.g., photoinitiation and/or photoinhibition light) may be directed through the hollow portion of the platform 101, through the print window 103, through the film 170, and towards the mixture 104.

The system may comprise a deposition head that comprises a nozzle in fluid communication with a source of the mixture. The source of the mixture may be part of the deposition head. Alternatively or in addition to, the source of the mixture may not be part of the deposition head. The deposition head may be configured to move across the area of the platform (e.g., across a print window of the platform, across a film disposed on or adjacent to the platform) to deposit a layer of the mixture over the area. In some examples, the deposition head may be configured to move across a film (e.g., the film 170 of FIG. 3) and deposit a layer of the mixture over the film. The system may comprise a controller operatively coupled to the deposition head. The controller may be programmed to (i) direct the deposition head to move across the area of the platform and dispense the mixture through the nozzle to deposit the layer of the mixture over the area of the platform.

The area of the platform may be a print surface, such as a print window (e.g., the print window 103 of FIG. 3) or a film (e.g., the film 170 of FIG. 3), as abovementioned in the present disclosure. The print surface may be opaque, transparent, or semitransparent (translucent). The print surface may be comprised of at least an optical window material, such as, for example, glass or a polymeric material (e.g., polymethylmethacrylate (PMMA), PTFE, etc.). The print surface may be comprised of at least polydimethylsiloxane (PDMS) that is permeable to oxygen. During printing, the oxygen dissolved in the print surface may (i) diffuse into a contact surface between the print surface and the mixture comprising the photoactive resin (the print surface-mixture interface) and (ii) inhibit curing of the photoactive resin at the contact surface. The print surface may be positioned above at least one optical source for photopolymer-based 3D printing using bottom-up illumination. As an alternative, the print window may be positioned below at least one optical source. As another alternative, the print window may be positioned between a first optical source and a second optical source.

In another aspect, the present disclosure provides a system for 3D printing. The system may comprise a substrate comprising (i) a surface configured to hold a mixture for printing a 3D object and (ii) a back surface opposite from the surface. The system may further comprise a base disposed adjacent to the substrate. The base may comprise one or more channels in fluid communication with the back surface. The one or more channels may be disposed opposite from at least a portion of the surface. The system may further comprise a vacuum unit operatively coupled to the one or more channels. The vacuum unit may be configured to provide a vacuum between the base and the back surface. The system may further comprise a controller operatively coupled to the vacuum unit. The controller may be configured to direct the vacuum unit to provide the vacuum between the base and the back surface. In some cases, the vacuum unit may be referred to as a vacuum chuck.

The system for 3D printing may utilize one or more components of any subject system for printing a 3D object, as provided in the present disclosure. For example, the substrate may be similar to the film 170 (e.g., a fluoropolymer film), e.g., as shown in FIGS. 3 and 4. In another example, the base may be similar to the deposition area 180 of the mixture deposition zone 410, e.g., as shown in FIG. 4B. Alternatively, the base may be similar to the print window 103 the printing zone 420, e.g., as shown in FIG. 4B. For example, at least a portion of the substrate may be transparent, semi-transparent (or translucent), semi-opaque, or opaque. In another example, at least a portion of the base may be transparent, semi-transparent (or translucent), semi-opaque, or opaque.

The system may comprise at least 1, 2, 3, 4, 5, or more vacuum units. The system may comprise at most 5, 4, 3, 2, or 1 vacuum unit. The vacuum unit may be a vacuum pump. Examples of the vacuum pump may include, but are not limited to, a positive displacement pump (e.g., a rotary vane pump, diaphragm pump, liquid ring, piston pump, scroll pump, screw pump, Wankel pump, external vane pump, roots blower, lobe pump, etc.), a momentum transfer pump, a regenerative pump, an entrapment pump, etc.

In operation (e.g., during printing of at least a portion of the 3D object), the surface may be a top surface of the substrate, and the back surface may be a bottom surface of the substrate. Alternatively, the surface may be a bottom surface of the substrate, and the back surface may be a top surface of the substrate. In a different alterative, the surface may be a left surface of the substrate and the back surface may be a right surface of the substrate, or vice versa.

The mixture may be disposed adjacent to at least a portion of the surface of the substrate. As such, the one or more channels may be disposed adjacent to the back surface and opposite from at least a portion of the mixture. The mixture may cover at least about 1%, 5%, 10%, 15%, 20%, 25%, 30%, 35%, 40%, 45%, 50%, 55%, 60%, 65%, 70%, 75%, 80%, 85%, 90%, 95%, or more of the surface. The mixture may cover at most about 100%, 95%, 90%, 85%, 80%, 75%, 70%, 65%, 60%, 55%, 50%, 45%, 40%, 35%, 30%, 25%, 20%, 15%, 10%, 5%, 1%, or less of the surface.

The vacuum between the base and the back surface may pull and maintain the substrate against the base, such that the substrate is disposed flat and without defects (e.g., wrinkles, air pockets, etc.) against the base. During depositing a layer of the mixture, keeping the substrate flat may help deposit the layer with a substantially flat bottom surface. During printing a portion of the 3D object using the layer, keeping the substrate flat may help print the portion with a substantially uniform thickness.

The system may further comprise an optical source configured to provide light through at least the one or more channels and towards the surface. The light may be directed through the at least the one or more channels, through the back surface, and towards the surface. Such light may transmit through the surface and towards at least a portion of the mixture.

The optical source may be configured to provide the light at a wavelength or wavelength range that is sufficient to (i) induce curing of at least a portion of the mixture (i.e., photoinitiation light) and/or (ii) inhibit curing of at least a portion of the mixture (i.e., photoinhibition light). The optical source may be similar to the one or more optical sources 126 shown in FIGS. 1B and 3A.

The optical source may be configured to provide the light at a wavelength or wavelength range that is not sufficient to cure the mixture. For example, the light may be provided at a wavelength or wavelength range within the infrared light to inspect a quality of the mixture disposed adjacent to the surface of the substrate. Such light may be provided for optical inspection (e.g., backlight optical inspection) without introducing additional sources of damage to the substrate and/or the mixture, e.g., stretch, shrink, tilt and meandering thereof. The optical inspection of the substrate and/or the mixture may not introduce any additional defects. The optical inspection of the substrate and/or the mixture may identify one or more defects of the substrate and/or the mixture that were generated during deposition of the mixture adjacent to the substrate. The optical source may be operatively coupled to a detector to detect at least a portion of the light that is transmitted through the mixture. A unit comprising the optical source and the detector may be a variation of or an equivalent to the mixture sensor 430 comprising the mixture sensor light source 432 and the mixture sensor detector 434, as shown in FIG. 4. In some cases, the optical source may be operatively coupled to a diffuser, as provided in the present disclosure. In an example, the diffuser may be disposed optically between the optical source and the substrate.

A combination of one or more members comprising: (i) intensity of the light from the optical source, (ii) a material of the base, (iii) a thickness of the base, (iv) a porosity of the base, and/or (v) dimension of one or more channels (or pores) of the base may be configured such that the optical source provides the light (e.g., infrared inspection light) at an irradiance of at least about 0.1 microwatts per square centimeter (μW/cm²), 0.2 μW/cm², 0.3 μW/cm², 0.4 μW/cm², 0.5 μW/cm², 0.6 μW/cm², 0.7 μW/cm², 0.8 μW/cm², 0.9 μW/cm², 1 μW/cm², 2 μW/cm², 3 μW/cm², 4 μW/cm², 5 μW/cm², 6 μW/cm², 7 μW/cm², 8 μW/cm², 9 μW/cm², 10 μW/cm², 15 μW/cm², 20 μW/cm², 25 μW/cm², 30 μW/cm², 35 μW/cm², 40 μW/cm², 45 μW/cm², 50 μW/cm², 60 μW/cm², 70 μW/cm², 80 μW/cm², 90 μW/cm², 100 μW/cm², or more to the back surface of the substrate. The optical source may be configured to provide the light (e.g., infrared inspection light) at an irradiance of at most about 100 μW/cm², 90 μW/cm², 80 μW/cm², 70 μW/cm², 60 μW/cm², 50 μW/cm², 45 μW/cm², 40 μW/cm², 35 μW/cm², 30 μW/cm², 25 μW/cm², 20 μW/cm², 15 μW/cm², 10 μW/cm², 9 μW/cm², 8 μW/cm², 7 μW/cm², 6 μW/cm², 5 μW/cm², 4 μW/cm², 3 μW/cm², 2 μW/cm², 1 μW/cm², 0.9 μW/cm², 0.8 μW/cm², 0.7 μW/cm², 0.6 μW/cm², 0.5 μW/cm², 0.4 μW/cm², 0.3 μW/cm², 0.2 μW/cm², 0.1 μW/cm², or less to the back surface of the substrate.

In some cases, a change in intensity of the light as the light travels across a layer of the mixture may be indicative of a quality of the mixture (e.g., presence of defects or lack thereof), and thus the optical source may provide the light such that the illuminance irradiance of the light can be uniform across at least a portion of the base (e.g., the entire top surface of the base that is facing the back surface of the substrate).

The system may further comprise a housing (i) operatively coupled to the vacuum unit and (ii) configured to seal at least the back surface from an ambient environment. The housing may be a vacuum chamber. The vacuum chamber may comprise a material comprising: stainless steel, aluminum, mild steel, brass, high density ceramic, glass, acrylic, and/or hard steel. The vacuum chamber may comprise a vacuum port. The vacuum unit may be in fluid communication with the one or more channels of the base via the vacuum port. Alternatively, the vacuum pot may be contained within the housing, and the housing may not need a vacuum port to fluidically connect the vacuum unit and the one or more channels of the base.

The vacuum unit may be configured to provide a vacuum pressure inside the housing to be less than about 0 pounds per square in gauge (PSIG), −0.1 PSIG, −0.5 PSIG, −1 PSIG, −2 PSIG, −3 PSIG, −4 PSIG, −5 PSIG, −6 PSIG, −7 PSIG, −8 PSIG, −9 PSIG, −10 PSIG, −11 PSIG, −12 PSIG, −13 PSIG, −14 PSIG, −14.5 PSIG, or less (e.g., −14.7 PSIG). The vacuum unit may be configured to provide a vacuum pressure inside the housing to be greater than about −14.7 PSIG, −14 PSIG, −13 PSIG, −12 PSIG, −11 PSIG, −10 PSIG, −9 PSIG, −8 PSIG, −7 PSIG, −6 PSIG, −5 PSIG, −4 PSIG, −3 PSIG, −2 PSIG, −1 PSIG, −0.5 PSIG, −0.1 PSIG, or more. In an example, vacuum unit may be configured to provide a vacuum pressure inside the housing to be about −12.5 PSIG. In some cases, the vacuum unit (or a controller operatively coupled to the vacuum unit) may be configured to adjust the vacuum pressure inside the housing based on one or more conditions, e.g., (i) thickness of the substrate, (ii) flexibility of the substrate, (iii) viscosity of the mixture disposed adjacent to the surface of the substrate, (iv) a thickness of a layer of the mixture disposed adjacent to the surface of the substrate, etc.

An induced vacuum pressure between the back surface of the substrate and a surface (e.g., a top surface) of the base may be less than about 0 PSIG, −0.1 PSIG, −0.5 PSIG, −1 PSIG, −2 PSIG, −3 PSIG, −4 PSIG, −5 PSIG, −6 PSIG, −7 PSIG, −8 PSIG, −9 PSIG, −10 PSIG, −11 PSIG, −12 PSIG, −13 PSIG, −14 PSIG, −14.5 PSIG, or less (e.g., −14.7 PSIG). The induced vacuum pressure between the back surface of the substrate and the surface of the base may be greater than about −14.7 PSIG, −14 PSIG, −13 PSIG, −12 PSIG, −11 PSIG, −10 PSIG, −9 PSIG, −8 PSIG, −7 PSIG, −6 PSIG, −5 PSIG, −4 PSIG, −3 PSIG, −2 PSIG, −1 PSIG, −0.5 PSIG, −0.1 PSIG, or more. In an example, the induced vacuum pressure between the back surface of the substrate and the surface of the base may be about −12.5 PSIG.

The housing may be further configured to seal the optical source from the ambient pressure. The optical source may be disposed within the housing. The optical source may be disposed within the housing and at a distance away from the base, e.g., at least 0.1 millimeter (mm), 0.2 mm, 0.3 mm, 0.4 mm, 0.5 mm, 1 mm, 5 mm, 1 cm, 5 cm, 10 cm, or more away from the base. Alternatively, the optical source may be coupled to at least a portion of the back surface. The optical source may be coupled to at least the one or more channels of the base. For example, the optical source may comprise a flat surface that is coupled to the at least the portion of the back surface and/or the one or more channels, e.g., via an adhesive or a clamping device.

The base may comprise a material comprising: stainless steel, aluminum, mild steel, brass, ceramic (e.g., low density ceramic, high density ceramic, glass, ceramic composite), polymer (e.g., acrylic polymer, polypropolyene), and/or hard steel. In an example the base may comprise a ceramic material such as a ceramic composite (e.g., METAPOR® CE100). The base may have a stiffness (i.e. Young's modulus) ranging from about 0.1 gigapascal (GPa) to about 1000 GPa. The stiffness of the base may be at least about 0.1 GPa, 0.2 GPa, 0.3 GPa, 0.4 GPa, 0.5 GPa, 1 GPa, 2 GPa, 3 GPa, 4 GPa, 5 GPa, 10 GPa, 20 GPa, 30 GPa, 40 GPa, 50 GPa, 100 GPa, 200 GPa, 300 GPa, 400 GPa, 500 GPa, 1000 GPa, or more. The stiffness of the base may be at most about 1000 GPa, 500 GPa, 400 GPa, 300 GPa, 200 GPa, 100 GPa, 50 GPa, 40 GPa, 30 GPa, 20 GPa, 10 GPa, 5 GPa, 4 GPa, 3 GPa, 2 GPa, 1 GPa, 0.5 GPa, 0.4 GPa, 0.3 GPa, 0.2 GPa, 0.1 GPa, or less. In some examples, the stiffness of the base may range between about 5 GPa to about 100 GPa. In an example, the stiffness of the base may be about 14 GPa. The stiffness of the base may be sufficient to withstand the vacuum pressure exerted by the vacuum unit.

The base may have a strength (e.g., flexural strength) ranging from about 1 megapascal (MPa) to about 10,000 MPa. The strength of the base may be at least about 1 MPa, 2 MPa, 3 MPa, 4 MPa, 5 MPa, 10 MPa, 20 MPa, 30 MPa, 40 MPa, 50 MPa, 100 MPa, 200 MPa, 300 MPa, 400 MPa, 500 MPa, 1,000 MPa, 2,000 MPa, 3,000 MPa, 4,000 MPa, 5,000 MPa, or more. The strength of the base may be at most about 10,000 MPa, 5,000 MPa, 4,000 MPa, 3,000 MPa, 2,000 MPa, 1,000 MPa, 500 MPa, 400 MPa, 300 MPa, 200 MPa, 100 MPa, 50 MPa, 40 MPa, 30 MPa, 20 MPa, 10 MPa, 5 MPa, 4 MPa, 3 MPa, 2 MPa, 1 MPa, or less. In some examples, the strength of the base may range between about 1 MPa to about 1,000 MPa, or between about 1 MPa to about 1000 MPa. In an example, the strength of the base may be about 28 MPa.

The base may have a thickness of at least 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, 6 mm, 7 mm, 8 mm, 9 mm, 10 mm, 20 mm, 30 mm, 40 mm, 50 mm, or more. The base may have a thickness of at most about 50 mm, 40 mm, 30 mm, 20 mm, 10 mm, 9 mm, 8 mm, 7 mm, 6 mm, 5 mm, 4 mm, 3 mm, 2 mm, 1 mm, 0.9 mm, 0.8 mm, 0.7 mm, 0.6 mm, 0.5 mm, 0.4 mm, 0.3 mm, 0.2 mm, 0.1 mm, or less. In some cases, the thickness of the base may be between about 1 mm to about 20 mm. In some cases, the thickness of the base may be between about 5 mm to about 15 mm.

The base may comprise one or more pores. The base may comprise a plurality of pores. The plurality of pores may be distributed throughout a volume of the base. Alternatively, the plurality of pores may be distributed locally within a region (e.g., center, periphery, or in a specific pattern) of the base. A pore of the plurality of pores may be a channel of the one or more channels. For example, a pore may provide a channel for fluid communication between two different surfaces of the base. Alternatively, two or more pores may be fluidically coupled to provide a channel of the one or more channels. Such two or more pores may provide at least one channel for fluid communication between two different surfaces of the base. The two different surfaces of the base may be opposite from each other, e.g., two opposite surfaces of the base, such as (i) a first surface disposed adjacent to the back surface of the substrate and (ii) a second surface that is opposite from the first surface. Alternatively, the two different surfaces of the base may be such that an angle between the two different surfaces is greater than 0 degrees and less than 180 degrees. In another alternative, the two different surface may be different regions of a same surface.

A pore of the plurality of pores may be characterized by a dimension, such as an average diameter of two or more pores of the plurality of pores. An average diameter of a pore of the plurality of pores may be at least about 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 100 μm, 200 μm, 300 μm, 400 μm, 500 μm, 600 μm, 700 μm, 800 μm, 900 μm, 1000 μm, or more. The average diameter of the pore of the plurality of pores may be at most about 1000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, 100 nm, or less. In some cases, the average diameter of the pore of the plurality of pores may range between about 1 μm to about 1000 μm. In some cases, the average diameter of the pore of the plurality of pores may range between about 5 μm to about 500 μm. In some cases, the average diameter of the pore of the plurality of pores may range between about 5 μm to about 400 μm. In some cases, the average diameter of the pore of the plurality of pores may range between about 7 μm to about 300 μm.

A porosity of the base may be at least about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 25%, 30%, 35%, 40%, 45%, 50%, 55%, 60%, 65%, 70%, 75%, 80%, 85%, 90%, or more by volume of the base. The porosity of the base may be at most about 90%, 85%, 80%, 75%, 70%, 65%, 560%, 55%, 50%, 45%, 40%, 35%, 30%, 25%, 20%, 19%, 18%, 17%, 16%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, or less by volume of the base. In some cases, the porosity of the base may range between about 0.1% to about 50% by volume of the base. In some cases, the porosity of the base may range between about 1% to about 40% by volume of the base. In some cases, the porosity of the base may range between about 1% to about 30% by volume of the base. In some cases, the porosity of the base may range between about 15% to about 25% by volume of the base. In an example, the porosity of the base may be about 20% by volume of the base.

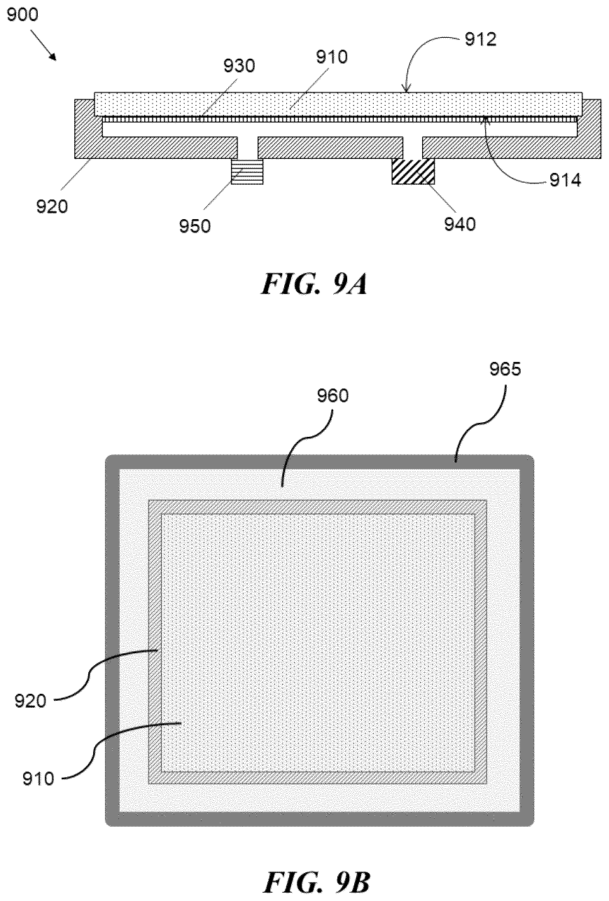

FIGS. 9A and 9B schematically illustrate an example of a vacuum unit for 3D printing. FIG. 9A shows a schematic cross-sectional view of a translucent vacuum unit system 900. The translucent vacuum unit system 900 comprises a base (i.e., a translucent porous platen) 910 that comprises a top surface 912 and a bottom surface 914. The top surface 912 of the translucent porous platen 910 is configured to hold a substrate (i.e., a transparent flexible substrate) adjacent to the top surface 912. The substrate may be held adjacent to the top surface 912 through suction provided by a vacuum unit that is operatively coupled to the translucent porous platen 910. When the transparent flexible substrate is held adjacent to the top surface 912 via vacuum suction thought one or more pores of the translucent porous platen 910, the one or more pores may be disposed below the mixture. In some cases, an induced vacuum pressure between a back surface of the transparent flexible substrate and the top surface 912 of the translucent porous platen 910 may be about −12.5 PSIG.

The translucent porous platen 910 is attached to a housing (i.e., a vacuum chuck base) 920 with airtight seals. The airtight seals may include one or both of a hermetic adhesive seals and gaskets. In some cases, the vacuum cuck base 920 may be removable. The vacuum cuck base 920 may seal the translucent porous platen 910 with airtight gaskets or O-rings. The vacuum chuck base 920 comprises a vacuum port 950 that is in fluid communication with one or more vacuum units.

The one or more vacuum units may apply vacuum to within the vacuum chuck base 920, thereby providing vacuum between the translucent porous platen 910 and a transparent flexible substrate.

The translucent vacuum unit system 900 comprises an optical source (e.g., a light source) 930 configured to direct light towards the bottom surface 914 of the translucent porous platen 910. The light source 930 may be attached to at least a portion of the bottom surface 914. The translucent vacuum unit system 900 comprises an airtight cable port 940 that allows electrical wires (e.g., power cables) for one or more components of the translucent vacuum unit system 900. For example, one or more a power cables for the light source 930 may pass through the airtight cable port 940, out of the translucent vacuum unit system 900, and towards an external power source. The optical source may provide light for optical inspection of the mixture disposed adjacent to the transparent flexible substrate. The optical source may provide the light through the translucent porous platen 910 (e.g., through at least one or more pores of the translucent porous platen 910), through the transparent flexible substrate, and towards the mixture.

The vacuum chuck base 920 may comprise a plurality of components, and the plurality of components may be coupled to one another with airtight seals. Alternatively, the vacuum chuck base 920 may be provided as a single piece.

FIG. 9B schematically illustrates a top-down view of the translucent vacuum unit system 900, onto which a transparent flexible substrate 960 is arranged. The translucent vacuum unit system comprises the translucent porous platen 910 on a vacuum chuck base 920. The top surface of the translucent porous platen 910 is shown in FIG. 9B. A film transfer frame 965 (e.g., a component of the film transfer unit 172 shown in FIG. 4A) may be arranged around the transparent flexible substrate 960 to hold (e.g., stretch) the transparent flexible substrate 960. A vacuum may be applied to the vacuum chuck base 920 to hold the transparent flexible substrate 960 in place against the translucent porous platen 910. The transparent flexible substrate 960 may be ready to receive a layer of the mixture for 3D printing. Alternatively, the transparent flexible substrate 960 may already hold the layer of the mixture prior to being held in place against the translucent porous platen 910.

In some cases, a layer of the mixture may be applied to the transparent flexible substrate 960. Following, the optical source 914 may provide light (e.g., infrared light) through the translucent porous platen 910, through the transparent flexible substrate 960, through the layer of the mixture, and towards a camera. The camera may be arranged above the top surface 912 of the translucent porous platen 910 and above the layer of the mixture. The camera may be configured to direct at least a portion of the light transmitted through the mixture to capture an image and/or video of the layer of the mixture. The image/video may be analyzed to determine whether there are any regions of inconsistent illumination across the layer of the mixture. In an example, the image/video may be converted to a greyscale map and analyzed for uniformity. The level of tolerance of defects of the layer of mixture may be set by a user of the system. The level of tolerance may depend, for example, on a level of consistency that is desired for a particular 3D printing process. Upon determining that the greyscale uniformity is above the level of tolerance, the layer of mixture may be indicative of having sufficient quality for 3D printing (e.g., can be removed from the translucent vacuum unit system 900 and to the printing zone for further processing). Alternatively, upon determining that the greyscale uniformity is less than the level of tolerance, the layer of mixture may be indicative of not having sufficient quality for 3D printing, and may not be used for 3D printing (e.g., may be removed from the transparent flexible substrate 960 to deposit a new layer of the mixture).

The translucent vacuum unit system 900, as shown in FIGS. 9A and 9B, may provide one or more advantages over different systems and methods for holding the transparent flexible substrate 960 in place, e.g., for depositing a layer of the mixture or for visual inspection. The translucent vacuum unit system 900 may be less complicated, thus requiring reduced mechanical components and/or time for operation as compared to other mechanical fixturing (e.g., clamping and unclamping). By using the translucent vacuum unit system 900, a variety of flexible substrates can be held in place without introducing a distortion to the flexible substrates and/or a mixture disposed thereto. In contrast, other mechanical fixturing systems and methods may introduce damages to the flexible substrates and/or the mixture deposited thereto.

In another aspect, the present disclosure provides a system for 3D printing. The system may comprise a substrate comprising (i) a surface configured to hold a mixture for printing a 3D object and (ii) a back surface opposite from the surface. The system may comprise a build head disposed adjacent to the surface. The system may comprise a base unit comprising a window. The base unit and the back surface may be configured to move laterally relative to one another. The lateral movement between the base unit and the back surface may provide at least a portion of the window adjacent to the back surface. The system may comprise a controller operatively coupled to the base unit and/or the substrate. The controller may be configured to direct the relative movement between the base unit and the back surface to provide the at least the portion of the window adjacent to the back surface.

In some embodiments, the base unit may be configured to move across the back surface to provide the at least the portion of the window adjacent to the back surface. The controller may be operatively coupled to at least the base unit. The controller may be configured to direct the base unit to move across the back surface. The base unit may be used as a laminator unit to laminate (or apply) a layer of the mixture that is held adjacent to the surface of the substrate onto (i) the build head or (ii) onto a surface of a previous layer of the 3D object.

During 3D printing (e.g., during a bottom-up 3D printing processes, such as DLP or stereolithography (SLA) printing), a layer of mixture (i.e., a film of feedstock material) may be coated onto a substrate (e.g., a window or a transparent film). A build head may contact and compress the layer of mixture to a target thickness. Following, the compressed layer of mixture may be exposed to form a new layer of the 3D object. During the contacting and compressing processes of the build head, defects can be generated in the layer of the mixture. For example, air can be trapped in compressed layer of the mixture in the form of one or more bubbles, thereby creating one or more defects (e.g., voids) that are preserved in the newly formed layer of the 3D object. Such defects within the 3D object may not be removed subsequent to the formation of the 3D object. Such defects may damage aesthetics and/or properties (e.g., porosity, stiffness, strength, thermal conductivity, electrical conductivity, etc.) of the 3D object. Thus, the base unit of the 3D printing system, as provided in the present disclosure, to compress the layer of the mixture onto the build head (or a previous layer of the 3D object) while reducing (e.g., eliminating) defects (e.g., air) trapped in the compressed layer of the mixture.

The system for 3D printing may utilize one or more components of any subject system for printing a 3D object, as provided in the present disclosure. For example, the substrate may be similar to the film 170 (e.g., a fluoropolymer film), e.g., as shown in FIGS. 3 and 4. In another example, the base unit may be similar to the print window 103 the printing zone 420, e.g., as shown in FIG. 4B. For example, at least a portion of the substrate may be transparent, semi-transparent (or translucent), semi-opaque, or opaque. In another example, at least a portion of the base unit (e.g., the window) may be transparent, semi-transparent (or translucent), semi-opaque, or opaque.

The movement of the base unit (e.g., across the back surface) may be configured to reduce a distance (e.g., a vertical distance and/or a lateral distance, etc.) between at least a portion of the surface and the build head. For example, the base unit may move across the back surface of the substrate and begin generating contact with the back surface of the substrate. Upon generation of such contact, the base unit may push the substrate towards the build head, thereby pushing the mixture (e.g., a layer of the mixture deposited on the surface of the substrate, opposite the back surface) towards the build head. The movement of the base unit may be configured to reduce a distance (e.g., a vertical distance) between the at least the portion of the surface and the build head by at least about 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 100 μm, 200 μm, 300 μm, 400 μm, 500 μm, 600 μm, 700 μm, 800 μm, 900 μm, 1000 μm, 2 mm, 3 mm, 4 mm, 5 mm, 6 mm, 7 mm, 8 mm, 9 mm, 10 mm, or more. The movement of the base unit may be configured to reduce a distance (e.g., a vertical distance) between the at least the portion of the surface and the build head by at most about 10 mm, 9 mm, 8 mm, 7 mm, 6 mm, 5 mm, 4 mm, 3 mm, 2 mm, 1000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, 100 nm, or less.

The movement of the base unit may be configured to reduce a distance (e.g., a vertical distance) between the at least the portion of the surface and the build head by at least about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 25%, 30%, 35%, 40%, 45%, 50%, 55%, 60%, 65%, 70%, 75%, 80%, 85%, 90%, 95%, 100%, 150%, 200%, 300%, or more of the thickness of the layer of the mixture deposited adjacent to the surface of the substrate. The movement of the base unit may be configured to reduce a distance (e.g., a vertical distance) between the at least the portion of the surface and the build head by at most about 300%, 200%, 150%, 100%, 95%, 90%, 85%, 80%, 75%, 70%, 65%, 560%, 55%, 50%, 45%, 40%, 35%, 30%, 25%, 20%, 19%, 18%, 17%, 16%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, or less of the thickness of the layer of the mixture deposited adjacent to the surface of the substrate.

The substrate may be arranged to remain stationary during the movement of the base unit. For example, the substrate may be arranged to remain horizontally stationary during the movement of the base unit, while allowing at least a portion of the substrate to move vertically (e.g., by being pushed by the base unit during the movement of the base unit across the back surface of the substrate). The substrate may be held (e.g., at a plurality of corners and/or edges of the substrate) by a substrate frame to arrange the substrate to remain horizontally stationary. The substrate frame may be a component of the film transfer unit 172, as shown in FIG. 4A. At least a portion of the substrate may be attached (e.g., glued) to the substrate frame. Alternatively or in addition to, at least a portion of the substrate may be held by one or more fasteners (e.g., one or more clamps) of the substrate frame.

During the relative movement of the base unit across the back surface, the substrate frame may hold the substrate without stretching the substrate. Alternatively, the substrate frame may hold the substrate while stretching at least a portion of the substrate (e.g., a portion that is holding the mixture) by at least about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, or more. The substrate frame may hold the substrate while stretching the at least the portion of the substrate by at most about 20%, 19%, 18%, 17%, 16%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, or less.

During the relative movement of the base unit across the back surface, the build head may be configured to move horizontally, vertically, and/or rotationally. Alternatively, the build head may be arranged to remain horizontally and/or vertically stationary during the relative movement of the base unit across the back surface. In an example, the build head may be arranged to remain horizontally and vertically stationary during the relative movement of the base unit across the back surface.

Prior to the relative movement of the base unit across the back surface, the build head may be moved adjacent to the layer of the mixture that is disposed adjacent to the surface of the substrate. The 3D printing system may comprise one or more actuators configured to direct the substrate holding the mixture and the build head to motion relative to one another. A distance (e.g., a vertical distance) between (i) a surface of the build head or a surface of a previous layer of the 3D object disposed adjacent to the build head and (ii) a surface of the layer of the mixture may be at least about 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 100 μm, 200 μm, 300 μm, 400 μm, 500 μm, 600 μm, 700 μm, 800 μm, 900 μm, 1000 μm, 2 mm, 3 mm, 4 mm, 5 mm, 6 mm, 7 mm, 8 mm, 9 mm, 10 mm, or more. A distance (e.g., a vertical distance) between (i) a surface of the build head or a surface of a previous layer of the 3D object disposed adjacent to the build head and (ii) a surface of the layer of the mixture may be at most about 10 mm, 9 mm, 8 mm, 7 mm, 6 mm, 5 mm, 4 mm, 3 mm, 2 mm, 1000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, 100 nm, or less.

A distance (e.g., a vertical distance) between (i) a surface of the build head or a surface of a previous layer of the 3D object disposed adjacent to the build head and (ii) a surface of the layer of the mixture may be at least about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 25%, 30%, 35%, 40%, 45%, 50%, 55%, 60%, 65%, 70%, 75%, 80%, 85%, 90%, 95%, 100%, 150%, 200%, 300%, or more of the thickness of the layer of the mixture. A distance (e.g., a vertical distance) between (i) a surface of the build head or a surface of a previous layer of the 3D object disposed adjacent to the build head and (ii) a surface of the layer of the mixture may be at most about 300%, 200%, 150%, 100%, 95%, 90%, 85%, 80%, 75%, 70%, 65%, 560%, 55%, 50%, 45%, 40%, 35%, 30%, 25%, 20%, 19%, 18%, 17%, 16%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, or less of the thickness of the layer of the mixture.

One or more actuators may be configured to direct a relative movement between the base unit and the back surface to provide the at least the portion of the window adjacent to the back surface. Examples of the one or more actuators can include, but are not limited to, a stepper actuator, linear actuator, hydraulic actuator, pneumatic actuator, electric actuator (e.g., a servo motor), magnetic actuator, mechanical actuator (e.g., rack and pinion, chains, etc.), jet actuator (e.g., an air jet actuator), etc. Such actuator may maintain the at least the portion of the window vertically leveled during the relative movement.

The system may further comprise an optical source configured to provide light through the window and towards the surface. The controller may be operatively coupled to the optical source and configured to direct the optical source to provide the light through the window and towards the surface. The base unit may be configured to move laterally across the back surface of the substrate, such that the window of the base unit is arranged within the path of the light from the optical source. The light may be directed through the window of the base unit, through the back surface of the substrate, through the surface of the substrate, and towards at least a portion of the mixture disposed adjacent to the surface of the substrate. The optical source may be similar to the one or more optical sources 126 shown in FIGS. 1B and 3A. In an example, the optical source may be configured to provide the light at a wavelength or wavelength range that is sufficient to cure at least a portion of the mixture (i.e., photoinitiation light). Alternatively or in addition to, the optical source may be configured to provide the light at a wavelength or wavelength range that is sufficient to inhibit curing of at least a portion of the mixture (i.e., photoinhibition light).

The base unit may comprise an angled (e.g., planar, round, curved, etc.) edge or corner configured to generate an initial contact with at least a portion of the back surface of the substrate. For example, the base unit may comprise an angled leading edge to not damage the back surface of the substrate and/or the mixture disposed opposite the back surface. Upon generating the initial contact, the angled edge or corner may be configured to continue generating new contact with additional portions of the back surface until the window of the base unit is arranged adjacent to the back surface.

An angle between (i) the angled edge or corner and (ii) a surface of the base unit (e.g., a surface of the window configured to contact the back surface of the substrate) may be at least about 1 degree, 2 degrees, 3 degrees, 4 degrees, 5 degrees, 6 degrees, 7 degrees, 8 degrees, 9 degrees, 10 degrees, 20 degrees, 30 degrees, 40 degrees, 50 degrees, or more. The angle between (i) the angled edge or corner and (ii) the surface of the base unit may be at most about 50 degrees, 40 degrees, 30 degrees, 20 degrees, 10 degrees, 9 degrees, 8 degrees, 7 degrees, 6 degrees, 5 degrees, 4 degrees, 3 degrees, 2 degrees, 1 degree, or less.

The angled edge or corner may be a part of the base unit (e.g., a part of the window of the base unit). Alternatively, the angled edge or corner may be a separate component that is operatively coupled to the base unit, e.g., by one or more hinges. In an example, the angled edge or corner may be at least one wiper that is configured to generate the initial contact with at least a portion of the back surface of the substrate.

The angled edge or corner may be permanently fixed relative to the rest of the base unit. Alternatively, the angled edge or corner may be movable relative to the rest of the base unit. In some cases, the angled edge or corner may be the at least one wiper, and the at least one wiper may be configured to move relative to the surface of the base unit. As such, the moving component may be the at least one wiper, the base unit, or both. For example, the at least one wiper may be configured to move relative to the surface of the base unit by at least one degree of freedom. In an example, the at least one wiper may be configured to move vertically, to control a vertical position of an apex of the at least one wiper relative to a surface of the window of the base unit. In another example, the at least one wiper may be moved by three degrees of freedom, three linear degrees of freedom including x-, y-, and z-axes. In another example, the at least one wiper may be moved by six degrees of freedom, comprising three linear degrees of freedom (e.g., the x, y, and z axes) and three rotational degrees of freedom (e.g., around each of the three axes, i.e., pitch, roll, and yaw). One or more actuators may be operatively coupled to the base unit and/or the at least one wiper to direct such relative movement between (i) the at least one wiper and (ii) the base unit. Examples of the one or more actuators can include, but are not limited to, a stepper actuator, linear actuator, hydraulic actuator, pneumatic actuator, electric actuator, magnetic actuator, mechanical actuator (e.g., rack and pinion, chains, etc.), jet actuator (e.g., an air jet actuator), etc.

During the lateral movement of the base unit across the back surface of the substrate, (i) an apex edge of the wiper that is operatively coupled to the base unit and (ii) a surface of the window of the base unit may be on a same plane. Alternatively, during such movement, (i) an apex edge of the wiper that is operatively coupled to the base unit and (ii) a surface of the window of the base unit may be on different planes. In some cases, e.g., for bottom-up 3D printing, the apex edge of the wiper may be lower than the surface window by at least about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 100 μm, 200 μm, 300 μm, 400 μm, 500 μm, 600 μm, 700 μm, 800 μm, 900 μm, 1000 μm, 2 mm, 3 mm, 4 mm, 5 mm, 6 mm, 7 mm, 8 mm, 9 mm, 10 mm, or more. The apex edge of the wiper may be lower than the surface window by at most about 10 mm, 9 mm, 8 mm, 7 mm, 6 mm, 5 mm, 4 mm, 3 mm, 2 mm, 1000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, or less. In other cases, e.g., for top-down 3D printing, the apex edge of the wiper may be higher than the surface window by at least about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 100 μm, 200 μm, 300 μm, 400 μm, 500 μm, 600 μm, 700 μm, 800 μm, 900 μm, 1000 μm, 2 mm, 3 mm, 4 mm, 5 mm, 6 mm, 7 mm, 8 mm, 9 mm, 10 mm, or more. The apex edge of the wiper may be higher than the surface window by at most about 10 mm, 9 mm, 8 mm, 7 mm, 6 mm, 5 mm, 4 mm, 3 mm, 2 mm, 1000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, or less.

The at least one wiper may comprise a blade, a roller, and/or a rod. A surface of the at least one wiper may comprise (e.g., may be coated with) one or more fluoropolymers that prevent adhesion of the at least one wiper to the back surface of the substrate. Examples of the one or more fluoropolymers include polyvinylidene fluoride (PVDF), ethylenchlorotrifluoroethylene (ECTFE), ethylenetetrafluoroethylene (ETFE), polytetrafluoroethylene (PTFE), perfluoroalkoxy (PFA), and modified fluoroalkoxy (a copolymer of tetrafluoroethylene and perfluoromethylvinylether, also known as MFA).

In an example, the at least one wiper may be a roller or a rod. The roller or a rod may have a diameter of at least about 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, or more. The roller or a rod may have a diameter of at most about 30 mm, 29 mm, 28 mm, 27 mm, 26 mm, 25 mm, 24 mm, 23 mm, 22 mm, 21 mm, 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, or less.

A surface of the angled leading edge may be sufficiently smooth, such that the angled leading edge does not damage the back surface of the substrate. The angled leading edge may be a cylindrical wiper, and the cylindrical wiper may be fixed (e.g., not rotating) during the lateral movement of the base unit across the back surface. Alternatively, the cylindrical wiper may be configured to rotate during the lateral movement of the base unit across the back surface.

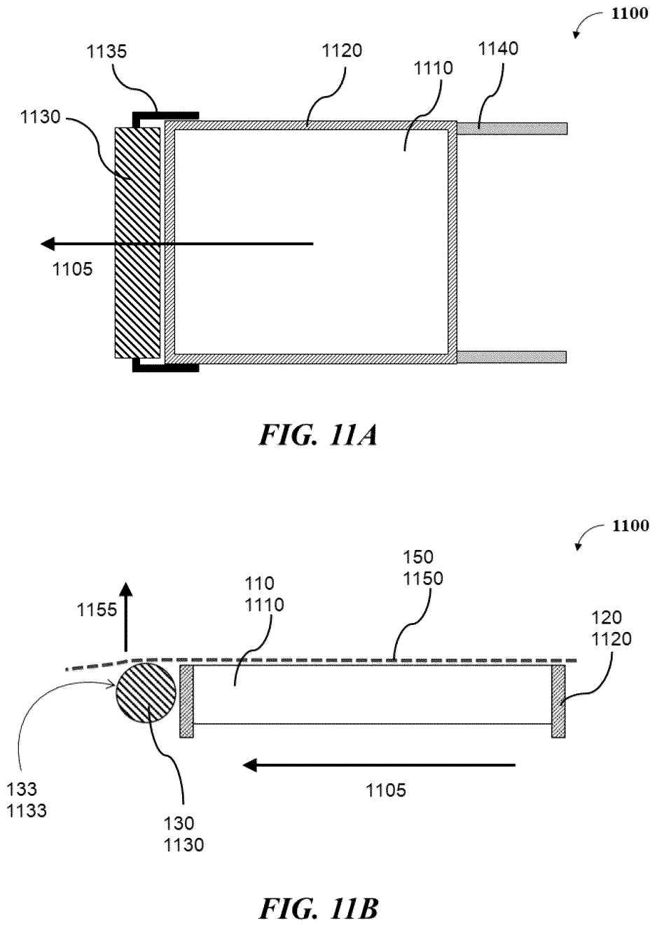

FIGS. 11A and 11B schematically illustrate an example of a laminator unit (i.e., a spreading device) for 3D printing. FIG. 11A schematically illustrates a top-down view of the laminator unit 1100. The laminator unit 1100 may be configured to provide (e.g., laminate) a layer of a mixture for 3D printing onto (i) a build head or (ii) a previous layer of the 3D object disposed adjacent to the build head while minimizing or preventing trapping of air bubbles in the layer of the mixture. The laminator unit 1100 comprises a base unit. The base unit comprises a window (i.e., a glass plate) 1110 that is supported by a frame 1120. The base unit comprises an angled edge in the form of a wiper (e.g., a roller, such as a cylindrical roller) 1130 that is disposed adjacent to the frame 1120. The roller 1130 is attached to the frame 1120 with brackets 1135. The roller 1130 can be configured to maintain its position (e.g., vertical and horizontal positions) relative to the glass plate 1110 during movement (e.g., a later movement) of the glass plate 1110. The laminator unit 1100 comprising the glass plate 1110, the frame 1120, and the roller 1130 may be operatively coupled to one or more actuators to direct a movement of laminator unit 1100 along a track 140. In an example, the laminator unit 1100 may move laterally (e.g., along a direction of the arrow 1105) across a back surface of a substrate holding a layer of the mixture to generate a contact between (i) the layer of the mixture and (ii) the build head or a previous layer of the 3D object disposed adjacent to the build head.

FIG. 11B shows a vertical cross-sectional view of the laminator unit 1100. The laminator unit 1100 is configured to move along the direction 1105 to (i) contact a bottom surface (e.g., a back surface) of a substrate 1150 (e.g., a flexible and transparent film) that is configured to hold or already holding a layer of mixture for 3D printing and (ii) push the substrate 1150 along a direction 1155.

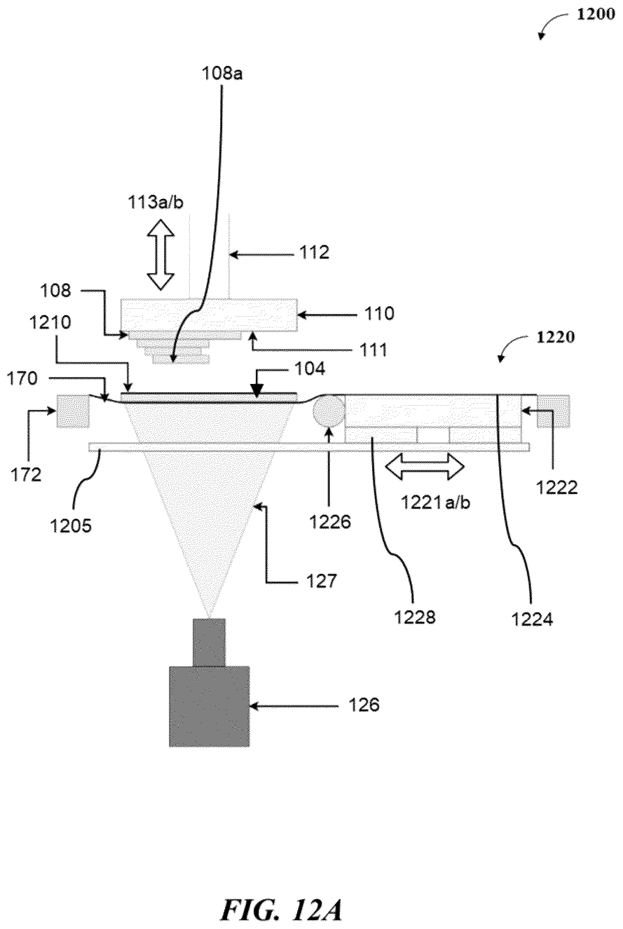

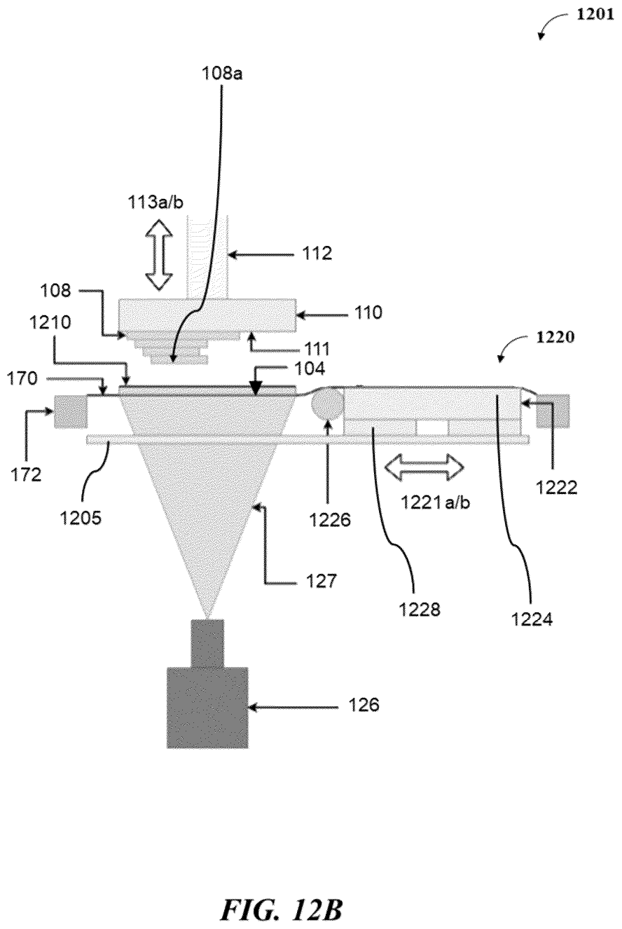

FIG. 12A shows an example 3D printing system 1200. The 3D printing system 1200 comprises one or more components of the 3D printing system 300, as shown in FIG. 3A. For example, referring to FIG. 12A, the 3D printing system 1200 comprises the build head 110 configured to move (e.g., vertically up and down) along the directions 113a/b by action of an actuator 112. The build head 110 comprises a build surface 111 that can hold an object 108, which may comprise a previously printed layer of a 3D object. The previously printed layer of the 3D object 108 comprise a surface 108a, onto which a new layer of the 3D object is to be printed from the mixture 104. The layer of the mixture 104 (i.e., a film of the mixture) is disposed adjacent to the flexible substrate 170 (i.e., a film). The layer of the mixture 104 comprises a top surface 1210 configured to contact the surface 108a of the previously printed layer of the 3D object 108 prior to transforming at least a portion of the layer of the mixture 104 into a new layer of the 3D object 108. The flexible substrate 170 is held by a substrate frame, which can be a part of the film transfer unit 172, as provided in the present disclosure. The film transfer unit 172 is configured to move across a platform 1205 to provide the layer of the mixture 104 to beneath the build head 110. The 3D printing system 1200 further comprises a laminator unit 1220. The laminator unit 1220 comprises a glass plate 1222 (i.e., a print window) having a top surface 1224. The laminator unit 1220 comprises a rounded leading edge 1226 (i.e., a wiper) configured to generate an initial contact with the portion of the flexible substrate 170 that is holding the layer of the mixture 104. The laminator unit 1220 is operatively coupled to one or more actuators 1228, such that the laminator unit 1220 can move laterally across the platform 1205, along the directions 1221a/b. For example, the laminator unit 1220 can move laterally across a bottom surface of the flexible substrate 170 to (i) provide the glass plate 1222 beneath the bottom surface of the flexible substrate 170, (ii) push the flexible substrate 170 and the layer of the mixture 104 upwards towards the build head 108, and (iii) generate a contact between the top surface 1210 of the layer of the mixture 104 and the surface 108a of the object 108 that is disposed adjacent to the build surface 111 of the build head 110. The 3D printing system 1200 further comprises an optical source 126 configured to provide light 127 (e.g., photoinitiation light and/or photoinhibition light) (i) through an opening or a transparent/semi-transparent portion of the platform 1205, (ii) through the glass plate 1222 of the laminator unit 1220, (iii) through the flexible substrate 170, and (iv) to at least a portion of the layer of the mixture 104 for printing a new layer onto the surface 108a of the object 108.

Referring to FIG. 12A, the film transfer unit 172 subjects the flexible substrate 170 to a first tension that allows the portion of the flexible substrate 170 that is holding the layer of the mixture 104 to sink relative to the rest of the flexible substrate 170. The top surface 1224 of the glass plate 1222 of the laminator unit 1220 may be disposed just beneath the flexible substrate 170 without substantially adjusting the vertical position (i.e., height) of the portion of the flexible substrate 170 that does not hold any mixture. As such, allows the portion of the flexible substrate 170 that is holding the layer of the mixture 104 may be at a lower height than the top surface 1224 of the glass plate 1222.

FIG. 12B shows another example 3D printing system 1201. The 3D printing system 1201 may comprise one or more components of the 3D printing system 1200, as shown in FIG. 12A. Referring to FIG. 12B, the film transfer unit 172 subjects the flexible substrate 170 to a second tension such that the portion of the flexible substrate 170 that is holding the layer of the mixture 104 does not sink. For example, the second tension may be higher than the firsts tension as abovementioned. The top surface 1224 of the glass plate 1222 of the laminator unit 1220 may be disposed beneath the flexible substrate 170 to push the portion of the flexible substrate 170 that does not hold any mixture upwards. As such, allows the portion of the flexible substrate 170 that is holding the layer of the mixture 104 may be at a lower height than the top surface 1224 of the glass plate 1222.

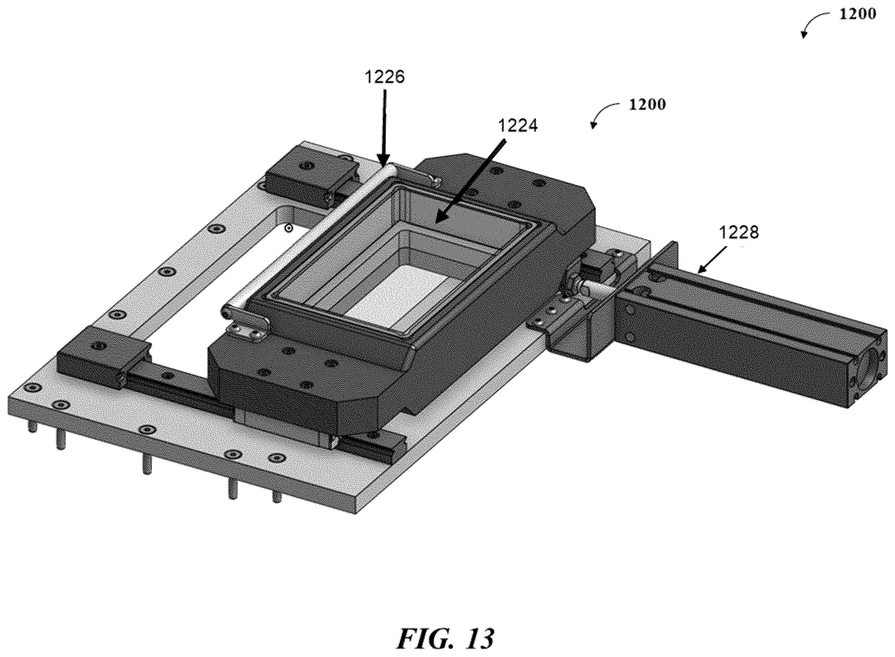

FIG. 13 illustrates a perspective view of laminator unit 1220 of the 3D printing system 1200, as shown in FIG. 12A. Referring to FIG. 13, the laminator unit 1200 comprises the rounded leading edge 1226 (e.g., a wiper), the glass plate 1222 (i.e., a print window), and the actuator 1228 (e.g., a linear motion system). The laminator unit 1200 may be operatively coupled to the film transfer unit 172 of the 3D printing system 1200 to move the glass plate 1222 across a bottom surface of the flexible substrate 170 (which is held by the film transfer unit 172) to provide at least a portion of the glass plate 1222 adjacent to the bottom surface the flexible substrate 170.

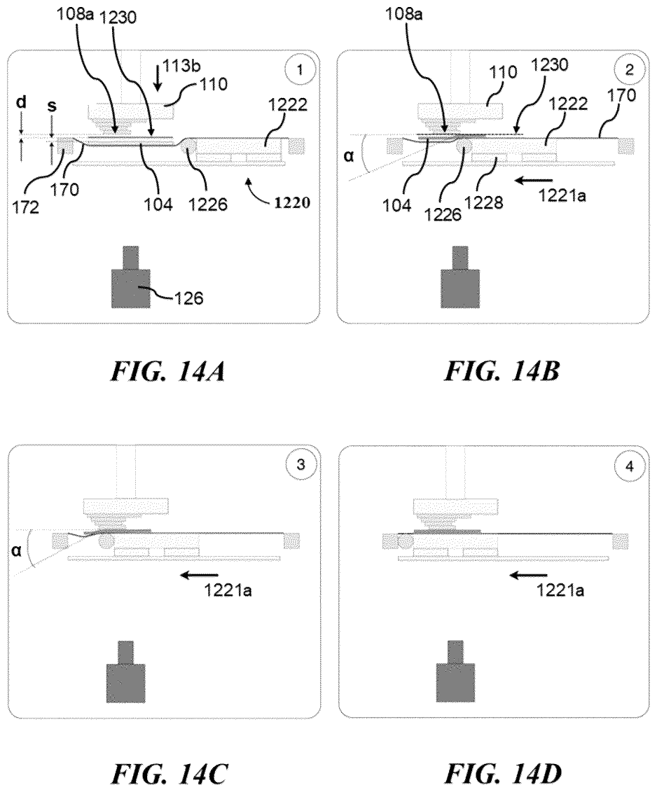

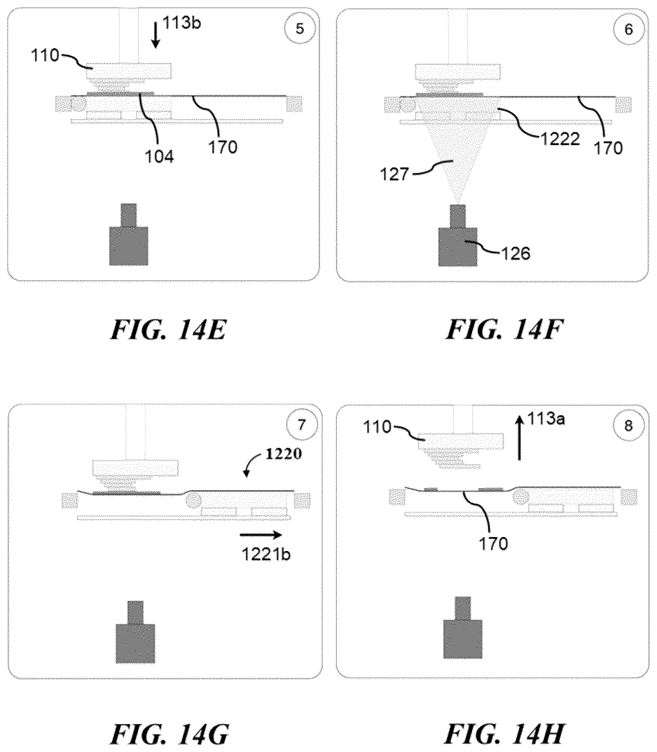

FIGS. 14A-14H schematically illustrate operation of the 3D printing system 1200 provided in FIG. 12A. Referring to FIG. 14A, the laminator unit 1220 is disposed outside the printing zone, which is between the optical source 126 and the build head 110. The flexible substrate 170 carrying a deposited layer of the mixture 103 is provided to the printing zone by the film transfer unit 172. The printing zone is characterizing by having a contact plane 1230, which is a plane in the space between the build head 110 and the layer of the mixture 104. The contact plane 1230 is where a contact between (i) the layer of the mixture 104 and (ii) the surface 108a of the previous layer of the object 108 is to be made, e.g., upon a lateral movement of the laminator unit 1220. Prior to such movement of the laminator unit 1220, the build head 110 is moved down along the direction 113b until the surface 108a of the previous layer of the object 108 is disposed at a distance “d” above the contact plane 1230. Prior to, subsequently, and/or at the same time as the movement of the build head 110, the film transfer unit 172 subjects the flexible substrate 170 to a tension that is sufficient to provide a top surface of the layer of the mixture at a distance “s” beneath the contact plane 1230.

Referring to FIG. 14B, the build head 110 is brought down such that the surface 108a of the previous layer of the object 108 is provided on the contact plane 1230. Subsequently, the actuator 1228 of the laminator unit 1220 subjects the laminator unit 1220 to a lateral movement across a back surface of the flexible substrate 170. During the later movement, the rounded leading edge 1226 (e.g., a wiper) pushes up the flexible substrate 170, thereby subjecting a portion of the layer of the mixture 104 to generate an initial contact with the surface 108a of the previous layer of the object 108 at an angle “a”. The initial contact may prevent entrapment of air between the layer of the mixture 104 and the surface 108a. The rest of the layer of the mixture 104 that is ahead of the laminator unit 1220 is not yet contacting the surface 108a. In addition, the (i) a first plane comprising a first portion of the layer of the mixture 104 that is raised by the laminator unit 1220 towards the contact plane 1230 is parallel to (ii) a second plane comprising a second portion of the layer of the mixture 104 that has not been raised by the laminator unit 1220. The laminator unit 1220 may support the weight of the layer of the mixture 104 to prevent it from peeling off the previous layer of the 3D object.

The angle α that is generated by the rounded leading edge 1226 bending the flexible substrate 170 may be less than about 80 degrees, 75 degrees, 70 degrees, 65 degrees, 60 degrees, 55 degrees, 50 degrees, 45 degrees, 40 degrees, 35 degrees, 30 degrees, 25 degrees, 20 degrees, 19 degrees, 18 degrees, 17 degrees, 16 degrees, 15 degrees, 14 degrees, 13 degrees, 12 degrees, 11 degrees, 10 degrees, 9 degrees, 8 degrees, 7 degrees, 6 degrees, 5 degrees, 4 degrees, 3 degrees, 2 degrees, 1 degrees, 0.5 degrees, 0.1 degrees, or less. In some cases, the angle α may be less than about 60 degrees. In some cases, the angle α may be less than about 40 degrees. In some cases, the angle α may be less than about 30 degrees. In some cases, the angle α may be less than about 20 degrees. In some cases, the angle α may be less than about 10 degrees. The angle α may be determined by a relative position of the rounded leading edge 1226 to the top surface of the glass plate 1222. The angle α may be determined by a dimension of the rounded leading edge 1226 (e.g., radius or diameter of the wiper).

Referring to FIG. 14C, the laminator unit 1220 continues to move (e.g., along the direction 1221a) laterally across (e.g., beneath) the flexible substrate 170, to (i) push up the flexible substrate 170 and (ii) increase the contact area between the layer of the mixture 104 and the surface 108a of the previous layer of the object 108 at the contact angle α. Alternatively or in addition to, the contact angle α may be defined by an angle of the curved surface (i.e., meniscus) of the layer of the mixture 104 (that is not laminated onto the surface 108a) relative to the contact plane 1230. The contact angle α may be kept constant or substantially constant during the lateral movement of the laminator unit 1220. During the continual lateral movement across the bottom surface of the flexible substrate 170, the laminator unit 1220 may push out most or all of air bubbles trapped between the layer of the mixture 104 and the surface 108a (i.e., squeegee effect).

Referring to FIG. 14D, the laminator unit 1220 completes its lateral movement (e.g., along the direction 1221a) with the surface 108a of the previous layer of the object 108 fully in contact with the layer of the mixture 104. As such, the rounded leading edge 1226 (e.g., a wiper) is outside of the printing zone. During the process shown in FIGS. 14A-14D, a tension of the flexible substrate 170 exerted by the film transfer unit 172 may be kept constant or substantially constant. Referring to FIG. 14E, the build head 110 moves down (e.g., along the direction 113b) past the contact plane 1230. Thus, the build head 110 compresses at least a portion of the layer of the mixture 104 towards the flexible substrate 170, such that a thickness of the compressed layer of the mixture between (i) the surface 108a of the previous layer of the object 108 and (ii) the flexible substrate 180 is a desired printing layer thickness. Because the layer of the mixture 104 is compressed after the contact has been made between the layer of the mixture 104 and the surface 108a, there may be minimal or no defects (e.g., air pockets) trapped at such contact.

As described in FIG. 14A, the distance between (i) the surface 108a of the previous layer of the object 108 and (ii) the contact plane 1230 may be indicated as “d.” The distance between (i) the top surface of the layer of the mixture and (ii) the contact plane 1230 may be indicted as “s.” In addition, as described in FIG. 14E, a final thickness of the compressed layer of the mixture (e.g., the desired printing layer thickness) may be indicated as “t.” Furthermore, prior to being “laminated” onto the surface 108a, the layer of the mixture 104 may have a coating thickness of “c.” The distance “s” may not be greater than the thickness “c.” When the distance “s” is less than zero, then (i) the thickness “c” may be greater than or equal to the distance “d” and (ii) the distance “d” may be greater than or equal to the thickness “t.” When the distance “s” is greater than or equal to zero, then the distance “d” may be substantially equal to a value obtained by subtracting the value “s” from the value “c.”

Referring to FIG. 14F, the optical source 126 directs the light 127 through the glass plate 1222 of the laminator unit 1220, through the flexible substrate 170, and towards the compressed layer of the mixture to print at least a portion of the 3D object.

Referring to FIG. 14G, the laminator unit 1220 moves along a direction 1221b (e.g., opposite of the direction 1221a) to retract away from the printing zone. The retraction of the laminator unit 1220 may allow the flexible substrate 170 to relax. For printing a subsequent layer of the 3D object, the printing system 1200 may be subjected to the processes as shown in FIGS. 14A-14G. Alternatively, the laminator unit 1220 may continue to move along the direction 1221a (e.g., as shown in FIG. 14F) to retract away from the printing zone. In such case, the laminator unit 1220 may comprise an additional rounded leading edge (i.e., a wiper) on an opposite side of the rounded leading edge 1226. The laminator unit 1220 may be configured to move along the direction 1221b and use the additional rounded leading edge to repeat the processes as shown in FIGS. 14A-14G.

Referring to FIG. 14F, the build head 110 moves up along the direction 113a, to retract the newly printed layer away from the flexible substrate 170.

A similar process as those illustrated in FIGS. 14A-14H may be performed with the 3D printing system 1201, as shown in FIG. 12B, to print at least a portion of the 3D object.

The 3D printing system provided herein can comprise at least one sensor configured to provide a feedback (e.g., light absorption spectroscopy, image, video, etc.) indicative of the film of the mixture disposed on or adjacent to at least a portion of the platform (e.g., a print window of the platform, a film disposed on or adjacent to the at least the portion of the platform, etc.). The sensor may be operatively coupled to a controller (e.g., a computer) that controls one or more operations (e.g., depositing the film of the mixture onto the at least the portion of the platform) of the 3D printing. The controller may adjust the one or more operations of the 3D printing, based on the feedback provided by the sensor. The controller may adjust the operation(s) during the 3D printing, and thus such feedback may be a closed loop feedback. The sensor may provide the feedback (i) during calibration of the 3D printing system, (ii) prior to, during, and/or subsequent to depositing the film of the mixture to be used for 3D printing, and/or (iii) prior to, during, or subsequent to solidifying (curing) at least a portion of the film of the mixture to print at least a portion of the 3D object. The sensor may provide the feedback pre-fabrication or post-fabrication of the 3D object. The 3D printing may use at least about 1, 2, 3, 4, 5, 6, 7, 8, 9, 10, or more sensors. The 3D printing may use at most about 10, 9, 8, 7, 6, 5, 4, 3, 2, or 1 sensor(s).

Examples of the sensor configured to provide such feedback indicative of the film of the mixture may comprise a detector, vision system, computer vision, machine vision, imager, camera, electromagnetic radiation sensor (e.g., IR sensor, color sensor, etc.), proximity sensor, densitometer (e.g., optical densitometer), profilometer, spectrometer, pyrometer, force sensor (e.g., piezo sensor for pressure, acceleration, temperature, strain, force), motion sensor, magnetic field sensor (e.g., microelectromechanical systems), electric field sensor, chemical sensor, structured-light sensor, etc.

The sensor may be capable of detecting and/or analyzing one or more profiles of various components of the 3D printing system. The various components may be used (e.g., the print window) and/or generated (e,g., the film of mixture or mixture) during the 3D printing process.

The sensor may capture profiles of a print surface (e.g., a portion of the platform, i.e., a print area, the film 170), a surface of the build head that is configured to hold at least a portion of the 3D object during printing, or a surface of a previously deposited layer of the 3D object adjacent to the build head.

The feedback from the sensor may be one or more images of the film of the mixture or any excess mixture remaining on the print surface after printing at least a portion of the 3D object. The feedback from the sensor may be one or more videos (e.g., for a duration of time) of the film of the mixture or the excess mixture remaining on the print surface.

The feedback provided by the sensor may comprise one or more internal or external features (e.g., temperature, transparency or opacity, surface texture, thickness, shape, size, length, area, pattern, density of one or more particles embedded in the film of the mixture, defects, etc.) of the film of the mixture deposited on or adjacent to the print surface. In an example, the sensor provides such feedback of the film of the mixture prior to solidifying (e.g., curing, polymerizing, cross-linking) a portion of the film of the mixture into at least a portion of the 3D object. In another example, the sensor provides such feedback of any excess mixture remaining on the print surface after the portion of the film of the mixture is solidified (e.g., cured, polymerized, cross-linked) into the at least a portion of the 3D object and removed from the print surface (e.g., by the build head). The feedback may comprise the one or more internal or external features of at least a portion of a 3D object printed on the build head, or a portion of a non-printed 3D object on the build head onto which at least a portion of a 3D object is to be printed.

The sensor may be capable of measuring an energy that is emitted, reflected, or transmitted by a medium (e.g., the film of the mixture on the build surface). The sensor may be capable of measuring an energy density, comprising: electromagnetic energy density, optical energy density, reflectance density, transmittance density, absorbance density, spectral density, luminescence (fluorescence, phosphorescence) density, and/or electron density. Such energy density may be indicative of an amount, concentration, and/or density of one or more components (e.g., one or more particles) within one or more points, lines, or areas within the film of the mixture.

The sensor may be operatively coupled to a source of energy for sensing, wherein at least a portion of energy for sensing is measured by the sensor as a feedback indicative of the 3D printing process. Such energy for sensing may be electromagnetic radiation (e.g., from ambient light or from an electromagnetic radiation source) and/or electrons (e.g., from an electron beam). In an example, the sensor may be an IR sensor (e.g., an IR camera), and the source of energy may be an IR light source. In such a case, the IR sensor may detect at least a portion of the IR light from the IR light source that is being reflected by or transmitted from (i) the film of the mixture adjacent to the print surface, or (ii) any excess mixture remaining on the print surface. The IR light being reflected by or transmitted from the film of the mixture or any excess mixture may be zero-dimensional (a point), 1D (a line), or 2D (a plane).

A single sensor may be operatively coupled to a single source of energy for sensing. A single sensor may be operatively coupled to at least 2, 3, 4, 5, 6, 7, 8, 9, 10, or more sources of energy for sensing that are the same or different. A single sensor may be operatively coupled to at most 10, 9, 8, 7, 6, 5, 4, 3, or 2 sources of energy for sensing that are the same or different. A single source of energy for sensing may be operatively coupled to at least 2, 3, 4, 5, 6, 7, 8, 9, 10, or more sensors that are the same or different. A single source of energy for sensing may be operatively coupled to at most 10, 9, 8, 7, 6, 5, 4, 3, or 2 sensors that are the same or different.

One or more sensors and one or more sources of energy for sensing may be part of a same system (e.g., a single enclosed unit) or different systems. The one or more sensors may be disposed below, within, on, and/or over the build surface. The one or more sensors and the one or more sources of energy for sensing may be on a same side or opposite sides of a component of the 3D printing system (e.g., the print window or film comprising the print surface, the film of the mixture adjacent to the print surface, etc.). In some examples, the one or more sensors and the one or more sources of energy may be in contact with the print surface, the film of the mixture adjacent to the print surface, and/or any excess mixture remaining on the print surface subsequent to printing a layer of the 3D object. In some examples, the one or more sensors and the one or more sources of energy may not be in contact with the print surface, the film of the mixture adjacent to the print surface, and/or any excess mixture remaining on the print surface subsequent to printing a layer of the 3D object.

The sensor may not be in contact with the film of the mixture while generating the feedback. The sensor may be in contact with the film of the mixture while generating the feedback.

The sensor and/or the source of energy for sensing may be stationary with respect to the print surface (e.g., the print window or the film disposed on or adjacent to the platform). The sensor and/or the source of energy for sensing may be movable with respect to the print surface. Such movement may be a relative movement, and thus the moving piece may be the sensor, the source of energy for sensing, and/or the print surface.

The one or more sensors may be operatively coupled to a controller (e.g., a computer) capable of employing artificial intelligence (e.g., one or more machine learning algorithms) to analyze a database comprising a plurality of feedbacks indicative of various components of the 3D printing system, such as the film of the mixture on the print surface or of any excess mixture remaining on the print surface after printing a portion of the 3D object. One or more machine learning algorithms of the artificial intelligence may be capable of distinguishing or differentiating profiles (e.g., features) of a film of the mixture on or adjacent to the print surface based on the database. Such features may comprise the film quality, film thickness, density of one or more components (e.g., one or more particles, etc.) in the film of the mixture, or one or more defects (e.g., bubbles, wrinkles, pre-polymerized particulates, etc.).

The database may further comprise a plurality of training data sets that comprise example feedback indicative of the features of the film of the mixture. The plurality of training data sets may allow the machine learning algorithm(s) to learn a plurality of parameters to generate one or more models (e.g., mathematical models, classifiers) that can be used to distinguish or differentiate the features of a new film of the mixture received from the one or more sensors during the 3D printing. In an example, the feedback from a sensor may be an optical (e.g., IR) densitometry profile of the film of the mixture. In such a case, the trained machine learning algorithm may be used to distinguish (i) a variation in optical density due to a height defect across the film of the mixture, (ii) a variation in optical density due to voids (e.g., bubbles, streaks, etc.) in the film of the mixture, and (iii) a variation in optical density due to a difference in the density of one or more particles (e.g., metal or ceramic particles) in the film of the mixture.

A series of machine learning algorithms may be connected as an artificial neural network to better recognize, categorize, and/or classify each feature of the film of the mixture or each feature of any excess mixture remaining on the print surface from the feedback of the one or more sensors. An artificial intelligence system capable of acquiring, processing, and analyzing image and/or video feedbacks from the one or more sensors, and such system may be referred to as computer vision.

The one or more machine learning algorithms may use deep learning algorithms. The deep learning algorithms may be capable of generating new classifications (e.g., categories, sub-categories, etc.) of one or more features of the mixture or the film of the mixture, based on a new feedback and a database comprising a plurality of previous feedbacks and example feedbacks. The deep learning algorithms may use the new classifications to distinguish or differentiate the features of the mixture or the film of the mixture.

The diffuser may be disposed between the one or more sources of energy (e.g., one or more electromagnetic radiations) for sensing and the corresponding sensor(s). In an example, the diffuser may diffuse the one or more electromagnetic radiations (e.g., one or more IR lights) and direct the scattered electromagnetic radiations towards a build surface (e.g., a print window), to the film of the mixture, and to the corresponding sensor(s) (e.g., one or more IR sensors). The scattered electromagnetic radiations may be directed to the film of the mixture without passing through the build surface. In another example, the diffuser may be adjacent to the one or more sensor(s).

The diffuser may be transparent, semi-transparent, semi-opaque, or opaque. The diffuser may be ceramic, polymeric (e.g., polycarbonate, polytetrafluoroethylene (PTFE), etc.), or a combination thereof. Examples of the diffuser comprise a holographic diffuser, a white diffusing glass, and a ground glass diffuser. Other examples of the diffuser include paper or fabric.

One or more surfaces of the diffuser may comprise a matte finish on its surface to further assist in scattering the one or more electromagnetic radiations. The diffuser may not be a mirror. During the 3D printing process, at least about 1, 2, 3, 4, 5, or more diffusers may be used. During the 3D printing process, at most about 5, 4, 3, 2, or 1 diffuser may be used.

The mixture may be used for printing the at least the portion of the 3D object. The mixture may comprise a photoactive resin to form a polymeric material. The photoactive resin may comprise a polymeric precursor of the polymeric material. The photoactive resin may comprise at least one photoinitiator that is configured to initiate formation of the polymeric material from the polymeric precursor. The photoactive resin may comprise at least one photoinhibitor that is configured to inhibit formation of the polymeric material from the polymeric precursor. The mixture may comprise a plurality of particles for forming the at least the portion of the 3D object.

The mixture may be the photoactive resin. The viscosity of the photoactive resin may range between about 1 cP to about 2,000,000 cP. The viscosity of the photoactive resin may be at least about 1 cP, 5 cP, 10 cP, 50 cP, 100 cP, 500 cP, 1000 cP, 5,000 cP, 10,000 cP, 50,000 cP, 100,000 cP, 500,000 cP, 1,000,000 cP, 2,000,000 cP, or more. The viscosity of the photoactive resin may be at most about 2,000,000 cP, 1,000,000 cP, 500,000 cP, 100,000 cP, 50,000 cP, 10,000 cP, 5,000 cP, 1,000 cP, 500 cP, 100 cP, 50 cP, 10 cP, 5 cP, 1 cP, or less.

The mixture may be a non-Newtonian fluid. The viscosity of the mixture may vary based on a shear rate or shear history of the mixture. As an alternative, the mixture may be a Newtonian fluid.

The mixture may comprise the photoactive resin and the plurality of particles. The viscosity of the mixture may range between about 4,000 cP to about 2,000,000 cP. The viscosity of the mixture may be at least about 4,000 cP, 10,000 cP, 20,000 cP, 30,000 cP, 40,000 cP, 50,000 cP, 60,000 cP, 70,000 cP, 80,000 cP, 90,000 cP, 100,000 cP, 200,000 cP, 300,000 cP, 400,000 cP, 500,000 cP, 600,000 cP, 700,000 cP, 800,000 cP, 900,000 cP, 1,000,000 cP, 2,000,000 cP, or more. The viscosity of the mixture may be at most about 2,000,000 cP, 1,000,000 cP, 900,000 cP, 800,000 cP, 700,000 cP, 600,000 cP, 500,000 cP, 400,000 cP, 300,000 cP, 200,000 cP, 100,000 cP, 90,000 cP, 80,000 cP, 70,000 cP, 60,000 cP, 50,000 cP, 40,000 cP, 30,000 cP, 20,000 cP, 10,000 cP, 4,000 cP, or less.

In the mixture comprising the photoactive resin and the plurality of particles, the photoactive resin may be present in an amount ranging between about 5 volume % (vol %) to about 80 vol % in the mixture. The photoactive resin may be present in an amount of at least about 5 vol %, 6 vol %, 7 vol %, 8 vol %, 9 vol %, 10 vol %, 11 vol %, 12 vol %, 13 vol %, 14 vol %, 15 vol %, 16 vol %, 17 vol %, 18 vol %, 19 vol %, 20 vol %, 21 vol %, 22 vol %, 23 vol %, 24 vol %, 25 vol %, 30 vol %, 35 vol %, 40 vol %, 45 vol %, 50 vol %, 55 vol %, 60 vol %, 65 vol %, 70 vol %, 75 vol %, 80 vol %, or more in the mixture. The photoactive resin may be present in an amount of at most about 80 vol %, 75 vol %, 70 vol %, 65 vol %, 60 ol %, 55 vol %, 50 vol %, 45 vol %, 40 vol %, 35 vol %, 30 vol %, 25 vol %, 24 vol %, 23 vol %, 22 vol %, 21 vol %, 20 vol %, 19 vol %, 18 vol %, 17 vol %, 16 vol %, 15 vol %, 14 vol %, 13 vol %, 12 vol %, 11 vol %, 10 vol %, 9 vol %, 8 vol %, 7 vol %, 6 vol %, 5 vol %, or less in the mixture.

The polymeric precursor in the photoactive resin may comprise monomers to be polymerized into the polymeric material, oligomers to be cross-linked into the polymeric material, or both. The monomers may be of the same or different types. An oligomer may comprise two or more monomers that are covalently linked to each other. The oligomer may be of any length, such as at least 2 (dimer), 3 (trimer), 4 (tetramer), 5 (pentamer), 6 (hexamer), 7, 8, 9, 10, 20, 30, 40, 50, 100, 200, 300, 400, 500, or more monomers. Alternatively or in addition to, the polymeric precursor may include a dendritic precursor (monodisperse or polydisperse). The dendritic precursor may be a first generation (G1), second generation (G2), third generation (G3), fourth generation (G4), or higher with functional groups remaining on the surface of the dendritic precursor. The resulting polymeric material may comprise a monopolymer and/or a copolymer. The copolymer may be a linear copolymer or a branched copolymer. The copolymer may be an alternating copolymer, periodic copolymer, statistical copolymer, random copolymer, and/or block copolymer.

Examples of monomers include one or more of hydroxyethyl methacrylate; n-Lauryl acrylate; tetrahydrofurfuryl methacrylate; 2, 2, 2-trifluoroethyl methacrylate; isobornyl methacrylate; polypropylene glycol monomethacrylates, aliphatic urethane acrylate (i.e., Rahn Genomer 1122); hydroxyethyl acrylate; n-Lauryl methacrylate; tetrahydrofurfuryl acrylate; 2, 2, 2-trifluoroethyl acrylate; isobornyl acrylate; polypropylene glycol monoacrylates; trimethylpropane triacrylate; trimethylpropane trimethacrylate; pentaerythritol tetraacrylate; pentaerythritol tetraacrylate; triethyleneglycol diacrylate; triethylene glycol dimethacrylate; tetrathyleneglycol diacrylate; tetrathylene glycol dimethacrylate; neopentyldimethacrylate; neopentylacrylate; hexane dioldimethacylate; hexane diol diacrylate; polyethylene glycol 400 dimethacrylate; polyethylene glycol 400 diacrylate; diethylglycol diacrylate; diethylene glycol dimethacrylate; ethyleneglycol diacrylate; ethylene glycol dimethacrylate; ethoxylated bis phenol A dimethacrylate; ethoxylated bis phenol A diacrylate; bisphenol A glycidyl methacrylate; bisphenol A glycidyl acrylate; ditrimethylolpropane tetraacrylate; and ditrimethylolpropane tetraacrylate.

Polymeric precursors may be present in an amount ranging between about 3 weight % (wt %) to about 90 wt % in the photoactive resin of the mixture. The polymeric precursors may be present in an amount of at least about 3 wt %, 4 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, or more in the photoactive resin of the mixture. The polymeric precursors may be present in an amount of at most about 90 wt %, 85 wt %, 80 wt %, 75 wt %, 70 wt %, 65 wt %, 60 wt %, 55 wt %, 50 wt %, 45 wt %, 40 wt %, 35 wt %, 30 wt %, 25 wt %, 20 wt %, 15 wt %, 10 wt %, 5 wt %, 4 wt %, 3 wt %, or less in the photoactive resin of the mixture.

Photopolymerization of the polymeric precursors into the polymeric material may be controlled by one or more photoactive species, such as the at least one photoinitiator and the at least one photoinhibitor. The at least one photoinitiator may be a photon-absorbing compound that (i) is activated by a first light comprising a first wavelength and (ii) initiates photopolymerization of the polymeric precursors. The at least one photoinhibitor may be another photon-absorbing compound that (i) is activated by a second light comprising a second wavelength and (ii) inhibits the photopolymerization of the polymeric precursors. The first wavelength and the second wavelength may be different. The first light and the second light may be directed by the same light source. As an alternative, the first light may be directed by a first light source and the second light may be directed by a second light source. In some examples, the first light may comprise wavelengths ranging between about 420 nm to about 510 nm. In some examples, the second light may comprise wavelengths ranging between about 350 nm to about 410 nm. In an example, the first wavelength to induce photoinitiation is about 460 nm. In an example, the second wavelength to induce photoinhibition is about 365 nm.

Relative rates of the photoinitiation by the at least one photoinitiator and the photoinhibition by the at least one photoinhibitor may be controlled by adjusting the intensity and/or duration of the first light, the second light, or both. By controlling the relative rates of the photoinitiation and the photoinhibition, an overall rate and/or amount (degree) of polymerization of the polymeric precursors into the polymeric material may be controlled. Such process may be used to (i) prevent polymerization of the polymeric precursors at the print surface-mixture interface, (ii) control the rate at which polymerization takes place in the direction away from the print surface, and/or (iii) control a thickness of the polymeric material within the film of the mixture.

Examples of types of the at least one photoinitiator include one or more of benzophenones, thioxanthones, anthraquinones, benzoylformate esters, hydroxyacetophenones, alkylaminoacetophenones, benzil ketals, dialkoxyacetophenones, benzoin ethers, phosphine oxides acyloximino esters, alphahaloacetophenones, trichloromethyl-S-triazines, titanocenes, dibenzylidene ketones, ketocoumarins, dye sensitized photoinitiation systems, maleimides, and mixtures thereof.

Examples of the at least one photoinitiator in the photoactive resin include one or more of 1-hydroxy-cyclohexyl-phenyl-ketone (Irgacure™ 184; BASF, Hawthorne, NJ); a 1:1 mixture of 1-hydroxy-cyclohexyl-phenyl-ketone and benzophenone (Irgacure™ 500; BASF); 2-hydroxy-2-methyl-1-phenyl-1-propanone (Darocur™ 1173; BASF); 2-hydroxy-1-[4-(2-hydroxyethoxy)phenyl]-2-methyl-1-propanone (Irgacure™ 2959; BASF); methyl benzoylformate (Darocur™ MBF; BASF); oxy-phenyl-acetic acid 2-[2-oxo-2-phenyl-acetoxy-ethoxy]-ethyl ester; oxy-phenyl-acetic 2-[2-hydroxy-ethoxy]-ethyl ester; a mixture of oxy-phenyl-acetic acid 2-[2-oxo-2-phenyl-acetoxy-ethoxy]-ethyl ester and oxy-phenyl-acetic 2-[2-hydroxy-ethoxy]-ethyl ester (Irgacure™ 754; BASF); alpha,alpha-dimethoxy-alpha-phenylacetophenone (Irgacure™ 651; BASF); 2-benzyl-2-(dimethylamino)-1-[4-(4-morpholinyl)-phenyl]-1-butanone (Irgacure™ 369; BASF); 2-methyl-1-[4-(methylthio)phenyl]-2-(4-morpholinyl)-1-propanone (Irgacure™ 907; BASF); a 3:7 mixture of 2-benzyl-2-(dimethylamino)-1-[4-(4-morpholinyl)phenyl]-1-butanone and alpha,alpha-dimethoxy-alpha-phenylacetophenone per weight (Irgacure™ 1300; BASF); diphenyl-(2,4,6-trimethylbenzoyl) phosphine oxide (Darocur™ TPO; BASF); a 1:1 mixture of diphenyl-(2,4,6-trimethylbenzoyl)-phosphine oxide and 2-hydroxy-2-methyl-1-phenyl-1-propanone (Darocur™ 4265; BASF); phenyl bis(2,4,6-trimethyl benzoyl) phosphine oxide, which can be used in pure form (Irgacure™ 819; BASF, Hawthorne, NJ) or dispersed in water (45% active, Irgacure™ 819DW; BASF); 2:8 mixture of phosphine oxide, phenyl bis(2,4,6-trimethyl benzoyl) and 2-hydroxy-2-methyl-1-phenyl-1-propanone (Irgacure™ 2022; BASF); Irgacure™ 2100, which comprises phenyl-bis(2,4,6-trimethylbenzoyl)-phosphine oxide); bis-(eta 5-2,4-cyclopentadien-1-yl)-bis-[2,6-difluoro-3-(1H-pyrrol-1-yl)phenyl]-titanium (Irgacure™ 784; BASF); (4-methylphenyl) [4-(2-methylpropyl)phenyl]-iodonium hexafluorophosphate (Irgacure™ 250; BASF); 2-(4-methylbenzyl)-2-(dimethylamino)-1-(4-morpholinophenyl)-butan-1-one (Irgacure™ 379; BASF); 4-(2-hydroxyethoxy)phenyl-(2-hydroxy-2-propyl) ketone (Irgacure™ 2959; BASF); bis-(2,6-dimethoxybenzoyl)-2,4,4-trimethylpentylphosphine oxide; a mixture of bis-(2,6-dimethoxybenzoyl)-2,4,4-trimethylpentylphosphine oxide and 2 hydroxy-2-methyl-1-phenyl-propanone (Irgacure™ 1700; BASF); 4-Isopropyl-9-thioxanthenone; and mixtures thereof.

The at least one photoinitiator may be present in an amount ranging between about 0.1 wt % to about 10 wt % in the photoactive resin. The at least one photoinitiator may be present in an amount of at least about 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, or more in the photoactive resin. The at least one photoinitiator may be present in an amount of at most about 10 wt %, 9 wt %, 8 wt %, 7 wt %, 6 wt %, 5 wt %, 4 wt %, 3 wt %, 2 wt %, 1 wt %, 0.9 wt %, 0.8 wt %, 0.7 wt %, 0.6 wt %, 0.5 wt %, 0.4 wt %, 0.3 wt %, 0.2 wt %, 0.1 wt %, or less in the photoactive resin.

The at least one photoinhibitor in the photoactive resin may comprise one or more radicals that may preferentially terminate growing polymer radicals, rather than initiating polymerization of the polymeric precursors. Examples of types of the at least one photoinitiator include: one or more of sulfanylthiocarbonyl and other radicals generated in photoiniferter polymerizations; sulfanylthiocarbonyl radicals used in reversible addition-fragmentation chain transfer polymerization; and nitrosyl radicals used in nitroxide mediate polymerization. Other non-radical species that can be generated to terminate growing radical chains may include the numerous metal/ligand complexes used as deactivators in atom-transfer radical polymerization (ATRP). Thus, additional examples of the types of the at least one photoinhibitor include: one or more of thiocarbamates, xanthates, dithiobenzoates, hexaarylbiimidazoles, photoinitiators that generate ketyl and other radicals that tend to terminate growing polymer chains radicals (i.e., camphorquinone (CQ) and benzophenones), ATRP deactivators, and polymeric versions thereof.

Examples of the at least one photoinhibitors in the photoactive resin include one or more of zinc dimethyl dithiocarbamate; zinc diethyl dithiocarbamate; zinc dibutyl dithiocarbamate; nickel dibutyl dithiocarbamate; zinc dibenzyl dithiocarbamate; tetramethylthiuram disulfide; tetraethylthiuram disulfide (TEDS); tetramethylthiuram monosulfide; tetrabenzylthiuram disulfide; tetraisobutylthiuram disulfide; dipentamethylene thiuram hexasulfide; N,N′-dimethyl N,N′-di(4-pyridinyl) thiuram disulfide; 3-Butenyl 2-(dodecylthiocarbonothioylthio)-2-methylpropionate; 4-Cyano-4-[(dodecylsulfanylthiocarbonyl) sulfanyl]pentanoic acid; 4-Cyano-4-[(dodecylsulfanylthiocarbonyl) sulfanyl]pentanol; Cyanomethyl dodecyl trithiocarbonate; Cyanomethyl[3-(trimethoxysilyl) propyl]trithiocarbonate; 2-Cyano-2-propyl dodecyl trithiocarbonate; S,S-Dibenzyl trithiocarbonate; 2-(Dodecylthiocarbonothioylthio)-2-methylpropionic acid; 2-(Dodecylthiocarbonothioylthio)-2-methylpropionic acid N-hydroxysuccinimide; Benzyl 1H-pyrrole-1-carbodithioate; Cyanomethyl diphenylcarbamodithioate; Cyanomethyl methyl(phenyl) carbamodithioate; Cyanomethyl methyl (4-pyridyl) carbamodithioate; 2-Cyanopropan-2-yl N-methyl-N-(pyridin-4-yl) carbamodithioate; Methyl 2-[methyl (4-pyridinyl) carbamothioylthio]propionate; 1-Succinimidyl-4-cyano-4-[N-methyl-N-(4-pyridyl) carbamothioylthio]pentanoate; Benzyl benzodithioate; Cyanomethyl benzodithioate; 4-Cyano-4-(phenylcarbonothioylthio) pentanoic acid; 4-Cyano-4-(phenylcarbonothioylthio) pentanoic acid N-succinimidyl ester; 2-Cyano-2-propyl benzodithioate; 2-Cyano-2-propyl 4-cyanobenzodithioate; Ethyl 2-(4-methoxyphenylcarbonothioylthio)acetate; 2-Phenyl-2-propyl benzodithioate; Cyanomethyl methyl (4-pyridyl) carbamodithioate; 2-Cyanopropan-2-yl N-methyl-N-(pyridin-4-yl) carbamodithioate; 2,2′-Bis(2-chlorophenyl)-4,4′,5,5′-tetraphenyl-1,2′-biimidazole; 2-(2-ethoxyphenyl)-1-[2-(2-ethoxyphenyl)-4,5-diphenyl-2H-imidazol-2-yl]-4,5-diphenyl-1H-imidazole; 2,2′,4-tris-(2-Chlorophenyl)-5-(3,4-dimethoxyphenyl)-4′,5′-diphenyl-1,1′-biimidazole; and Methyl 2-[methyl (4-pyridinyl) carbamothioylthio]propionate.

In some examples, the photoinhibitor may comprise a hexaarylbiimidazole (HABI) or a functional variant thereof. The hexaarylbiimidazole may comprise a phenyl group with a halogen and/or an alkoxy substitution. In an example, the phenyl group comprises an ortho-chloro-substitution. In another example, the phenyl group comprises an ortho-methoxy-substitution. In another example, the phenyl group comprises an ortho-ethoxy-substitution. Examples of the functional variants of the hexaarylbiimidazole include: 2,2′-Bis(2-chlorophenyl)-4,4′,5,5′-tetraphenyl-1,2′-biimidazole; 2-(2-methoxyphenyl)-1-[2-(2-methoxyphenyl)-4,5-diphenyl-2H-imidazol-2-yl]-4,5-diphenyl-1H-imidazole; 2-(2-ethoxyphenyl)-1-[2-(2-ethoxyphenyl)-4,5-diphenyl-2H-imidazol-2-yl]-4,5-diphenyl-1H-imidazole; and 2,2′,4-tris-(2-Chlorophenyl)-5-(3,4-dimethoxyphenyl)-4′,5′-diphenyl-1,l′-biimidazole.

The at least one photoinhibitor may be present in an amount ranging between about 0.1 wt % to about 10 wt % in the photoactive resin. The at least one photoinhibitor may be present in an amount of at least about 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 7 wt %, 8 wt %, 9 wt %, 10 wt %, or more in the photoactive resin. The at least one photoinhibitor may be present in an amount of at most about 10 wt %, 9 wt %, 8 wt %, 7 wt %, 6 wt %, 5 wt %, 4 wt %, 3 wt %, 2 wt %, 1 wt %, 0.9 wt %, 0.8 wt %, 0.7 wt %, 0.6 wt %, 0.5 wt %, 0.4 wt %, 0.3 wt %, 0.2 wt %, 0.1 wt %, or less in the photoactive resin.

Alternatively or in addition to, the photoactive resin may include a co-initiator. The co-initiator may be used to enhance the polymerization rate of the polymeric precursors. Suitable classes of the co-initiators may include: primary, secondary, and tertiary amines; alcohols; and thiols. Examples of the co-initiators may include: one or more of isoamyl 4-(dimethylamino)benzoate, 2-ethylhexyl 4-(dimethylamino)benzoate; ethyl 4-(dimethylamino)benzoate (EDMAB); 3-(dimethylamino) propyl acrylate; 2-(dimethylamino)ethyl methacrylate; 4-(dimethylamino)benzophenones, 4-(diethylamino)benzophenones; 4,4′-Bis(diethylamino)benzophenones; methyl diethanolamine; triethylamine; hexane thiol; heptane thiol; octane thiol; nonane thiol; decane thiol; undecane thiol; dodecane thiol; isooctyl 3-mercaptopropionate; pentaerythritol tetrakis(3-mercaptopropionate); 4,4′-thiobisbenzenethiol; trimethylolpropane tris(3-mercaptopropionate); CN374 (Sartomer); CN371 (Sartomer), CN373 (Sartomer), Genomer 5142 (Rahn); Genomer 5161 (Rahn); Genomer (5271 (Rahn); Genomer 5275 (Rahn), and TEMPIC (Bruno Boc, Germany).

The at least one photoinitiator and the co-initiator may be activated by the same light. The at least one photoinitiator and the co-initiator may be activated by the same wavelength and/or two different wavelengths of the same light. Alternatively or in addition to, the at last one photoinitiator and the co-initiator may be activated by different lights comprising different wavelengths. The system may comprise a co-initiator light source configured to direct a co-initiation light comprising a wavelength sufficient to activate the co-initiator to the film of the mixture.

The co-initiator may be a small molecule (e.g., a monomer). Alternatively or in addition to, the co-initiator may be an oligomer or polymer comprising a plurality of small molecules. The co-initiator may be present in an amount ranging between about 0.1 wt % to about 10 wt % in the photoactive resin. The co-initiator may be present in an amount of at least about 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, or more in the photoactive resin. The co-initiator may be present in an amount of at most about 10 wt %, 9 wt %, 8 wt %, 7 wt %, 6 wt %, 5 wt %, 4 wt %, 3 wt %, 2 wt %, 1 wt %, 0.9 wt %, 0.8 wt %, 0.7 wt %, 0.6 wt %, 0.5 wt %, 0.4 wt %, 0.3 wt %, 0.2 wt %, 0.1 wt %, or less in the photoactive resin.

The photoactive resin may comprise one or more dyes. The one or more dyes may be used to attenuate light, to transfer energy to the photoactive species, or both. The one or more dyes may transfer energy to the photoactive species to increase sensitivity of the photoactive resin to the first light for the photoinitiation process, the second light for the photoinhibition process, or both. In an example, the photoactive resin comprises at least one dye configured to absorb the second light having the second wavelength, which second wavelength is for activating the at least one photoinhibitor. Exposing the photoactive resin to the second light may initiate the at least one dye to absorb the second light and (i) reduce an amount of the second light exposed to the at least one photoinhibitor, thereby controlling the depth of penetration of the second light into the film of the mixture, and/or (ii) transfer (e.g., via Förster resonance energy transfer (FRET)) some of the absorbed energy from the second light to the at least one photoinhibitor, thereby improving the efficiency of photoinhibition. Examples of the one or more dyes may include compounds commonly used as ultraviolet (UV) light absorbers, including 2-hydroxyphenyl-benzophenones, 2-(2-hydroxyphenyl)-benzotriazoles, and 2-hydroxyphenyl-s-triazines. Alternatively or in addition to, the one or more dyes may include those used for histological staining or dying of fabrics, including Martius yellow, Quinoline yellow, Sudan red, Sudan I, Sudan IV, eosin, eosin Y, neutral red, and acid red.

A concentration of the one or more dyes in the photoactive resin may be dependent on the light absorption properties of the one or more dyes. The one or more dyes may be present in an amount ranging between about 0.1 wt % to about 10 wt % in the photoactive resin. The one or more dyes may be present in an amount of at least about 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, or more in the photoactive resin. The one or more dyes may be present in an amount of at most about 10 wt %, 9 wt %, 8 wt %, 7 wt %, 6 wt %, 5 wt %, 4 wt %, 3 wt %, 2 wt %, 1 wt %, 0.9 wt %, 0.8 wt %, 0.7 wt %, 0.6 wt %, 0.5 wt %, 0.4 wt %, 0.3 wt %, 0.2 wt %, 0.1 wt %, or less in the photoactive resin.

The mixture may comprise the plurality of particles for forming the at least the portion of the 3D object. The amount of the plurality of particles in the mixture may be sufficient to minimize shrinking of the green body during sintering. The plurality of particles may comprise any particulate material (a particle) that can be melted or sintered (e.g., not completely melted). The particulate material may be in powder form. The particular material may be inorganic materials. The inorganic materials may be metallic, intermetallic, ceramic materials, or any combination thereof. The one or more particles may comprise at least one metallic material, at least one intermetallic material, at least one ceramic material, at least one polymeric material, or any combination thereof.

Whereas powdered metals alone may be a severe safety hazard and may explode and/or require extensive safety infrastructures, using powdered metals that are dispersed in the mixture may avoid or substantially reduce the risks relevant to using the powdered metals that are not dispersed in a liquid medium. Additionally, photopolymer-based 3D printing using the mixture comprising the photoactive resin and the powdered metals may be performed without using heat, thereby avoiding or substantially reducing thermal distortion to the at least the portion of the 3D object during printing.

The metallic materials for the particles may include one or more of aluminum, calcium, magnesium, barium, scandium, titanium, vanadium, chromium, manganese, iron, cobalt, nickel, copper, zinc, yttrium, niobium, molybdenum, ruthenium, rhodium, silver, cadmium, actinium, and gold. The particles may comprise a rare earth element. The rare earth element may include one or more of scandium, yttrium, and elements of the lanthanide series having atomic numbers from 57-71.

An intermetallic material may be a solid-state compound exhibiting metallic bonding, defined stoichiometry and ordered crystal structure (i.e., alloys). The intermetallic materials may be in prealloyed powder form. Examples of such prealloyed powders may include, but are not limited to, brass (copper and zinc), bronze (copper and tin), duralumin (aluminum, copper, manganese, and/or magnesium), gold alloys (gold and copper), rose-gold alloys (gold, copper, and zinc), nichrome (nickel and chromium), and stainless steel (iron, carbon, and additional elements including manganese, nickel, chromium, molybdenum, boron, titanium, silicon, vanadium, tungsten, cobalt, and/or niobium). The prealloyed powders may include superalloys. The superalloys may be based on elements including iron, nickel, cobalt, chromium, tungsten, molybdenum, tantalum, niobium, titanium, and/or aluminum.

The ceramic materials may comprise metal (e.g., aluminum, titanium, etc.), non-metal (e.g., oxygen, nitrogen, etc.), and/or metalloid (e.g., germanium, silicon, etc.) atoms primarily held in ionic and covalent bonds. Examples of the ceramic materials include, but are not limited to, an aluminide, boride, beryllia, carbide, chromium oxide, hydroxide, sulfide, nitride, mullite, kyanite, ferrite, titania zirconia, yttria, and magnesia.

The mixture may comprise a pre-ceramic material. The pre-ceramic material may be a polymer that can be heated (or pyrolyzed) to form a ceramic material. The pre-ceramic material may include polyorganozirconates, polyorganoaluminates, polysiloxanes, polysilanes, polysilazanes, polycarbosilanes, polyborosilanes, etc. Additional examples of the pre-ceramic material include zirconium tetramethacrylate, zirconyl dimethacrylate, or zirconium 2-ethylhexanoate; aluminum III s-butoxide, aluminum III diisopropoxide-ethylacetoacetate; 1,3-bis(chloromethyl) 1,1,3,3-Tetrakis(trimethylsiloxy)disiloxane; 1,3-bis(3-carboxypropyl)tetramethyldisiloxane; 1,3,5,7-tetraethyl-2,4,6,8-tetramethylcyclotetrasilazane; tris(trimethylsilyl)phosphate; tris(trimethylsiloxy) boron; and mixtures thereof.

A cross-sectional dimension of the plurality of particles may range between about 1 nanometers (nm) to about 500 μm. The cross-sectional dimension of the plurality of particles may be at least about 1 nm, 2 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 200 μm, 300 μm, 400 μm, 500 μm, or greater. The cross-sectional dimension of the plurality of particles may be at most about 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, 1 nm, or smaller.

The plurality of particles (e.g., metallic, intermetallic, and/or ceramic particles) may be present in an amount ranging between about 5 vol % to about 90 vol % in the mixture. The plurality of particles may be present in an amount of at least about 5 vol %, 10 vol %, 15 vol %, 20 vol %, 25 vol %, 30 vol %, 35 vol %, 40 vol %, 45 vol %, 50 vol %, 55 vol %, 60 vol %, 65 vol %, 70 vol %, 75 vol %, 80 vol %, 85 vol %, 90 vol %, or more in the mixture. The plurality of particles may be present in an amount of at most about 90 vol %, 85 vol %, 80 vol %, 75 vol %, 70 vol %, 65 vol %, 60 vol %, 55 vol %, 50 vol %, 45 vol %, 40 vol %, 35 vol %, 30 vol %, 25 vol %, 20 vol %, 15 vol %, 10 vol %, 5 vol %, or less in the mixture.

The mixture may comprise an anti-settling component to prevent settling of the plurality of particles and keep them suspend in the mixture. The anti-settling component may sterically limit the plurality of particles from moving closer to each other. The anti-settling component may not scatter light (e.g., the first light and/or the second light) to avoid negatively affecting the penetration depth of the light into the mixture. The anti-settling component may be present in an amount ranging between about 5 vol % to about 90 vol % in the mixture. The anti-settling component may be present in an amount of at least about 5 vol %, 10 vol %, 15 vol %, 20 vol %, 25 vol %, 30 vol %, 35 vol %, 40 vol %, 45 vol %, 50 vol %, 55 vol %, 60 vol %, 65 vol %, 70 vol %, 75 vol %, 80 vol %, 85 vol %, 90 vol %, or more in the mixture. The anti-settling component may be present in an amount of at most about 90 vol %, 85 vol %, 80 vol %, 75 vol %, 70 vol %, 65 vol %, 60 vol %, 55 vol %, 50 vol %, 45 vol %, 40 vol %, 35 vol %, 30 vol %, 25 vol %, 20 vol %, or less in the mixture.

Examples of the anti-settling component include, but are not limited to, one or more additional particles and a thixotropic additive. The one or more additional particles may be configured to prevent settling of the plurality of particles in the mixture. The one or more additional particles may decrease free space and increase the overall packing density within the mixture, thereby preventing the plurality of particles from settling towards the window during printing. Examples of the one or more additional particles include micronized and/or dispersed waxes such as paraffin, carnuba, montan, Fischer tropsch wax, ethylene bis stearamide, and lignin; micronized polymers such as cellulose, high density polyethylene, polyethylene, polypropylene, oxidized polyethylene (PE), paraformaldehyde, polyethylene glycol, phenolics, and melamine-formaldehyde based materials; and microspheres made from crosslinked polystyrene, polymethyl methacrylate, and/or other copolymers. An example of the one or more additional particles is Byk Ceraflour 929 (micronized, modified polyethylene wax).

The thixotropic additive may be a gel-like or static material that becomes fluid-like when physically disturbed. Such property may be reversible. In the mixture, the thixotropic additive may be configured to create a network to prevent settling of the plurality of particles. The network of the thixotropic additive may be easily disturbed by shearing (e.g., dispensing through the nozzle) the mixture to allow flow. Upon being dispensed through the nozzle, the thixotropic additive may form another network within the mixture to prevent settling of the plurality of particles during printing. Examples of the thixotropic additive include castor wax, oxidized polyethylene wax, amide wax, modified ureas, castor oil derivatives, fumed silica and alumina, Bentonite clays, and mixtures thereof.

The anti-settling component of the mixture may be the one or more additional particles, the thixotropic additive, or both.

The mixture may comprise at least one additional additive that is configured to prevent foaming (or induce deaeration) of the mixture. Preventing foaming of the mixture may improve quality of the resulting 3D object. The at least one additional additive may be an amphiphilic material. The at least one additional additive may be a low surface energy material to allow association with each other within the mixture. Such association of the at least one additional additive may trap air bubbles present inside the mixture, migrate towards the mixture-air interface, and release the air bubbles. During curing of the photoactive resin, the at least one additional additive may polymerize and/or cross-link with the polymeric precursor. Examples of the one additional additive include silicones, modified silicones, lauryl acrylates, hydrophobic silicas, and modified ureas. An example of the one additional additive may be Evonik Tegorad 2500 (silicon acrylate).

The mixture may comprise an extractable material. The extractable material may be soluble in the polymeric precursor and/or dispersed throughout the mixture. During printing, curing of the polymeric precursor of the photoactive resin of the at least the portion of the mixture may create a first solid phase comprising the polymeric material and a second solid phase comprising the extractable material within the at least the portion of the 3D object. Such process may be a polymerization-induced phase separation (PIPS) process. At least a portion of the plurality of particles may be encapsulated by the first solid phase comprising the polymeric material. In some examples, the at least the portion of the 3D object may be a green body that can be heated to sinter at least a portion of the plurality of particles and burn off at least a portion of other components (i.e., organic components).

Prior to sintering the plurality of particles, the green body may be treated (e.g., immersed, jetted, etc.) with a solvent (liquid or vapor) to generate a brown body. The solvent may be an extraction solvent. The extractable material may be soluble in the solvent. A first solubility of the extractable material in the solvent may be higher than a second solubility of the polymeric material in the solvent. The solvent may be a poor solvent for the polymeric material. Thus, treating the green body with the solvent may solubilize and extract at least a portion of the extractable material out of the green body into the solvent, and create one or more pores in the at least the portion of the 3D object. The one or more pores may be a plurality of pores. In some examples, the green body may be treated with the solvent and heat at the same time. The one or more pores may create at least one continuous porous network in the at least the portion of the 3D object. Such process may be a solvent de-binding process.

The mixture may be stored in the source of the mixture. The source of the mixture may be a cup, container, syringe, or any other repository that can hold the mixture. The source of the mixture may in fluid communication (e.g., via a passageway) with the nozzle in the deposition head. The source of the mixture may be connected to a flow unit. The flow unit may provide and control flow of the mixture from the source of the mixture towards the nozzle, thereby dispensing the mixture. Alternatively or in addition to, the flow unit may provide and control flow of the mixture in a direction away from the nozzle and towards the source of the mixture, thereby retrieving the mixture. The flow unit may use pressure mechanisms to control the speed and direction of the flow of the mixture. The flow unit may be a syringe pump, vacuum pump, an actuator (e.g., linear, pneumatic, hydraulic, etc.), a compressor, or any other suitable device to exert pressure (positive or negative) to the mixture in the source of the mixture. The controller may be operatively coupled to the flow unit the control the speed, duration, and/or direction of the flow of the mixture.

The source of the mixture may comprise a sensor (e.g., an optical sensor) to detect the volume of the mixture. The controller may be operatively coupled to the sensor to determine when the source of the mixture may be replenished with new mixture. Alternatively or in addition to, the source of the mixture may be removable. The controller may determine when the source of the mixture may be replaced with a new source of the mixture comprising with the mixture.

The deposition head may comprise the nozzle. The nozzle may be in fluid communication with the source of the mixture. The deposition head may dispense the mixture over the print surface through the nozzle as a process of depositing the film of the mixture over the print surface. The deposition head may retrieve any excess mixture from the print surface back into the source of the mixture through the nozzle. The source of the mixture may be connected to the flow unit to provide and control flow of the mixture towards or away from the nozzle of the deposition head. Alternatively or in addition to, the nozzle may comprise a nozzle flow unit that provides and controls flow of the mixture towards or away from the print surface. Examples of the nozzle flow unit include a piezoelectric actuator and an auger screw that is connected to an actuator.

The deposition head may comprise a wiper. The wiper may be movable along a direction towards and/or away from the print surface. The wiper may have a variable height relative to the print surface. The deposition head may comprise an actuator connected to the wiper to control movement of the wiper in a direction towards and away from the print surface. The actuator may be a mechanical, hydraulic, pneumatic, or electro-mechanical actuator. The controller may be operatively coupled to the actuator to control the movement of the wiper in a direction towards and away from the print surface. Alternatively or in addition to, a vertical distance between the wiper and the print surface (e.g., a distance perpendicular to the print surface) may be static. The deposition head may comprise a plurality of wipers with different configurations. In some examples, the deposition head may comprise the nozzle and three wipers.

The wiper of the deposition head may be configured to (i) reduce or inhibit flow of the mixture out of the deposition head, (ii) flatten the film of the mixture, and/or (iii) remove any excess of the mixture. In an example, the wiper may be configured to be in contact with the print surface and reduce or inhibit flow of the mixture out of the deposition head. In another example, the wiper may be movable along a direction away from the print surface and configured to flatten the film of the mixture. The wiper may flatten the film of the mixture to a defined height (or thickness). In a different example, the wiper may be movable along a direction away from the print surface and configured to remove the excess of the mixture.

The wiper may comprise polymer (e.g., rubber, silicone), metal, or ceramic. The wiper may comprise (e.g., entirely or as a coating) one or more fluoropolymers that prevent adhesion of the mixture on the wiper. Examples of the one or more fluoropolymers include polyvinylidene fluoride (PVDF), ethylenchlorotrifluoroethylene (ECTFE), ethylenetetrafluoroethylene (ETFE), polytetrafluoroethylene (PTFE), perfluoroalkoxy (PFA), and modified fluoroalkoxy (a copolymer of tetrafluoroethylene and perfluoromethylvinylether, also known as MFA).

The wiper of the deposition head may be a blade (e.g., a squeegee blade, a doctor blade). The blade may have various shapes. In some examples, the blade may be straight and/or curved. In some examples, the wiper may be a straight blade with a flat surface. In some examples, the wiper may be a straight blade with a curved surface. In some examples, the wiper may be a curved blade (curved along the long axis of the wiper) with a flat surface. In some examples, the wiper may be a curved blade (curved along the long axis of the wiper) with a curved surface. In some examples, the wiper may comprise at least one straight portion and at least one curved portion along its length. In an example, the wiper may be a blade comprising a straight central portion between two curved portions.

In an example, the wiper may be a straight blade and configured perpendicular to the print surface. In another example, the wiper may be a straight blade with a flat surface, and tilted at an angle. When the deposition head moves to remove any excess mixture from the print surface, the tilted straight blade may concentrate the excess resin at the bottom of the blade. The straight blade may be tilted at an angle ranging between about 1 degree to about 50 degrees. The straight blade may be tilted at an angle of at least about 1 degree, 2 degrees, 3 degrees, 4 degrees, 5 degrees, 6 degrees, 7 degrees, 8 degrees, 9 degrees, 10 degrees, 20 degrees, 30 degrees, 40 degrees, 50 degrees, or more. The straight blade may be tiled at an angle of at most about 50 degrees, 40 degrees, 30 degrees, 20 degrees, 10 degrees, 9 degrees, 8 degrees, 7 degrees, 6 degrees, 5 degrees, 4 degrees, 3 degrees, 2 degrees, 1 degree, or less.

In a different example, the wiper may be a straight blade with a curved surface (a curved blade). When the deposition head moves to remove any excess mixture from the print surface, the curved blade may concentrate the excess resin in the center of the concave surface of the wiper. The curved blade may reduce or prevent the excess resin from spilling out from the sides of the blade. A radius of curvature of the surface of the blade may range between about 10 mm to about 1000 mm. The radius of curvature of the surface of the blade may be at least about 10 mm, 20 mm, 30 mm, 40 mm, 50 mm, 60 mm, 70 mm, 80 mm, 90 mm, 100 mm, 200 mm, 300 mm, 400 mm, 500 mm, 1000 mm, or more. The radius of curvature of the surface of the blade may be at most about 1000 mm, 500 mm, 400 mm, 300 mm, 200 mm, 100 mm, 90 mm, 80 mm, 70 mm, 60 mm, 50 mm, 40 mm, 30 mm, 20 mm, 10 mm, or less.

The wiper of the deposition head may be a roller. The roller may have a surface that is flat or textured. The roller may be configured to rotate clockwise and/or counterclockwise while the deposition head moves across the print window. Alternatively or in addition to, the roller may be configured to be static while the deposition head moves across the print window. The wiper of the deposition head may be a rod. The rod may have a surface that is flat or textured. The rod may be configured to rotate clockwise and/or counterclockwise while the deposition head moves across the print window. Alternatively or in addition to, the rod may be configured to be static while the deposition head moves across the print window. In an example, the rod may be a wire wound rod, also known as a Meyer rod.

The deposition head may comprise a slot die. The slot die may be configured to move along a direction away from the print surface. The slot die may be height adjustable with respect to the print surface. The slot die may comprise a channel in fluid communication with the source of the mixture. The channel may comprise a first opening to receive the mixture from the source of the mixture. The channel may comprise a second opening opposite of the first opening to dispense the mixture to the print window. The second opening may be an injection point. The channel may have a reservoir between the first and second openings to hold a volume of the mixture. The injection point of the slot die may comprise a flat surface to flatten the film of the mixture to a defined height (or thickness).

The deposition head comprising the slot die may include a separate nozzle to suction and retrieve any excess mixture from the film of the mixture during printing. The separate nozzle of the deposition head comprising the slot die may be in fluid communication with a repository to collect the excess mixture. The repository may be a recycling bin. The repository may also be in fluid communication with the slot die to send the excess mixture collected in the repository back into the reservoir of the slot die. Alternatively or in addition to, the collected excess mixture may be removed for reprocessing. The reprocessing of the collected excess mixture may comprise (i) filtering out any polymerized solid particulates, (ii) filtering out any of the plurality of particles that may be greater than a target particle size, (iii) remixing the mixture to ensure homogeneity, and/or (iv) removing at least a portion of air entrapped in the mixture. The at least the portion of air entrapped in the mixture may be removed by centrifuging the mixture. The slot die may be part of a nozzle. Alternatively or in addition to, the slot die may be part of a wiper.

The system may further comprise an additional deposition head comprising an additional nozzle. The additional nozzle of the additional deposition head may be in fluid communication with an additional source of an additional mixture. In some examples, the nozzle of the deposition head of the system may be in fluid communication with the source of the mixture and the additional source of the additional mixture. Alternatively or in addition to, the deposition head may comprise a first nozzle in fluid communication with the source of the mixture, and (b) a second nozzle in fluid communication with the additional source of the additional mixture. The presence of the additional source of the additional mixture may allow printing at least a portion of a 3D object comprising multiple materials (multi-materials) in different layers and/or in different portions within the same layer.

The mixture and the additional mixture may be the same. As an alternative, the mixture and the additional mixture may be different. The mixture and the additional mixture may comprise different types of the photoactive resin, the plurality of particles, or both. Alternatively or in addition to, the mixture and the additional mixture may comprise different amounts (concentrations by weight or volume) of the photoactive resin, the plurality of particles, or both. In an example, the mixture may comprise metallic particles, and the additional mixture may comprise ceramic particles. A first concentration of the metallic particles in the mixture and a second concentration of the ceramic particles in the additional mixture may be the same or different. A first photoactive resin in the mixture and a second photoactive resin in the additional mixture may be the same or different. In another example, the mixture may comprise a first type of metallic particles, and the additional mixture may comprise a second type of metallic particles. In a different example, the mixture may comprise ceramic particles at a first concentration, and the additional mixture may comprise the same ceramic particles at a second concentration that is different from the first concentration.

Upon printing at least a portion of the 3D object, the deposition head may be configured to move across the print surface and remove any excess mixture from the print surface. The deposition head may be configured to collect the excess mixture. The deposition head may be configured to collect the excess mixture to a designated area of the platform. The deposition head may be configured to collect the excess mixture within the deposition head. At least a portion of the collected excess mixture may be used to deposit a subsequent layer or film of the mixture by the deposition head.

The system may comprise a cleaning zone. The cleaning zone may be configured adjacent to the platform. The cleaning zone may be configured in a path of movement of the deposition head across the platform. The cleaning zone may be configured to clean the deposition head. Cleaning the deposition head may (i) improve reliability and reproducibility of printing at least the portion of the 3D object, and (ii) reduce wear and tear of the deposition head. The deposition head may be static or move relative to the cleaning zone while the cleaning zone cleans the deposition head. The cleaning zone may comprise a wiper, a nozzle configured to provide at least one cleaning solvent, or both. The wiper of the cleaning zone may be a blade (e.g., a doctor blade), a roller, or a rod. One or more wipers of the cleaning zone may come in contact with one or more wipers of the deposition head and remove any excess resin remaining on the one or more wipers of the deposition head. The one or more nozzles of the cleaning zone may dispense or jet the at least one cleaning solvent to the one or more wipers of the deposition head for cleaning. The one or more nozzles of the cleaning zone may be in fluid communication with at least one source of the at least one cleaning solvent. At least a portion of the mixture may be soluble in the at least one cleaning solvent. The cleaning zone may comprise a repository that can hold the excess mixture that is removed from the deposition head and/or the at least one cleaning solvent.

The system may comprise a repository (e.g., vat or container) adjacent to the platform. The repository may be configured to collect the mixture removed from the platform (e.g., from the print surface). The repository may be configured to hold any excess mixture that is removed from the print surface by the deposition head. After removing any excess mixture from the print surface, the deposition head may move and use at least one wiper to collect the excess mixture into the repository. The repository may be a recycling bin. The repository may be in fluid communication with the source of the mixture to recycle the collected excess mixture for printing. Alternatively or in addition to, the collected excess mixture may be removed for reprocessing. The system may comprise a sensor for detecting or determining one or more qualities of the mixture or a layer of the mixture deposited on the print surface. The sensor may be configured to move across the print surface and/or measure a thickness of at least a portion of the film of the mixture. The sensor may assess integrity of the film of the mixture before inducing polymerization of the polymeric precursors in the photoactive resin in the film of the mixture. The sensor may detect any variation in thickness across the film of the mixture. The sensor may detect any irregularities (e.g., defects, empty spots, solid particles, etc.) in the film of the mixture. The sensor may be configured to perform quality control after printing at least a portion (e.g., a layer) of the 3D object. The sensor may scan a remaining portion of the film (i.e., “silhouette”) of the mixture after printing, and the controller that is operatively coupled to the sensor may determine if the previous printing process was successful or not. In some examples, the sensor may be an optical profilometer (e.g., an in-line profilometer), densitometer, or computer vision.

The system may comprise a motion stage adjacent to the open platform. The motion stage may be coupled to the deposition head and configured to direct movement of the deposition head across the open platform. In addition, the motion stage may be coupled to one or more other components of the system that move across the platform (e.g., an additional deposition head, a sensor, etc.). The motion stage may be connected to an actuator that is configured to direct movement of the motion stage. The actuator may be a mechanical, hydraulic, pneumatic, electro-mechanical, or magnetic actuator. The controller may be operatively coupled to the actuator to control movement of the motion stage. Alternatively or in addition to, the system may comprise an additional motion stage coupled to the open platform to direct movement of the open platform relative to other components of the system.

The system may comprise the optical source that provides the light through the print window for curing the at least the portion of the film of the mixture. The light of the optical source may comprise a first wavelength for curing the photoactive resin in a first portion of the film of the mixture. The first wavelength may activate the at least one photoinitiator of the photoactive resin, thereby initiating curing of the polymeric precursors into the polymeric material. The light may be a photoinitiation light, and the first portion of the film may be a photoinitiation layer. The optical source may provide an additional light having a second wavelength for inhibiting curing of the photoactive resin in a second portion of the film of the mixture. The first wavelength and the second wavelength may be different. The second wavelength may activate the at least one photoinhibitor of the photoactive resin, thereby inhibiting curing of the polymeric precursors into the polymeric material. The additional light may be a photoinhibition light, and the second portion of the film of the mixture may be a photoinhibition layer. In some examples, a dual-wavelength projector (e.g., a dual-wavelength laser) may be used as the optical source that provides both the photoinitiation light and the photoinhibition light.

The light of the optical source may comprise a first wavelength for curing the photoactive resin in a first portion of the film of the mixture. The first wavelength may activate the at least one photoinitiator of the photoactive resin, thereby initiating curing of the polymeric precursors into the polymeric material. The light may be a photoinitiation light, and the first portion of the film may be a photoinitiation layer. The light may be a patterned light. The system may further comprise an additional optical source comprising an additional light having a second wavelength for inhibiting curing of the photoactive resin in a second portion of the film of the mixture. The first wavelength and the second wavelength may be different. The second wavelength may activate the at least one photoinhibitor of the photoactive resin, thereby inhibiting curing of the polymeric precursors into the polymeric material. The additional light may be a photoinhibition light, and the second portion of the film of the mixture may be a photoinhibition layer. The additional light may be a flood light.

The optical source that directs the photoinitiation light may be a mask-based display, such as a liquid crystal display (LCD) device, or light emitting, such as a discrete LED array device. Alternatively, the optical source that directs the photoinitiation light may be a DLP device, including a digital micro-mirror device (DMD) for producing patterned light that can selectively illuminate and cure 3D printed structures. The initiation light directed from the DLP device may pass through one or more projection optics (e.g., a light projection lens) prior to illuminating through the print window and to the film of the mixture. The one or more projection optics may be integrated in the DLP device. Alternatively or in addition to, the one or more projection optics or may be configured between the DLP device and the print window. A relative position of the one or more projection optics relative to the DLP device and the print window may be adjustable to adjust an area of the photoinitiation layer in the film of the mixture. The area of the photoinitiation layer may be defined as a build area. In some examples, the one or more projection optics may be on a projection optics platform. The projection optics platform may be coupled to an actuator that directs movement of the projection optics platform. The controller may be operatively coupled to the actuator to control movement of the projection optics platform. The controller may direct the actuator (e.g., a screw-based mechanism) to adjust a relative position of the one or more projection optics to the DLP device and the print window during printing the 3D object.

The additional optical source that directs the photoinhibition light may comprise a plurality of light devices (e.g., a plurality of light emitting diodes (LEDs)). The light devices may be on a light platform. The light platform may be configured (i) move relative to the print window and (ii) yield a uniform projection of the photoinhibition light within the photoinhibition layer in the film of the mixture adjacent to the print window. In some examples, the position of the light platform may be independently adjustable with respect to a position of the optical source that directs the photoinitiation light. The light platform comprising the plurality of light devices may be arranged with respect to the print window such that a peak intensity of each of the plurality of light devices is directed at a different respective position (e.g., corner or other position) of the build area. In an example, the build area may have four corners and a separate beam of light (e.g., a separate LED) may be directed to each corner of the build area. The beams of photoinhibition light from the plurality of light devices may overlap to provide the uniform projection of the photoinhibition light within the photoinhibition layer. The light platform may be coupled to an actuator that directs movement of the light platform. The controller may be operatively coupled to the actuator to control movement of the light platform. The controller may direct the actuator (e.g., a screw-based mechanism) to adjust a relative position of the plurality of light devices to the print window during printing the 3D object. In some examples, the one or more projection optics to the DLP device (for the photoinitiation light) may be on the light platform.

Whether using one optical source or two optical sources, the photoinhibition light may be configured to create the photoinhibition layer in the film of the mixture adjacent to the print window. The photoinhibition light may be configured to form the photoinhibition layer in the film of the mixture adjacent to the transparent film that is covering the print window. Furthermore, the photoinitiation light may be configured to cure the photoactive resin in the photoinitiation layer that resides between the photoinhibition layer and the build head. The photoactive resin in the photoinitiation layer may be cured into at least a portion of the 3D structure. The photoinitiation light may be configured to cure the photoactive resin in the photoinitiation layer that resides between the photoinhibition layer and the at least the portion of the 3D structure adjacent to the build head.

A thickness of the photoinitiation layer, the photoinhibition layer, or both may be adjusted by adjusting an intensity and duration of the photoinitiation light, the photoinhibition light, or both. The thickness of the photoinitiation layer, the photoinhibition layer, or both may be adjusted to adjust the thickness of the printed layer of the at least the portion of the 3D object. Alternatively or in addition to, the thickness of the photoinitiation layer, the photoinhibition layer, or both may be adjusted by adjusting the speed at which the build head moves away in a direction away from the print window.

The system may comprise the controller to control various parts (e.g., actuators, sensors, etc.) of different components of the 3D printing system, as described elsewhere herein.

### Methods of Use

In an aspect, the present disclosure provides a method for printing a 3D object. The method may comprise providing a platform comprising an area configured to hold a mixture including a photoactive resin. The method may comprise providing an optical source in optical communication with the mixture. The optical source may provide light for curing the photoactive resin in at least a portion of the mixture to print at least a portion of the 3D object. The method may comprise providing a build head that supports the at least the portion of the 3D object during printing. The platform may comprise a coupling unit. The method may further comprise directing the coupling unit to couple to at least a portion of the build head to provide an alignment of the area of the platform relative to a surface of the build head while printing the at least the portion of the 3D object. The method for printing the 3D object may utilize one or more components of the system for printing the 3D object, as provided herein.

In another aspect, the present disclosure provides a method for printing a 3D object. The method may comprise providing a platform comprising an area configured to hold a mixture including a photoactive resin. The method may comprise providing an optical source in optical communication with the mixture. The optical source may provide light for curing the photoactive resin in at least a portion of the mixture to print at least a portion of the 3D object. The method may comprise providing a build head that supports the at least the portion of the 3D object during printing. The build head may comprise a coupling unit. The method may further comprise directing the coupling unit to couple to at least a portion of the platform to provide an alignment of the area of the platform relative to a surface of the build head while printing the at least the portion of the 3D object. The method for printing the 3D object may utilize one or more components of the system for printing the 3D object, as provided herein.

In another aspect, the present disclosure provides a method for printing a 3D object. The method may comprise providing a platform comprising an area comprising a mixture including a photoactive resin. The platform may comprise a first coupling unit. The method may comprise providing an optical source in optical communication with the mixture. The optical source may provide light for curing the photoactive resin in at least a portion of the mixture to print at least a portion of the 3D object. The method may comprise providing a build head that supports the at least the portion of the 3D object during printing. The build head may comprise a second coupling unit. The method may further comprise coupling the first coupling unit to the second coupling unit to provide an alignment of the area of the platform relative to a surface of the build head while printing the at least the portion of the 3D object. The method for printing the 3D object may utilize one or more components of the system for printing the 3D object, as provided herein.

The first coupling unit and/or the second coupling unit may comprise at least one releasable fastener configured to promote the coupling of the first coupling unit and the second coupling unit. In some examples, the at least one fastener may comprise at least one magnet. The method may further comprise (i) activating the fastener to promote the coupling of the first and second coupling units, and (ii) deactivating the fastener to disconnect the coupling of the coupling of the first and second coupling units.

The method may further comprise directing the optical source to provide the light to the mixture to cure the photoactive resin in the at least the portion of the mixture.

The method may further comprise directing the build head and/or the platform to undergo motion towards or away from one another along an axis. The build head may be directed to move along the axis while the platform is stationary along the axis, or the platform may be directed to move along the axis while the build head is stationary along the axis. As an alternative, both the build head and the platform may be directed to move along the axis toward or away from one another.

The method may further comprise (i) directing the build head and/or the platform to undergo motion towards one another along the axis and (ii) coupling the first coupling unit to the second coupling unit. The method may further comprise directing the build head and/or the platform to undergo motion towards one another along the axis until the coupling of the first coupling unit and the second coupling unit. The method may further comprise (i) disconnecting the coupling of the first coupling unit and the second coupling unit, and (ii) directing the build head and/or the platform to undergo motion away from one another along the axis.

The method may further comprise directing the area to move relative to the platform along an additional axis. The area may comprise a print surface. In some examples, the print surface may comprise a print window of the platform, which print window may be configured to configured to hold a mixture or a layer of the mixture. Alternatively or in addition to, the print surface may comprise a film configured to hold a mixture or a layer of the mixture. The film may be disposed on or adjacent to the print window. Alternatively or in addition to, the film may not be disposed on or adjacent to the print window. The axis and the additional axis may be the same. The axis and the additional axis may be different. In some examples, the axis and the additional axis may be perpendicular to one another.

The first coupling unit may be part of the area. As an alternative, the first coupling unit and the area may be different.

The first coupling unit may protrude from a surface of the platform. The method may further comprise protruding at least a portion of the first coupling unit from the surface of the platform. The area and the surface of the platform may be parallel to one another. In some examples, the area and the surface of the platform may be on the same plane. The method may further comprise protruding the first coupling unit from the surface of the platform by an adjustable height. The first coupling unit may comprise an actuator to control the adjustable height. The method may further comprise directing an actuator coupled to the first coupling unit to control the adjustable height of the first coupling unit.

The second coupling unit may protrude from the surface of the build head. The method may further comprise protruding at least a portion of the second coupling unit from the surface of the build head. The second coupling unit may protrude from the surface of the build head by an adjustable height. The second coupling unit may comprise an actuator to control the adjustable height. The method may further comprise directing the actuator to control the adjustable height of the second coupling unit.

The alignment between the area of the platform relative to the surface of the build head may form a film of the mixture between the area of the platform and the surface of the build head. The film of the mixture may have a thickness. The thickness of the film of the mixture may be the same as the alignment gap between the area of the platform and the surface of the build head. As an alternative, the thickness of the film of the mixture may be the same as the alignment gap between the area of the platform and an outermost surface of an object (e.g., a previously printed portion of the 3D object) disposed on the surface of the build head.

The coupling of the first coupling unit and the second coupling unit comprises a kinematic coupling. The method may further comprise generating a kinetic coupling between the first and second coupling units.

The method may further comprise directing a sensor to detect the coupling of the first coupling unit and second coupling unit. The method may further comprise directing the build head and/or the platform to undergo motion towards one another along an axis until the sensor detects the coupling of the first coupling unit and second coupling unit. In some examples, the sensor may be a camera. The sensor may be part of the first coupling unit and/or the second coupling unit. In some examples, the sensor may be a pressure sensor configured to detect a pressure between the first coupling unit and the second coupling unit. In some examples, the sensor may be an electrical current sensor configured to detect an electrical current between the first coupling unit and the second coupling unit. In some examples, the sensor may be a magnetic field sensor configured to detect a magnetic field between the first coupling unit and the second coupling unit.

The method may further comprise directing a deposition head (e.g., at least 1, 2, 3, 4, 5, or more deposition heads; at most 5, 4, 3, 2, or 1 deposition head(s)) to move across the area and deposit the mixture over the area. The method may further comprise directing the deposition head to move across the film and deposit the mixture or a layer of mixture over the film. The film may be coupled to a film transfer unit. The film transfer unit may be configured to direct movement of the film over the platform (e.g., between a mixture deposition zone and a printing zone, between a first mixture deposition zone to a second mixture deposition zone, between a first printing zone and a second printing zone, between a printing zone and a post-processing zone, between a printing zone and a wash zone, between a printing zone and a sintering zone, etc.).

The area of the platform may be part of a vat configured to hold the mixture. The vat may comprise a print surface (e.g., the print window, the film configured to hold the mixture, etc.). The method may further comprise directing the optical source to provide the light through the print surface (e.g., print window) to the mixture. Alternatively or in addition to, the method may further comprise directing the optical source to provide the light to the mixture from one or more sides and/or above the mixture.

The area of the platform may be part of an open substrate configured to hold a film or layer of the mixture. The open substrate may be a film configured to hold the mixture. In some examples, the open substrate may not have any sidewall that contacts the film of the mixture during the mixture depositing and/or 3D printing process. The open substrate comprises a print window, and the method may further comprise directing the optical source to provide the light through the print window and to the mixture. As an alternative, the open substrate may or may not comprise the print window, and the method may further comprise directing the optical source to provide the light to the mixture from one or more sides and/or above the mixture.

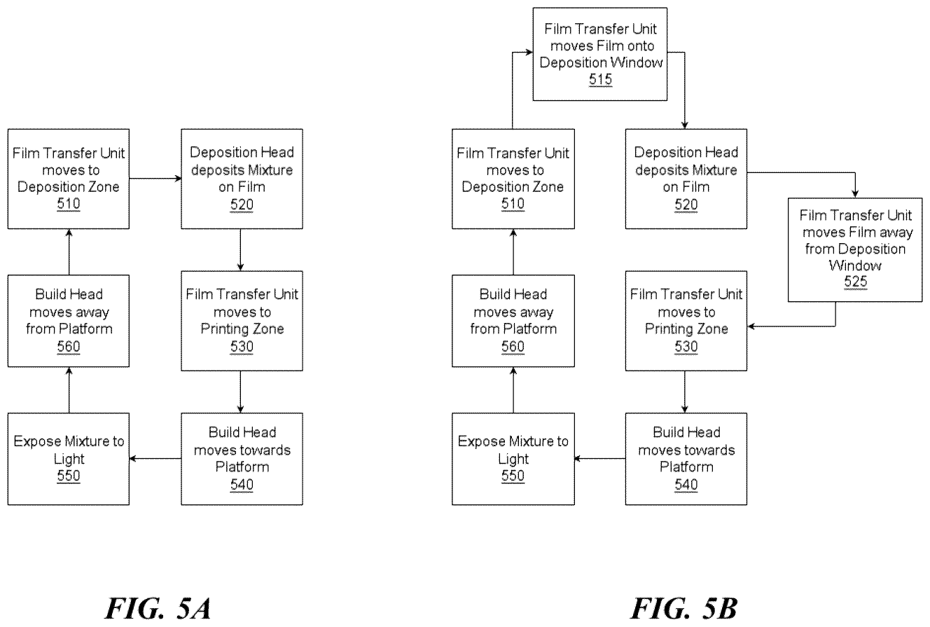

The mixture may further comprise one or more particles. The one or more particles may comprise at least one metal particle, at least one ceramic particle, or combinations thereof. FIG. 5 shows example flow charts of methods for printing a 3D object. Referring to FIG. 5A, the film transfer unit (e.g., the film transfer unit 172 as shown in FIG. 4) moves to a deposition zone of a 3D printing system (process 510). The film transfer unit may move across a platform of the 3D printing system to move to the deposition zone. Following, a deposition head of the 3D printing system deposits a mixture on a film coupled to the film transfer unit (process 520). Following, the film transfer unit moves (e.g., moves across the platform) to a printing zone of the 3D printing system (process 530). Following, a build head moves (e.g., downwards) towards the film of the film transfer unit, which film is holding the mixture or a layer of the mixture (process 540). The build head may move in a relative direction towards the platform, thereby to move relatively towards the film. Following, one or more optical sources may direct one or more lights to expose the mixture to one or more lights (process 550). The film of the film transfer unit may be (i) transparent or semi-transparent, and (ii) disposed on or adjacent to a print window that is transparent or semi-transparent (e.g., the print window 103 as shown in FIG. 4). In such a case, the one or more lights may be directed through the print window and through film of the film transfer unit to expose the mixture to the one or more lights. Following, the build head moves in a relative direction away from the platform, thereby to move relatively away from the film (process 560). Subsequently, the processes 510-560 are repeated one or more times until printing the 3D object or at least a portion of the 3D object.

Referring to FIG. 5B, the film transfer unit (e.g., the film transfer unit 172 as shown in FIG. 4) moves to a deposition zone of a 3D printing system (process 510). The film transfer unit may move across a platform of the 3D printing system to move to the deposition zone. Following, the film transfer unit moves a film that is coupled to the film transfer unit onto a deposition window of the deposition zone (process 515). The film transfer unit may direct one or more actuators (e.g., the vertical actuator 442 shown in FIG. 4B) to move the film onto the deposition window. Such movement may be a relative movement, and thus the moving piece may be the film, the deposition window, and/or both. Following, a deposition head of the 3D printing system deposits a mixture on the film (process 520). Following, the film transfer unit moves (e.g., by using the vertical actuator 442 shown in FIG. 4B) the film in a relative direction away from the deposition window (process 525). Following, the film transfer unit moves (e.g., moves across the platform) to a printing zone of the 3D printing system (process 530). Following, a build head moves (e.g., downwards) towards the film of the film transfer unit, which film is holding the mixture or a layer of the mixture (process 540). The build head may move in a relative direction towards the platform, thereby to move relatively towards the film. Following, one or more optical sources may direct one or more lights to expose the mixture to one or more lights (process 550). The film of the film transfer unit may be (i) transparent or semi-transparent, and (ii) disposed on or adjacent to a deposition area that is transparent or semi-transparent (e.g., the print window 103 as shown in FIG. 4). In such a case, the one or more lights may be directed through the deposition area and through film of the film transfer unit to expose the mixture to the one or more lights. Following, the build head moves in a relative direction away from the platform, thereby to move relatively away from the film (process 560). Subsequently, the processes 510-560 are repeated one or more times until printing the 3D object or at least a portion of the 3D object.

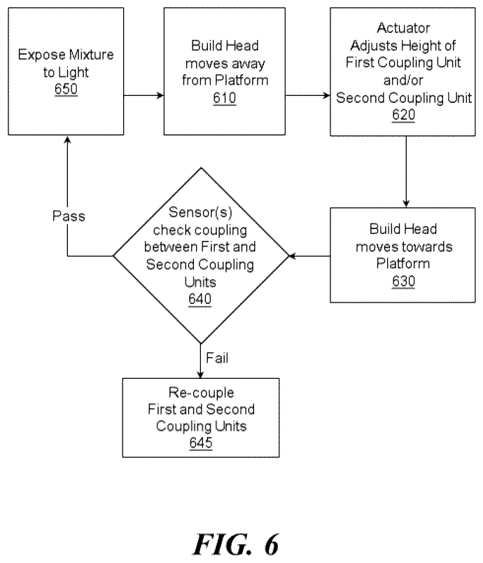

FIG. 6 shows an example flowchart of another method of printing a 3D object by using a system for printing the 3D object. The system comprises a platform comprising a first coupling unit. A mixture for printing the 3D object may be disposed on or adjacent to the platform (or a film disposed on adjacent to the platform). The system comprises a build head comprising a second coupling unit. The build head may be configured to hold at least a portion of the printed 3D object. During the 3D printing, the build head moves in a relative direction away from a platform (process 610). Following, one or more actuators adjusts the height of (i) the first coupling unit of the platform relative to a surface of the platform, and/or (ii) the second coupling unit of the build head relative to a surface of the build head (process 620). The first coupling unit of the platform may be moved in a direction away from the surface of the platform by a distance corresponding to at least a portion of a thickness of a subsequent layer of the 3D object to be printed. Alternatively or in addition to, the second coupling unit of the build head may be moved in a direction away from the surface of the build head by a distance corresponding to the at least the portion of the thickness of the subsequent layer of the 3D object to be printed. Following, the build head moves in a relative direction towards the platform (process 630). Prior to, during, and/or subsequent to the moving of the build head towards the platform in process 630, one or more sensors, which are operatively coupled to the first coupling unit and/or the second coupling unit, check the coupling between the first and second coupling units (process 640). When the one or more sensors determine that the coupling between the first and second coupling units is insufficient (e.g., indicating a misalignment between the build head and the platform, thereby an uneven thickness of a film of the mixture disposed therebetween), the one or more sensors directs the system to re-couple the first and second coupling units (645). Re-coupling of the first and second coupling units may involve repeating the processes 610 through 640. Alternatively, when the one or more sensors determine that the coupling between the first and second coupling unit is sufficient, proper, or complete, the system directs one or more lights to the mixture to print at least a layer of the 3D object. Subsequently, the processes 610-650 (and optionally the process 645) are repeated one or more times until the 3D object or at least a portion of the 3D object is printed.

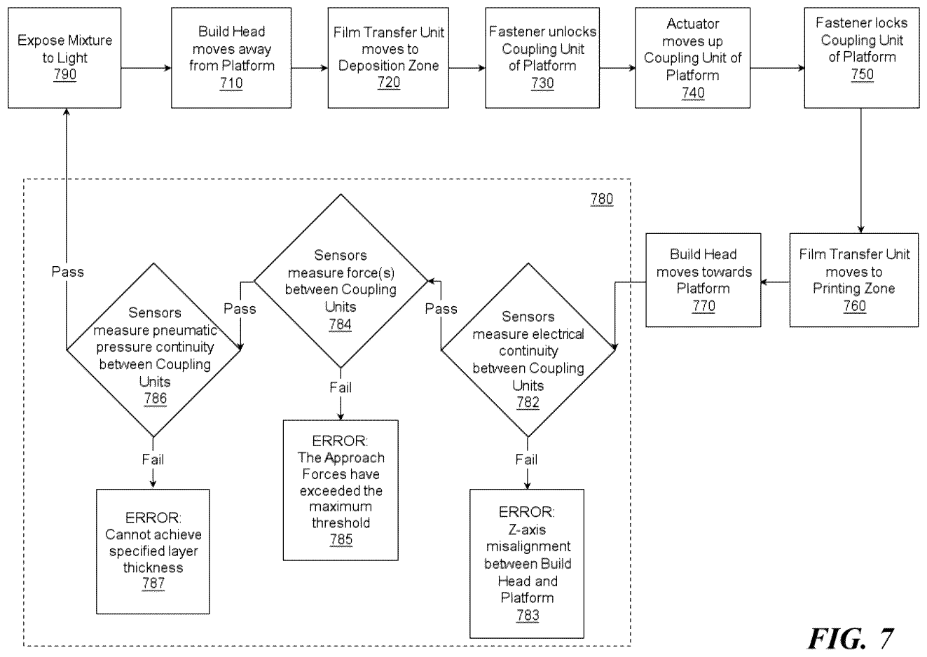

FIG. 7 shows an example flowchart of a different method of printing a 3D object by using a system for printing the 3D object. The system comprises a printing zone, which comprises a platform comprising a plurality of first coupling units. A mixture for printing the 3D object may be disposed on or adjacent to the platform (or a film disposed on adjacent to the platform). The printing zone further comprises a build head comprising a plurality of second coupling units. A number of the plurality of first coupling units and a number of the plurality of the second coupling units may be the same. The build head may be configured to hold at least a portion of the printed 3D object. The system further comprises a deposition zone, which comprises a deposition head configured to deposit the mixture (or a layer of the mixture) on the film. The system further comprises a film transfer unit that comprises the film configured to hold the mixture, and configured to move at least between the printing zone and the deposition zone. In the example shown in FIG. 7, the first coupling unit of the platform may have an adjustable height. In one or more alternatives, the coupling unit of the build head may have an adjustable height, or each of the first and second coupling units may have an adjustable height.

Referring to FIG. 7, during the 3D printing, the build head moves in a relative direction away from a platform (process 710). Following, the film transfer unit moves to the deposition zone (process 720). In some examples, the film transfer unit may already be in the deposition zone. Following, a fastener operatively coupled to each first coupling unit of the platform unlocks the each first coupling unit (process 730), thus allowing a height of the each first coupling unit relative to a surface of the platform to be adjustable. Following, an actuator operatively coupled to the each first coupling unit adjusts the height of the each first coupling unit of the platform relative to the surface of the platform (process 740). In some examples, the each first coupling unit may be moved in a direction away from the surface of the platform by a distance corresponding to at least a portion of a thickness of a subsequent layer of the 3D object to be printed. Following, the fasteners of the each first coupling unit of the platform locks the each first coupling unit (process 750), thus making the plurality of first coupling units stationary relative to the platform. Following, the film transfer unit moves to the printing zone (process 760). The film transfer unit may move across the platform to move to the printing zone. Following, the build head moves in a relative direction towards the platform (process 770). Prior to, during, and/or subsequent to the moving of the build head towards the platform in process 770, one or more sensors, which are operatively coupled to the each first coupling unit and/or each second coupling unit of the plurality of second coupling units, check the coupling between each pair of a first coupling unit and a second coupling unit (process 780).

Referring to FIG. 7, during the process 780, one or more sensors operatively coupled to each pair of the first and second coupling units measure electrical continuity between the each pair of the first and second coupling units (process 782). When an absence or signal of the electrical continuity below a predetermined threshold is measured, the one or more sensors generate an error signal indicating a misalignment between the build head and the platform (process 783). When an acceptable electrical continuity is measured, the one or more sensors proceed to measure a force (e.g., an approach force, a pressure, etc.) between the each pair of the first and second coupling units (process 784). When a force below and/or above a predetermined threshold range of the force is measured, the one or more sensors generate an error signal indicating an improper coupling force (e.g., an improper approach force) between at least one pair of the first and second coupling units. When an acceptable force is measured between all pairs of the first and second coupling units, the one or more sensors measures and compares pneumatic pressure continuity between the pairs of the first and second coupling units (process 786). In some examples, the system may comprise three pairs of the first and second coupling units, and the one or more sensors may measure and compare the pneumatic pressures among all three pairs of the first and second coupling units. When the pneumatic pressures among all three pairs of the first and second coupling units are not within a predetermined threshold range, the one or more sensors generate an error signal indicating an improper pneumatic pressure continuity, which may suggest an uneven layer thickness of the film of the mixture disposed between the build head and the platform. When an acceptable pneumatic pressure is measured, the system directs one or more lights to the mixture to print at least a layer of the 3D object (process 790). Subsequently, the processes 710-790 are repeated one or more times until the 3D object or at least a portion of the 3D object is printed.

Once the at least the portion of the 3D object is printed (herein referred to as a green body), the method may further comprise removing the green body from the build head. The green body may be separated from the build head by inserting a thin material (e.g. a steel blade) between the green body and the build head. In some examples, a first layer of the green body that is in contact with the build head may not comprise the plurality of particles for easy removal from the build head by the thin material. The method may further comprise washing the green body. The green body may be washed by jetting a solvent (e.g., isopropanol) to remove any excess polymeric precursor.

The method may further comprise subjecting the green body comprising at least the polymeric material to heating (e.g., in a furnace), to thereby heat at least the plurality of particles encapsulated in the at least the polymeric material. The heating may be under conditions sufficient to sinter the plurality of particles to form a final product that is at least a portion of a 3D object or an entire 3D object. During heating (e.g., sintering), the organic components (e.g., the polymeric material, additives, etc.) may decompose and leave the green body. At least a portion of the decomposed organic components may leave the green body in gas phase.

The green body may be heated in a processing chamber. The temperature of the processing temperature may be regulated with at least one heater. The processing chamber may be an oven or a furnace. The oven or furnace may be heated with various heating approaches, such as resistive heating, convective heating and/or radiative heating. Examples of the furnace include an induction furnace, electric arc furnace, gas-fired furnace, plasma arc furnace, microwave furnace, and electric resistance furnace. Such heating may be employed at a fixed or variating heating rate from an initial temperature to a target temperature or temperature range.

A green body comprising metallic and/or intermetallic particles may be heated from room temperature to a processing temperature. The processing temperature may be kept constant or substantially constant for a given period of time, or may be adjusted to one or more other temperatures. The processing temperature may be selected based on the material of the particles in the green body (e.g., the processing temperature may be higher for material having a higher melting point than other materials). The processing temperature may be sufficient to sinter but not completely melt the particles in the green body. As an alternative, the processing temperature may be sufficient to melt the particles in the green body.

The processing temperature for heating (e.g., sintering) the green body (including the metal and/or intermetallic particles) may range between about 300 degrees Celsius to about 2200 degrees Celsius. The processing temperature for sintering the green body may be at least about 300 degrees Celsius, 350 degrees Celsius, 400 degrees Celsius, 450 degrees Celsius, 500 degrees Celsius, 550 degrees Celsius, 600 degrees Celsius, 650 degrees Celsius, 700 degrees Celsius, 750 degrees Celsius, 800 degrees Celsius, 850 degrees Celsius, 900 degrees Celsius, 950 degrees Celsius, 1000 degrees Celsius, 1050 degrees Celsius, 1100 degrees Celsius, 1150 degrees Celsius, 1200 degrees Celsius, 1250 degrees Celsius, 1300 degrees Celsius, 1350 degrees Celsius, 1400 degrees Celsius, 1450 degrees Celsius, 1500 degrees Celsius, 1550 degrees Celsius, 1600 degrees Celsius, 1700 degrees Celsius, 1800 degrees Celsius, 1900 degrees Celsius, 2000 degrees Celsius, 2100 degrees Celsius, 2200 degrees Celsius, or more. The processing temperature for sintering the green body (including the particles) may be at most about 2200 degrees Celsius, 2100 degrees Celsius, 2000 degrees Celsius, 1900 degrees Celsius, 1800 degrees Celsius, 1700 degrees Celsius, 1600 degrees Celsius, 1550 degrees Celsius, 1500 degrees Celsius, 1450 degrees Celsius, 1400 degrees Celsius, 1350 degrees Celsius, 1300 degrees Celsius, 1250 degrees Celsius, 1200 degrees Celsius, 1150 degrees Celsius, 1100 degrees Celsius, 1050 degrees Celsius, 1000 degrees Celsius, 950 degrees Celsius, 900 degrees Celsius, 850 degrees Celsius, 800 degrees Celsius, 750 degrees Celsius, 700 degrees Celsius, 650 degrees Celsius, 600 degrees Celsius, 550 degrees Celsius, 500 degrees Celsius, 450 degrees Celsius, 400 degrees Celsius, 350 degrees Celsius, 300 degrees Celsius, or less.

In an example, a green body comprising aluminum particles may be heated from room temperature to a processing temperature ranging between about 350 degrees Celsius to about 700 degrees Celsius. In another example, a green body comprising copper particles may be heated from room temperature to a processing temperature of about 1000 degrees Celsius. In another example, a green body comprising stainless steel particles may be heated from room temperature to a processing temperature ranging between about 1200 degrees Celsius to about 1500 degrees Celsius. In another example, a green body comprising other tool steel particles may be heated from room temperature to a processing temperature of about 1250 degrees Celsius. In another example, a green body comprising tungsten heavy alloy particles may be heated from room temperature to a processing temperature of about 1500 degrees Celsius.

During sintering the green body comprising the metallic and/or intermetallic particles, the temperature of the processing chamber may change at a rate ranging between about 0.1 degrees Celsius per minute (degrees Celsius/min) to about 200 degrees Celsius/min. The temperature of the processing chamber may change at a rate of at least about 0.1 degrees Celsius/min, 0.2 degrees Celsius/min, 0.3 degrees Celsius/min, 0.4 degrees Celsius/min, 0.5 degrees Celsius/min, 1 degrees Celsius/min, 2 degrees Celsius/min, 3 degrees Celsius/min, 4 degrees Celsius/min, 5 degrees Celsius/min, 6 degrees Celsius/min, 7 degrees Celsius/min, 8 degrees Celsius/min, 9 degrees Celsius/min, 10 degrees Celsius/min, 20 degrees Celsius/min, 50 degrees Celsius/min, 100 degrees Celsius/min, 150 degrees Celsius/min, 200 degrees Celsius/min, or more. The temperature of the processing chamber may change at a rate of at most about 200 degrees Celsius/min, 150 degrees Celsius/min, 100 degrees Celsius/min, 50 degrees Celsius/min, 20 degrees Celsius/min, 10 degrees Celsius/min, 9 degrees Celsius/min, 8 degrees Celsius/min, 7 degrees Celsius/min, 6 degrees Celsius/min, 5 degrees Celsius/min, 4 degrees Celsius/min, 3 degrees Celsius/min, 2 degrees Celsius/min, 1 degrees Celsius/min, 0.5 degrees Celsius/min, 0.4 degrees Celsius/min, 0.3 degrees Celsius/min, 0.2 degrees Celsius/min, 0.1 degrees Celsius/min, or less.

During sintering the green body comprising the metallic and/or intermetallic particles, the process may comprise holding at a fixed temperature between room temperature and the processing temperature for a time ranging between about 1 min to about 240 min. The sintering process may comprise holding at a fixed temperature for at least about 10 min, 20 min, 30 min, 40 min, 50 min, 60 min, 90 min, 120 min, 150 min, 180 min, 210 min, 240 min, or more. The sintering process may comprise holding at a fixed temperature for at most about 240 min, 210 min, 180 min, 150 min, 120 min, 90 min, 60 min, 50 min, 40 min, 30 min, 20 min, 10 min, 1 min, or less. Alternatively or in addition to, during the sintering process, the temperature may not be held at a processing temperature for an extended period of time (e.g., once a target temperature is reached, the temperature may be reduced). In an example, the sintering process may increase the temperature to a first temperature and immediately (e.g., without holding at the first temperature for a period of time) lower the temperature to a second temperature that is lower than the first temperature.

A green body comprising ceramic particles may be heated from room temperature to a processing temperature ranging between about 900 degrees Celsius to about 2000 degrees Celsius. The processing temperature may be kept constant or substantially constant for a given period of time, or may be adjusted to one or more other temperatures. The processing temperature for sintering the green body (including the particles) may be at least about 900 degrees Celsius, 950 degrees Celsius, 1000 degrees Celsius, 1050 degrees Celsius, 1100 degrees Celsius, 1150 degrees Celsius, 1200 degrees Celsius, 1300 degrees Celsius, 1400 degrees Celsius, 1500 degrees Celsius, 1600 degrees Celsius, 1700 degrees Celsius, 1800 degrees Celsius, 1900 degrees Celsius, 2000 degrees Celsius, or more. The processing temperature for sintering the green body may be at most about 2000 degrees Celsius, 1900 degrees Celsius, 1800 degrees Celsius, 1700 degrees Celsius, 1600 degrees Celsius, 1500 degrees Celsius, 1400 degrees Celsius, 1300 degrees Celsius, 1200 degrees Celsius, 1150 degrees Celsius, 1100 degrees Celsius, 1050 degrees Celsius, 1000 degrees Celsius, 950 degrees Celsius, 900 degrees Celsius, or less.

In an example, a green body comprising alumina particles may be heated from room temperature to a processing temperature ranging between about 1500 degrees Celsius to about 1950 degrees Celsius. In an example, a green body comprising cemented carbide particles may be heated from room temperature to a processing temperature ranging between about 1700 degrees Celsius. In an example, a green body comprising zirconia particles may be heated from room temperature to a processing temperature ranging between about 1100 degrees Celsius.

During sintering the green body comprising the ceramic particles, the temperature of the processing chamber may change at a rate ranging between about 0.1 degrees Celsius per minute (degrees Celsius/min) to about 200 degrees Celsius/min. The temperature of the processing chamber may change at a rate of at least about 0.1 degrees Celsius/min, 0.2 degrees Celsius/min, 0.3 degrees Celsius/min, 0.4 degrees Celsius/min, 0.5 degrees Celsius/min, 1 degrees Celsius/min, 2 degrees Celsius/min, 3 degrees Celsius/min, 4 degrees Celsius/min, 5 degrees Celsius/min, 6 degrees Celsius/min, 7 degrees Celsius/min, 8 degrees Celsius/min, 9 degrees Celsius/min, 10 degrees Celsius/min, 20 degrees Celsius/min, 50 degrees Celsius/min, 100 degrees Celsius/min, 150 degrees Celsius/min, 200 degrees Celsius/min, or more. The temperature of the processing chamber may change at a rate of at most about 200 degrees Celsius/min, 150 degrees Celsius/min, 100 degrees Celsius/min, 50 degrees Celsius/min, 20 degrees Celsius/min, 10 degrees Celsius/min, 9 degrees Celsius/min, 8 degrees Celsius/min, 7 degrees Celsius/min, 6 degrees Celsius/min, 5 degrees Celsius/min, 4 degrees Celsius/min, 3 degrees Celsius/min, 2 degrees Celsius/min, 1 degrees Celsius/min, 0.5 degrees Celsius/min, 0.4 degrees Celsius/min, 0.3 degrees Celsius/min, 0.2 degrees Celsius/min, 0.1 degrees Celsius/min, or less.

During sintering the green body comprising the ceramic particles, the process may comprise holding at a fixed temperature between room temperature and the processing temperature for a time ranging between about 1 min to about 240 min. The sintering process may comprise holding at a fixed temperature for at least about 1 min, 10 min, 20 min, 30 min, 40 min, 50 min, 60 min, 90 min, 120 min, 150 min, 180 min, 210 min, 240 min, or more. The sintering process may comprise holding at a fixed temperature for at most about 240 min, 210 min, 180 min, 150 min, 120 min, 90 min, 60 min, 50 min, 40 min, 30 min, 20 min, 10 min, 1 min, or less. Alternatively or in addition to, during the sintering process, the temperature may not be held at a processing temperature for an extended period of time (e.g., once a target temperature is reached, the temperature may be reduced). In an example, the sintering process may increase the temperature to a first temperature and immediately (e.g., without holding at the first temperature for a period of time) lower the temperature to a second temperature that is lower than the first temperature.

During sintering the green body comprising the plurality of particles (e.g. metal, intermetallic, and/or ceramic), the green body may be subjected to cooling by a fluid (e.g., liquid or gas). The fluid may be applied to the green body and/or the processing chamber to decrease the temperature of the green body. The fluid may be subjected to flow upon application of positive or negative pressure. Examples of the fluid for cooling the green body include water, oil, hydrogen, nitrogen, argon, etc. Cooling the green body during the sintering process may control grain size within the sintered body.

The resin (e.g., the mixture) may further comprise an extractable material. Accordingly, the method may comprise additional processes of treating the green body prior to subjecting the green body to heating (e.g., sintering).

The extractable material may be soluble in the polymeric precursor and/or dispersed throughout the rein. Accordingly, the method may comprise curing the polymeric precursor of the resin in at least a portion of the resin, thereby creating a first solid phase comprising the polymeric material and a second solid phase comprising the extractable material within the at least the portion of the 3D object. Such method may be a polymerization-induced phase separation (PIPS) process. The plurality of particles (e.g., metallic, intermetallic, and/or ceramic particles) may be encapsulated by the first solid phase comprising the polymeric material. The at least the portion of the 3D object may be a green body that can undergo heating to sinter at least a portion of the plurality of particles and burn off at least a portion of other components (i.e., organic components).

The extractable material may be soluble in a solvent (e.g., isopropanol). The solvent may be an extraction solvent. A first solubility of the extractable material in the solvent may be higher than a second solubility of the polymeric material in the solvent. The solvent may be a poor solvent for the polymeric material. Accordingly, the method may further comprise (i) treating (e.g., immersed, jetted, etc.) the green body with the solvent (liquid or vapor), (ii) solubilizing and extracting at least a portion of the extractable material from the second solid phase of the green body into the solvent, and (iii) generating one or more pores in the green body. The one or more pores in the green body may be a plurality of pores. The method may further comprise treating the green body with the solvent and heat at the same time. The one or more pores may create at least one continuous porous network in the green body. Such process may be a solvent de-binding process.

The solvent for the solvent de-binding process may not significantly swell the polymeric material in the green body. The mixture may comprise acrylate-based polymeric precursors. Since acrylate-based polymers are of intermediate polarity, both protic polar solvents (e.g., water and many alcohols such as isopropanol) and non-polar solvents (e.g., heptane) may be used. Examples of the solvent for the solvent de-binding process include water, isopropanol, heptane, limolene, toluene, and palm oil. On the other hand, intermediate polarity solvents (e.g., acetone) may be avoided.

The solvent de-binding process may involve immersing the green body in a container comprising the liquid solvent. A volume of the solvent may be at least about 2 times the volume of the green body. The volume of the solvent may be at least about 2, 3, 4, 5, 6, 7, 8, 9, 10 times or more than the volume of the green body. The container comprising the liquid solvent and the green body may be heated to a temperature ranging between about 25 degrees Celsius to about 50 degrees Celsius. The container comprising the liquid solvent and the green body may be heated (e.g., a water bath, oven, or a heating unit from one or more sides of the green body) to a temperature of at least about 25 degrees Celsius, 26 degrees Celsius, 27 degrees Celsius, 28 degrees Celsius, 29 degrees Celsius, 30 degrees Celsius, 35 degrees Celsius, 40 degrees Celsius, 45 degrees Celsius, 50 degrees Celsius, or more. The container comprising the liquid solvent and the green body may be heated to a temperature of at most about 50 degrees Celsius, 45 degrees Celsius, 40 degrees Celsius, 35 degrees Celsius, 30 degrees Celsius, 29 degrees Celsius, 28 degrees Celsius, 27 degrees Celsius, 26 degrees Celsius, 25 degrees Celsius, or less. The solvent de-binding process may last between about 0.1 hours (h) to about 48 h. The solvent de-binding process may last between at least about 0.1 h, 0.2 h, 0.3 h, 0.4 h, 0.5 h, 1 h, 2 h, 3 h, 4 h, 5 h, 6 h, 12 h, 18 h, 24 h, 30 h, 36 h, 42 h, 48 h, or more. The solvent de-binding may last between at most about 48 h, 42 h, 36 h, 30 h, 24 h, 18 h, 12 h, 6 h, 5 h, 4 h, 3 h, 2 h, 1 h, 0.5 h, 0.4 h, 0.3 h, 0.2 h, 0.1 h, or less. After the solvent de-binding process, the solvent may be removed and the green body may be allowed to dry. A weight of the green body may be measured before and after the solvent de-binding to determine the amount of material extracted from the green body.

After the solvent de-binding process, the green body may be heated (e.g., sintered) and/or cooled as abovementioned. During heating (e.g., sintering), at least a portion of the organic components (e.g., the polymeric material, additives, etc.) may decompose and leave the green body in part through the at least one continuous porous network. The presence of the at least one continuous porous network from the solvent de-binding process may improve the speed of the sintering process.

The mixture may comprise one or more reactants (e.g., an oxidizer, fuel, solvent, etc.) for conducting as elf-propagating reaction in the green body to yield heat. The method may comprise, prior to the sintering process, using the one or more reactants to conduct the self-propagating reaction to generate the heat in the green part. The heat may be sufficient to de-bind or pre-sinter the green part to generate a brown body. In some examples, the method may further comprise supplying an external energy to the one or more reactants of the green body to initiate the self-propagating reaction to generate the heat. The external energy may be from one or more light sources (e.g., light emitting diodes, lasers, etc.) and/or one or more sources of thermal energy.

The one or more reactants may comprise an oxidizer, e.g., oxidizer is nitric acid, ammonium nitrate, a metal nitrate, a nitrate hydrate, a functional variant thereof, or a combination thereof. The one or more reactants may comprise a fuel, e.g., urea, glycine, sucrose, glucose, citric acid, carbohydrazide, oxalyldihydrazide, hexamethylenetetramine, acetylacetone, a functional variant thereof, or a combination thereof. The one or more reactants may comprise a solvent, e.g., water, kerosene, benzene, ethanol, methanol, furfuryl alcohol, 2-methoxyethanol, formaldehyde, a functional variant thereof, or a combination thereof.

The mixture may comprise (i) a binder configured to decompose at a first temperature, (ii) a polymeric precursor configured to form a polymeric material, wherein the polymeric material is configured to decompose at a second temperature that is greater than the first temperature, and (iii) a plurality of particles. The method may comprise providing such mixture (e.g., providing such mixture on or adjacent to the platform or print surface). The method may further comprise using the mixture to generate a green part corresponding to a 3D object, wherein the green part comprises the binder, the polymeric material, and he plurality of particles. The method may further comprise heating the green part at the first temperature to decompose at least a portion of the binder and generate one or more pores in the green part, which green part comprises the plurality of particles and the polymeric material. Subsequently, the method may further comprise heating the green part at or above the second temperature to decompose at least a portion of the polymeric material, thereby generating the 3D object comprising the plurality of particles. In some examples, heating the green part at the first temperature may not decompose the polymeric material. At least the portion of the binder may decompose into a gas (e.g., carbon monoxide, carbon dioxide, water, or formaldehyde). Examples of such binder may include poly(propylene carbonate) or paraformaldehyde. The first temperature may range from about 150 degrees Celsius to about 350 degrees Celsius. In some examples, the second temperature may be greater than or equal to about 400 degrees Celsius. In some examples, the second temperature may be greater than or equal to about 500 degrees Celsius.

Subsequent to the post-printing processes, the heated (e.g., sintered) particles as part of a nascent 3D object may be further processed to yield the 3D object. This may include, for example, performing surface treatment, such as polishing, on the nascent 3D object.

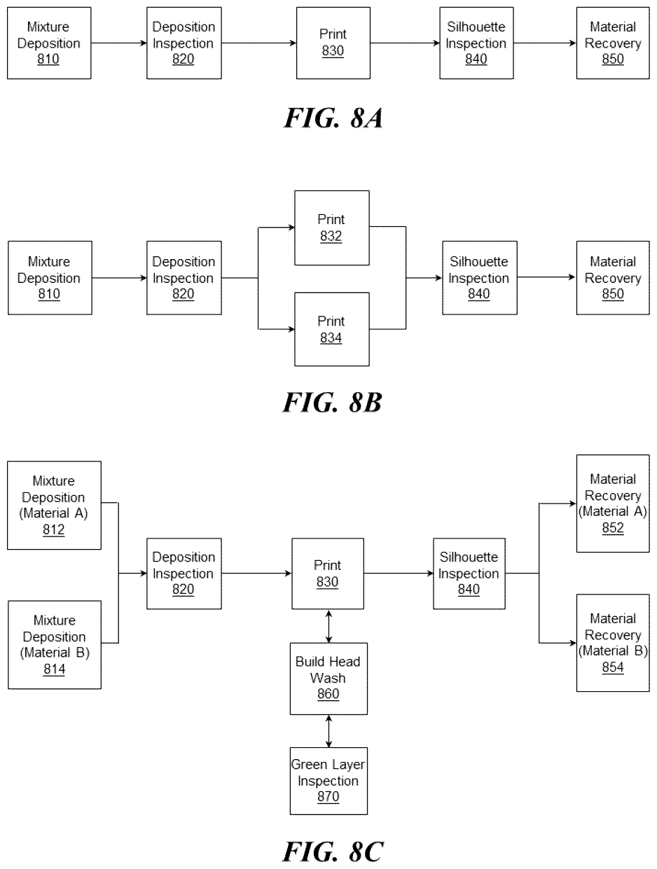

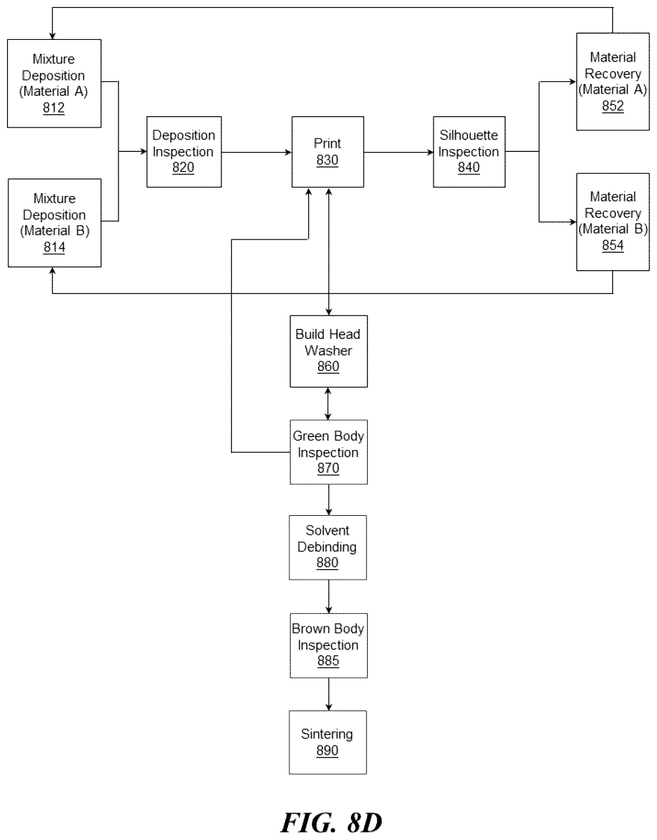

FIG. 8 shows example configurations of a 3D printing system and methods of using thereof. The system comprises at least one printing zone, each of which comprises a platform configured to hold (i) a mixture or (ii) a film that is configured to hold the mixture. Each of the at least one printing zone further comprises a build head. The build head may be configured to hold at least a portion of the printed 3D object. The system further comprises at least one deposition zone, each of which comprises a deposition head configured to deposit the mixture (or a layer of the mixture) on the film. The system further comprises at least one film transfer unit, each of which comprises the film configured to hold the mixture, and configured to move at least between the at least one printing zone and the at least one deposition zone. In any of the flowcharts in FIG. 8, an arrow may indicate one or more hardware interfaces between two or more components of the 3D printing system. The one or more hardware interfaces may be directed by one or more controllers. The one or more hardware interfaces may be de-coupled from one another, to reduce complexity and/or interdependency among them. Thus, two or more hardware components of the system may be easily coupled and/or de-coupled to generate a functional 3D printing system. Advantageous of such system can include parallel development of each hardware component, scalable and modular to a plurality of configurations and arrangements, etc.

FIG. 8A shows an example configuration of the 3D printing system and method of using thereof. The system includes a deposition zone for mixture deposition, an inspection zone for inspecting the deposited mixture, and a printing zone to print at least a portion of the 3D object (e.g., by exposing the mixture to the light). The deposition zone and the inspection zone may be part of the same zone or different zones. During the 3D printing, the film transfer unit begins at the deposition zone to deposit the mixture to a film of the film transfer unit (process 810). Following, the film transfer unit moves to the inspection zone (process 820), such that a quality of the mixture of a layer of the mixture disposed on or adjacent to the film is inspected. If the quality is sufficient (e.g., a variance of an average optical density of the layer of mixture is below a predetermined threshold), the film transfer unit moves to the printing zone (process 830), wherein the build head and the one or more optical sources are directed to print at least a portion of the 3D object. Following, the film transfer unit moves to the inspection zone (process 840), such that a quality (e.g., silhouette) of any excess of the mixture on or adjacent to the film is inspected. Such silhouette image may be used as an inverse image of the at least portion of the 3D object that was printed. Following, the film transfer unit moves to the deposition zone or a separate material recovery zone (process 850) to recover any excess of the mixture and deposit a subsequent layer of the mixture, if needed.

FIG. 8B shows another example configuration of the 3D printing system and method of using thereof. The system includes a deposition zone for mixture deposition, an inspection zone for inspecting the deposited mixture, and two printing zones to print two 3D objects. During the 3D printing, a first film transfer unit begins at the deposition zone to deposit the mixture to a film of the first film transfer unit (process 810). Following, the first film transfer unit moves to the inspection zone (process 820), such that a quality of the mixture of a layer of the mixture disposed on or adjacent to the film is inspected. If the quality is sufficient, the first film transfer unit moves to a first printing zone (process 832), wherein a build head and one or more optical sources are directed to print at least a portion of a first 3D object. While the first film transfer unit is positioned at the first printing zone, a second film transfer unit goes through the processes 810 and 820, and subsequently moves to the second printing zone (process 834), wherein a build head and one or more optical sources are directed to print at least a portion of a second 3D object. Following, while the second film transfer unit is located at its respective printing zone, the first film transfer unit moves to the inspection zone (process 840) to determine a quality (e.g., silhouette) of any excess of the mixture on or adjacent to the film, and subsequently moves to the deposition zone or a separate material recovery zone (process 850) to recover any excess of the mixture and deposit a subsequent layer of the mixture, if needed. The second film transfer unit may move through the inspection zone and to the deposition zone for the processes 840 and 850 while (i) the first film transfer unit is still positioned at the deposition zone, or (ii) the first film transfer unit repeats the processes 810 and 820 and is moved to the respective printing zone for process 832. The flowchart shown in FIG. 8 can be used to simultaneously print two 3D objects or two parts of a same 3D object.

FIG. 8C shows a different example configuration of the 3D printing system and method of using thereof. The system includes two deposition zones for deposition of two different materials (Material A and Material B), an inspection zone for inspecting the deposited mixture, and a printing zone to print at least a portion of the 3D object (e.g., by exposing the mixture to the light). During the 3D printing, a first film transfer unit begins at a first deposition zone to deposit Material A to a film of the first film transfer unit (process 812). Following, the first film transfer unit moves to the inspection zone (process 820), such that a quality of the mixture of a layer of the mixture disposed on or adjacent to the film is inspected. If the quality is sufficient, the first film transfer unit moves to a printing zone (process 830), wherein a build head and one or more optical sources are directed to print at least a portion of the 3D object comprising the Material A. Following, the first film transfer unit moves to the inspection zone (process 840) to determine a quality (e.g., silhouette) of any excess of the mixture on or adjacent to the film, and subsequently moves to the first deposition zone or a separate material recovery zone (process 852) to recover any excess of the Material A and deposit a subsequent layer of the Material A, if needed. When Material B is needed to print at least a portion of the 3D object, a second film transfer unit begins at a second deposition zone to deposit the Material B to a film of the second film transfer unit (process 814). Following, the second film transfer unit moves to the inspection zone (process 820), such that a quality of the mixture of a layer of the mixture disposed on or adjacent to the film is inspected. If the quality is sufficient, the second film transfer unit moves to the printing zone (process 830), wherein the build head and the one or more optical sources are directed to print at least an additional portion of the 3D object comprising the Material B. Following, the second film transfer unit moves to the inspection zone (process 840) to determine a quality (e.g., silhouette) of any excess of the mixture on or adjacent to the film, and subsequently moves to the second deposition zone or a separate material recovery zone (process 854) to recover any excess of the Material B and deposit a subsequent layer of the Material B, if needed. The flowchart shown in FIG. 8C can be used to print a 3D object comprising layers of different mixtures.

FIG. 8D shows a different configuration of the 3D printing system and method of using thereof. In addition to the components of the 3D printing system illustrated in FIG. 8C, the system provided in FIG. 8D further includes a build head washer, a green body inspector (or inspection zone), an apparatus for solvent debinding, a brown body inspector (or inspection zone), and an apparatus for sintering. When a desired 3D object is printed by using both Material A and Material B (process 830), the build head is moved to a build head washer (or the build head washer is brought towards the build head) to wash the green body (process 860). A solvent may be directed towards the green body to remove any uncured mixture on a surface of the green body. Following, the build head is moved to a green body inspection zone (or the green body inspector is brought towards the build head) to inspect quality (e.g., shape) of the 3D printed object (process 870). When the quality does not pass a predetermined threshold, the build head may be moved back to the printing zone to continue printing to fix any error or re-start printing. When the quality passes the predetermined threshold, the build head or at least a portion of the build head holding the 3D object may be moved to a solvent de-binding zone to de-bind at least a portion of a cured polymer within the 3D object (process 880). Following, a resulting brown body may be inspected by a brown body inspector (e.g., a scale, a sensor, a camera, etc.) (process 885). Subsequently, the brown body may be sintered to generate the final 3D object (process 890).

In another aspect, the present disclosure provides a method for 3D printing. The method may utilize the vacuum unit as provided in the present disclosure for one or more aspects of the 3D printing. In an example, the method may use a vacuum unit to provide enhanced contact or connection between (i) a substrate (e.g., the film 170 as shown in FIGS. 3 and 4, or a functional variation thereof) and (ii) a base configured to hold at least a portion of the substrate (e.g., the deposition area 180 of the mixture deposition zone 410 as shown in FIG. 4B, the print window 103 the printing zone 420 as shown in FIG. 4B, or a functional variation thereof). The substrate may hold a mixture for 3D printing prior to being disposed adjacent to the base. Alternatively, the substrate may not hold the mixture prior to being disposed adjacent to the base, and the mixture may be deposited adjacent to the substrate subsequent to generating a contact between the substrate and the base. The method may be implemented, e.g., a by a controller, to control one or more aspects of the 3D printing system as shown in FIGS. 9A and 9B.

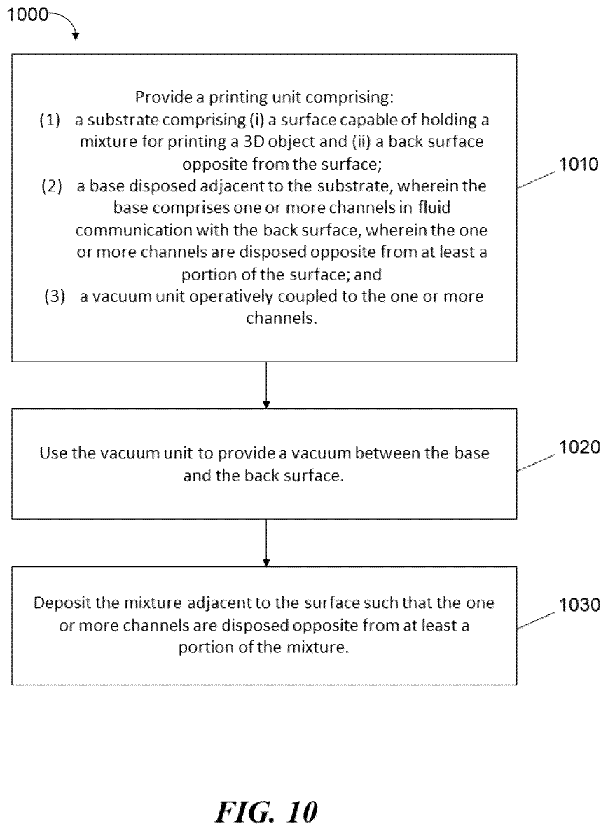

FIG. 10 illustrates an example flowchart 1000 of a method for 3D printing using a vacuum unit. The method may comprise providing a printing unit (process 1010). The printing unit may comprise a substrate comprising (i) a surface capable of holding a mixture for printing a 3D object and (ii) a back surface opposite from the surface. The printing unit may comprise a base disposed adjacent to the substrate. The base comprises one or more channels in fluid communication with the back surface, and the one or more channels are disposed opposite from at least a portion of the surface. The printing unit may comprise a vacuum unit operatively coupled to the one or more channels. The method may further comprise using the vacuum unit to provide a vacuum between the base and the back surface (process 1020). In some cases, the method may further comprise depositing the mixture adjacent to the surface of the substrate such that the one or more channels are disposed opposite from at least a portion of the mixture (process 1030). Alternatively, the mixture may be deposited adjacent to the surface of the substrate. As such, when the vacuum unit is used to provide the vacuum between the base and the back surface, the one or more channels may be disposed opposite from at least a portion of the mixture.

In another aspect, the present disclosure provides a method for 3D printing. The method may utilize the base unit (i.e., a laminator unit) as provided in the present disclosure for one or more aspects of the 3D printing. In an example, the method may use a laminator unit to provide enhanced contact or connection between (i) a layer of mixture deposited on a flexible substrate and (ii) a surface of a previously printed layer of a 3D object disposed adjacent to a build head. The method may be implemented, e.g., a by a controller, to control one or more aspects of the 3D printing system as shown in FIGS. 11-14.

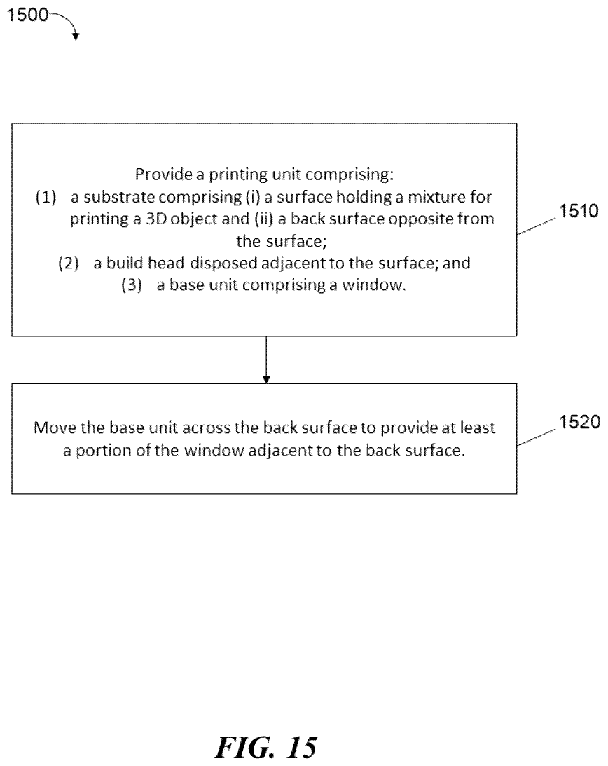

FIG. 15 illustrates an example flowchart 1500 of a method for 3D printing using the base unit. The method may comprise providing a printing unit (process 1510). The printing unit may comprise (1) a substrate comprising (i) a surface holding a mixture for printing a 3D object and (ii) a back surface opposite from the surface; (2) a build head disposed adjacent to the surface; and (3) a base unit comprising a window. The method may further comprise moving the base unit across the back surface to provide at least a portion of the window adjacent to the back surface (process 1520). During the movement of the base unit, the base unit may generate a contact between at least a portion of the mixture to (i) a surface of the build head or (ii) a surface of a previous layer of the 3D object disposed adjacent to the build head. In some cases, the substrate may be kept stationary or substantially stationary during the movement of the base unit.

### Computer Systems

The present disclosure provides computer systems that are programmed to implement methods of the disclosure. Computer systems of the present disclosure may be used to regulate various operations of 3D printing, such as providing a film of a mixture adjacent to an open platform and directing an optical source to provide light to the mixture to cure at least a portion of the mixture.

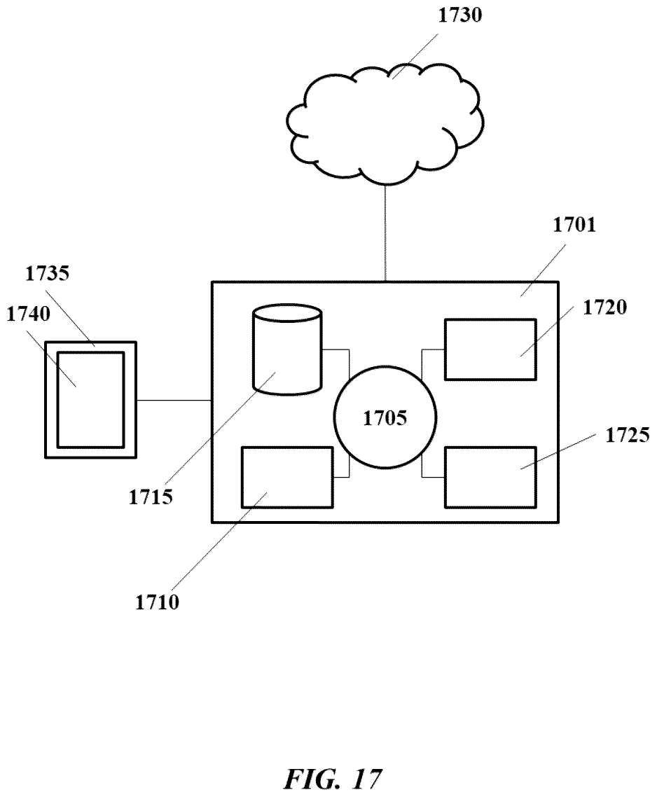

FIG. 17 shows a computer system 1701 that is programmed or otherwise configured to communicate with and regulate various aspects of a 3D printer of the present disclosure. The computer system 1701 can communicate with, for example, the light sources, build head, one or more deposition heads, one or more sources of one or more mixtures of the present disclosure, one or more first coupling units of the platform, one or more second coupling units of the build head, one or more actuators coupled to one or more of the coupling units, one or more fixtures coupled to the one or more coupling units, one or more film transfer units, one or more actuators operatively coupled to the film transfer units, one or more sensors for detecting the layer of the mixture prior to, during, and subsequent to printing at least a portion of the 3D object, a vacuum unit, and/or a laminator unit. The computer system 1701 may also communicate with the 3D printing mechanisms or one or more controllers of the present disclosure. The computer system 1701 can be an electronic device of a user or a computer system that is remotely located with respect to the electronic device. The electronic device can be a mobile electronic device.

The computer system 1701 includes a central processing unit (CPU, also “processor” and “computer processor” herein) 1705, which can be a single core or multi core processor, or a plurality of processors for parallel processing. The computer system 1701 also includes memory or memory location 1710 (e.g., random-access memory, read-only memory, flash memory), electronic storage unit 1715 (e.g., hard disk), communication interface 1720 (e.g., network adapter) for communicating with one or more other systems, and peripheral devices 1725, such as cache, other memory, data storage and/or electronic display adapters. The memory 1710, storage unit 1715, interface 1720 and peripheral devices 1725 are in communication with the CPU 1705 through a communication bus (solid lines), such as a motherboard. The storage unit 1715 can be a data storage unit (or data repository) for storing data. The computer system 1701 can be operatively coupled to a computer network (“network”) 1730 with the aid of the communication interface 1720. The network 1730 can be the Internet, an internet and/or extranet, or an intranet and/or extranet that is in communication with the Internet. The network 1730 in some cases is a telecommunication and/or data network.

The network 1730 can include one or more computer servers, which can enable distributed computing, such as cloud computing. The network 1730, in some cases with the aid of the computer system 1701, can implement a peer-to-peer network, which may enable devices coupled to the computer system 1701 to behave as a client or a server.

The CPU 1705 can execute a sequence of machine-readable instructions, which can be embodied in a program or software. The instructions may be stored in a memory location, such as the memory 1710. The instructions can be directed to the CPU 1705, which can subsequently program or otherwise configure the CPU 1705 to implement methods of the present disclosure. Examples of operations performed by the CPU 1705 can include fetch, decode, execute, and writeback.

The CPU 1705 can be part of a circuit, such as an integrated circuit. One or more other components of the system 1701 can be included in the circuit. In some cases, the circuit is an application specific integrated circuit (ASIC).

The storage unit 1715 can store files, such as drivers, libraries and saved programs. The storage unit 1715 can store user data, e.g., user preferences and user programs. The computer system 1701 in some cases can include one or more additional data storage units that are external to the computer system 1701, such as located on a remote server that is in communication with the computer system 1701 through an intranet or the Internet.

The computer system 1701 can communicate with one or more remote computer systems through the network 1730. For instance, the computer system 1701 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1701 via the network 1730.

Methods as described herein can be implemented by way of machine (e.g., computer processor) executable code stored on an electronic storage location of the computer system 1701, such as, for example, on the memory 1710 or electronic storage unit 1715. The machine executable or machine readable code can be provided in the form of software. During use, the code can be executed by the processor 1705. In some cases, the code can be retrieved from the storage unit 1715 and stored on the memory 1710 for ready access by the processor 1705. In some situations, the electronic storage unit 1715 can be precluded, and machine-executable instructions are stored on memory 1710.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1701, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1701 can include or be in communication with an electronic display 1735 that comprises a user interface (UI) 1740 for providing, for example, (i) activate or deactivate a 3D printer for printing a 3D object, (ii) determining when to clean the deposition head, (iii) determine any defects in the film of the mixture, (iv) determining a height of the one or more first coupling units with respect to a surface of the platform, (v) determining a height of the one or more second coupling units with respect to a surface of the build head, and (vi) determining a predetermined (and acceptable) threshold range of electrical current, approach force, pressure, and/or time of contact between the one or more first coupling units and the second one or more coupling units. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1705. The algorithm can, for example, determine a volume of the mixture that must be dispensed into a pool of excess mixture for a subsequent printing step.

Methods and systems of the present disclosure may be combined with or modified by other methods and systems, such as, for example, those described in U.S. Patent Publication No. 2016/0067921 (“THREE DIMENSIONAL PRINTING ADHESION REDUCTION USING PHOTOINHIBITION”), U.S. Patent Publication No. 2018/0348646 (“MULTI WAVELENGTH STEREOLITHOGRAPHY HARDWARE CONFIGURATIONS”), Patent Cooperation Treaty Patent Publication No. 2018/213356 (“VISCOUS FILM THREE-DIMENSIONAL PRINTING SYSTEMS AND METHODS”), Patent Cooperation Treaty Patent Publication No. 2018/232175 (“METHODS AND SYSTEMS FOR STEREOLITHOGRAPHY THREE-DIMENSIONAL PRINTING”), and Patent Cooperation Treaty Patent Application No. PCT/US2019/068413 (“SENSORS FOR THREE-DIMENSIONAL PRINTING SYSTEMS AND METHODS”), each of which is entirely incorporated herein by reference.

### EXAMPLES

### Example 1: 3D Printing with a Laminator Unit

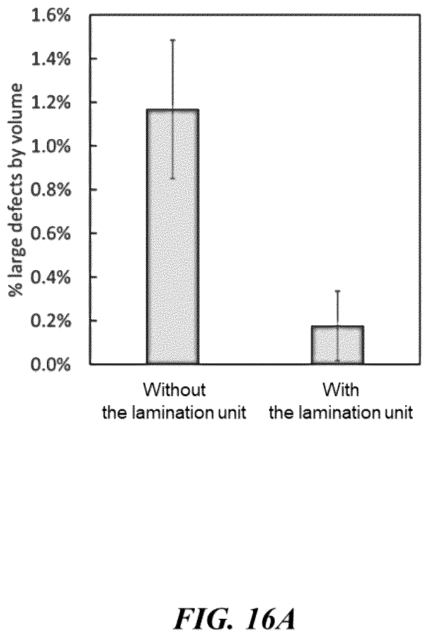

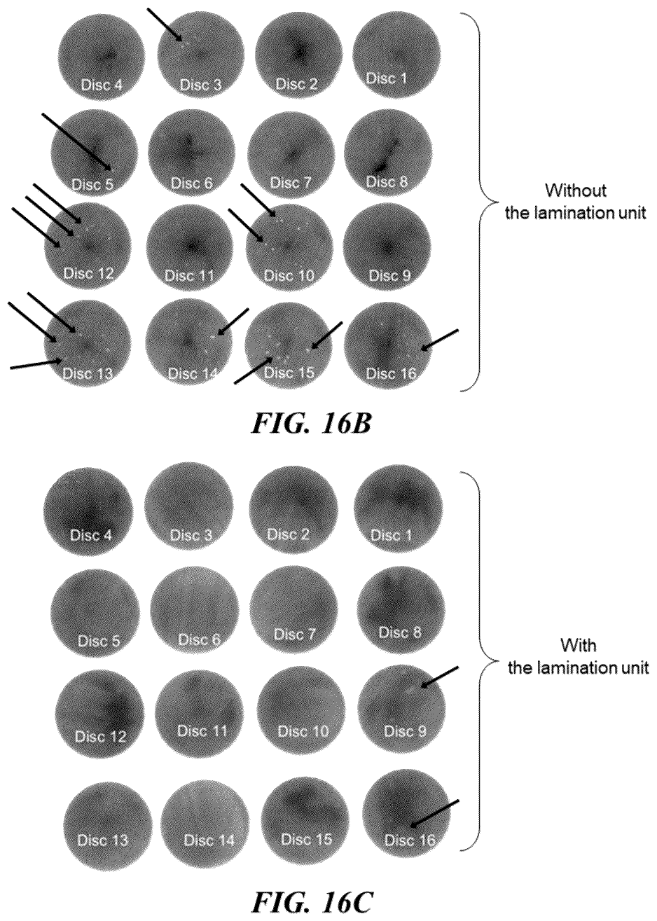

A laminator unit and methods thereof (e.g., as described in FIGS. 11-15) can be used to gradually increase a contact area between (i) a surface of a layer of a mixture for 3D printing and (ii) a surface of a build head or a 3D object disposed adjacent to the build head (i.e., a lamination process). FIGS. 16A-16C show comparative data between structural qualities of (i) a first plurality of discs (16 discs, 13 mm in diameter) printed without the lamination process by the laminator unit of the present disclosure and (ii) a second plurality of discs (16 discs, 13 mm in diameter) printed with the lamination process by the laminator unit. The first and second plurality of discs were printed using the same mixture, under substantially the same conditions except for the use of the laminator unit.

Referring to FIG. 16A, the first and second plurality of discs were structurally analyzed by X-Ray computed tomography (3D scanning by Scanco Xtreme CT with a 17 μm voxel size). The 3D reconstructions of the first and second plurality of discs were analyzed to identify a number of defects (e.g., pores) and their dimensions (e.g., size, volume, etc.). Due to the voxel size, any defects with a diameter of less than 20 μm were excluded form the analysis. Following, an average percentage of defects per disc volume was plotted. As shown in FIG. 16A, the average volume percentage of defects in the discs printed without the lamination process was about 1.2%+0.2%. In contrast, the average volume percentage of defects in the discs printed with the lamination process was about 0.2%+0.2%. The use of the lamination process via the laminator unit of the present disclosure resulted in about 83% reduction in the average volume percentage of defects in the printed discs.

FIG. 16B shows X-ray images of the plurality of discs printed without the lamination process. As indicated by the arrows, the plurality of discs exhibited a plethora of pores in the printed disc. FIG. 16C shows X-ray images of the plurality of discs printed with the lamination process. The plurality of discs exhibited a reduced number of pores as compared to the discs shown in FIG. 16B. The improved printing quality may be due at least in part to the (i) gradual increase in contact area between the layer of mixture and the previously printed layer of the 3D object and/or (ii) a constant contact angle α across the contact plane between the layer of mixture and the previously printed layer of the 3D object (e.g., as described in FIG. 14C), regardless of the shape and/or size of the previously printed layer of the 3D object.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. (canceled)

2.-133. (canceled)

134. A photopolymerization-based additive manufacturing apparatus comprising:
a first module including a vacuum unit configured to receive and stabilize a carrier film bearing a layer of photocurable resin, the vacuum unit comprising a transparent window having a light-diffusing surface texture and a vacuum channel disposed around a perimeter of the transparent window, the vacuum channel being fluidically connected to a vacuum unit;
a second module positioned adjacent to the first module, the second module including a transparent exposure window configured to support the carrier film during photocuring of the resin;
at least one UV light source optically coupled to the second module and configured to cure successive layers of the resin to build a three-dimensional part; and
a non-curing light source positioned below the first module and configured to transmit light through the transparent window and through the carrier film and feedstock coating to enable in-situ optical metrology of the feedstock coating.

135. A module for a vat photopolymerization printer, the module comprising:
a vacuum unit comprising a transparent window having a textured upper surface, the textured upper surface configured to serve both as a light diffuser and to facilitate evacuation of air between the transparent window and a carrier film placed thereon;
a vacuum channel disposed around a perimeter of the transparent window and fluidically connected to a vacuum source, the vacuum channel configured to hold the carrier film against the textured upper surface to stabilize the carrier film during a wipe operation and to maintain a uniform gap between the carrier film and a coating blade during a recoat operation;
a wiper configured to redistribute any resin remaining on the carrier film into a bead; and
a coating blade configured to spread the redistributed resin into a uniform layer on the carrier film.

136. A method of in-situ process monitoring in an additive manufacturing apparatus, the method comprising:
transmitting non-curing light from a light source disposed below a carrier film, through a vacuum unit transparent window and through the carrier film bearing a photocurable resin coating;
capturing, with a camera disposed above the carrier film, images of the feedstock coating illuminated by the transmitted non-curing light at a plurality of process stages;
analyzing the captured images to assess at least one of: (a) layer silhouette geometry to verify part position, (b) residual cured material on the carrier film indicative of a print failure, (c) coating uniformity including streaks or voids, and (d) coating thickness based on optical absorption through the feedstock coating; and
adjusting at least one process parameter in response to the analysis.

137. The apparatus of claim 134, wherein the light-diffusing surface texture of the transparent window is configured to scatter the light from the non-curing light source to provide uniform illumination of the feedstock coating.

138. The apparatus of claim 134, wherein the non-curing light source emits visible light having a wavelength that does not initiate photopolymerization of the feedstock coating.

139. The apparatus of claim 134, wherein the non-curing light source emits infrared light configured to penetrate the resin coating, the apparatus further comprising a camera configured to measure an infrared absorption map of the resin coating to determine at least one of coating thickness and metal particle content of the resin coating.

140. The apparatus of claim 134 further comprising a camera positioned above the first module, the camera configured to capture images of the resin coating illuminated by the non-curing light source at each of: a post-exposure stage, a post-wipe stage, and a post-recoat stage.

141. The apparatus of claim 140, further comprising a controller configured to: detect, from post-exposure images, silhouette locations corresponding to cured layer cross-sections to verify part positioning; detect, from post-wipe images, residual cured material adhering to the carrier film as an indicator of print failure; and detect, from post-recoat images, streaks, voids, or non-uniformities in the recoated resin layer.

142. The apparatus of claim 141, wherein the controller is further configured to determine a coating thickness from an optical absorption measurement of the resin coating in the post-recoat image and to adjust a coating blade height in response to a measured coating thickness deviating from a target thickness and to compensate for thickness variation in direction of travel.

143. The apparatus of claim 141, wherein the controller is configured to adjust one or more operations of the apparatus based on feedback provided via the camera.

144. The apparatus of claim 134, wherein the second module comprises a load cell located on a vertical axis of the second module and directly coupled to the build plate and configured to measure a force exerted on the build plate during separation of a cured layer from the carrier film.

145. The apparatus of claim 134, wherein the recoat module and the exposure module are each configured to independently receive the carrier film via a transfer system, the transfer system configured to move segments of the carrier film sequentially between the recoat module and the exposure module.

146. The apparatus of claim 145, wherein the carrier film is an FEP (fluorinated ethylene propylene) film bearing a photocurable resin coating having a thickness of between 30 and 100 micrometers.

147. The apparatus of claim 134, wherein the vacuum channel is configured to apply vacuum pressure across the entire area bound by the vacuum channel including the perimeter of the transparent window such that uniform unit retention of the carrier film is achieved without the vacuum source contributing to or inhibiting the photopolymerization process.

148. The apparatus of claim 135, wherein the vacuum unit is configured to maintain uniform carrier film flatness during the recoat operation such that the resin coating thickness is determined solely by a controlled gap between the carrier film and the coating blade.

149. The apparatus of claim 135, further comprising a non-curing light source disposed below the transparent window and configured to backlight the carrier film and resin coating for optical inspection.

150. The apparatus of claim 149, wherein the non-curing light source emits at least one of visible red light and infrared light, and wherein the textured surface of the transparent window acts as a diffuser to provide uniform illumination across the carrier film.

151. The method of claim 136, wherein transmitting non-curing light comprises transmitting at least one of visible red light and infrared light that does not initiate photopolymerization of the resin coating.

152. The method of claim 136, wherein analyzing the captured images to assess coating thickness comprises measuring an optical absorption map of the resin coating at a plurality of spatial locations, and wherein adjusting at least one process parameter comprises modifying a coating blade height to correct for regions where the measured thickness deviates from a target value.

153. The method of claim 136, wherein analyzing the captured images further comprises assessing metal particle concentration in the resin coating based on optical transmission through the resin coating, thereby enabling closed-loop adjustment of resin composition.
